(19) United States
(12) Patent Application Publication
(10) Pub. No.: US 2016/0046529 A1
(43) Pub. Date: Feb. 18, 2016

(54) Polymer Derived Ceramic Equipment for the Exploration and Recovery of Resources

(71) Applicants: Bruce A. Bricco, The Woodlands, TX (US); Brian L. Benac, Marble Falls, TX (US); Walter J. Sherwood, Glenville, NY (US); Mark S. Land, Houston, TX (US); Douglas M. Dukes, Troy, NY (US)

(72) Inventors: Bruce A. Bricco, The Woodlands, TX (US); Brian L. Benac, Marble Falls, TX (US); Walter J. Sherwood, Glenville, NY (US); Mark S. Land, Houston, TX (US); Douglas M. Dukes, Troy, NY (US)

(73) Assignee: Melior Innovations, Inc., Houston, TX (US)

(21) Appl. No.: 14/664,538

(22) Filed: Mar. 20, 2015

Related U.S. Application Data
(63) Continuation-in-part of application No. 14/634,814, filed on Feb. 28, 2015.
Application No. 14/634,814 is a continuation-in-part of application No. 14/268,150, filed on May 2, 2014.
(60) Provisional application No. 61/968,774, filed on Mar. 21, 2014.
(60) Provisional application No. 61/946,598, filed on Feb. 28, 2014.
(60) Provisional application No. 61/818,906, filed on May 2, 2013.
(60) Provisional application No. 61/818,981, filed on May 3, 2013.

(51) Int. Cl. C04B 35/515; E21B 17/00; E21B 43/10; C08J 5/00; E21B 17/01; E21B 15/00; E21B 43/12; E21B 33/06; E21B 10/46; E21B 33/12

(52) U.S. Cl. CPC C04B 35/515; E21B 10/46; E21B 17/00; E21B 43/10; E21B 33/12; E21B 17/01; E21B 15/00; E21B 43/121; E21B 33/06; C08J 5/00; C08J 2383/07

(57) ABSTRACT

Apparatus and method for developing polymer derived ceramic downhole equipment including completion structure, isolation plugs, hanger systems, marine risers, risers, packer assemblies and sucker rods. In various approaches, one or more of downhole components, surfaces or structure can embody polymer derived ceramic material, and, in particular, polysilocarb derived material and polysilocarb derived ceramic material.

This application: (i) claims under 35 U.S.C. §119(e)(1) the benefit of the filing date of Mar. 21, 2014 of U.S. provisional application Ser. No. 61/968,774; (ii) is a continuation-in-part of U.S. patent application Ser. No. 14/634,814 filed Feb. 28, 2015, which claims, under 35 U.S.C. §119(e)(1), the benefit of the filing date of Feb. 28, 2014 of U.S. provisional application Ser. No. 61/946,598; and (iii) is a continuation-in-part of U.S. patent application Ser. No. 14/268,150 filed May 2, 2014, which claims under 35 U.S.C. §119(e)(1) the benefit of the filing date of May 2, 2013 of U.S. provisional application Ser. No. 61/818,906 and of May 3, 2013 of U.S. provisional application Ser. No. 61/818,981, the entire disclosures of each of which are incorporated herein by reference.

### BACKGROUND OF THE INVENTION

The present disclosure relates to polymeric derived ceramic downhole apparatus and methods for making such apparatus. In particular, the present disclosure relates to drilling activities and structure that utilize polymeric derived siloxane based ceramics. Thus, the present disclosure further relates to creating wells, e.g., hydrocarbon producing wells, water wells and geothermal wells, to increase and enhance the production from these wells by employing siloxane based polymeric derived ceramic downloading drilling apparatus.

In the production of natural resources from formations within the earth a well or borehole is drilled into the earth to the location where the natural resource is believed to be located. These natural resources may be a hydrocarbon reservoir, containing natural gas, crude oil and combinations of these; the natural resource may be fresh water; it may be a heat source for geothermal energy; or it may be some other natural resource that is located within the ground.

These resource-containing formations may be a few hundred feet, a few thousand feet, or tens of thousands of feet below the surface of the earth, including under the floor of a body of water, e.g., below the sea floor. In addition to being at various depths within the earth, these formations may cover areas of differing sizes, shapes and volumes.

Generally, when a well is drilled into these formations the natural resources rarely flow into the well at rates, durations and amounts that are economically viable. This problem occurs for several reasons, some of which are well understood, others of which are not as well understood, and some of which may not yet be known. These problems can relate to the viscosity of the natural resource, the porosity of the formation, the geology of the formation, the formation pressures, and the perforations that place the production tubing in the well in fluid communication with the formation, to name a few.

The ability, or ease, by which the natural resource can flow out of the formation and into the well or production tubing (into and out of, for example, in the case of engineered geothermal wells) can generally be understood as the fluid communication between the well and the formation. As this fluid communication is increased several enhancements or benefits may be obtained: the volume or rate of flow (e.g., gals per minute) can increase; the distance within the formation out from the well where the natural resources will flow into the well can be increase (e.g., the volume and area of the formation that can be drained by a single well is increased and it will thus take less total wells to recover the resources from an entire field); the time period when the well is producing resources can be lengthened; the flow rate can be maintained at a higher rate for a longer period of time; and combinations of these and other efficiencies and benefits.

Fluid communication between the formation and the well can be increased by the use of hydraulic fracturing techniques. The first uses of hydraulic fracturing date back to the late 1940s. Hydraulic fracturing involves forcing fluids down a well under pressure causing the formation rock to fracture. The fluid containing propping agents is forced into the fractures creating channels or flow paths that may have cross sections of a few microns, to several millimeters, and potentially larger. The fractures may also extend out from the well in all directions for a few feet, several feet and tens of feet or further. After the fracturing treatment, the fluid is flowed back out of the well leaving the propping agent in place. It should be borne in mind that the longitudinal axis of the well in the reservoir may be vertical or it may be on various angles (either slopping up or down) or horizontal. For example, in the recovery of shale gas the wells are typically essentially horizontal in the reservoir. The section of the well located within the reservoir, i.e., the section of the formation containing the natural resources, can be called the pay zone.

Typical fluid volumes in fracturing treatment of a formation can range from a few thousand to millions of gallons. Proppant volumes can approach several thousand cubic feet. In general, an objective of a proppant fracturing is to create and enhance fluid communication between the wellbore and the hydrocarbons in the formation or reservoir. Proppant fracturing techniques are therefore used to create and enhance conductive pathways for the hydrocarbons to get from the reservoir to the wellbore. Moreover, one way of enhancing the efficacy of proppant fracturing techniques is to have uniform proppant distribution. In this manner a uniformly conductive fracture along the wellbore height and fracture half-length can be provided. However, the complicated nature of proppant settling, can cause a higher concentration of proppant to settle down in the lower part of the fracture. This in turn can create a lack of adequate proppant coverage on the upper portion of the fracture and the wellbore. Clustering of proppant, encapsulation, bridging, crushing and embedment are a few negative occurrences or phenomena that can lower the potential conductivity of the proppant pack, and efficacy of hydraulic fracture and the well.

In one approach, after drilling each of the sections of a subterranean wellbore, individual lengths of relatively large diameter metal tubes are typically secured together to form a casing string that is positioned within each section of the wellbore. This casing string is used to increase the integrity of the wellbore by preventing the wall of the hole from caving in. In addition, the casing string prevents movement of fluids from one formation to another formation. Conventionally, each section of the casing string is cemented (can be open hole, or slotted liner with external casing packers, as well as other borehole configurations) within the wellbore before the next section of the wellbore is drilled.

Once this well construction process is finished, the completion process may begin. The completion process comprises a number of steps. Hydraulic openings or perforations are typically created through the casing string, cement and a short distance into the desired formation by detonating shaped charges carried in a perforating gun. The perforations allow production fluids from the subterranean formation to enter the interior of the wellbore. Once the perforations are created, however, the formation pressure must be controlled. Typically, this is achieved by loading a completion fluid into the wellbore during the completion process. The completion fluid has a density sufficient to create pressure at the location or locations of the wellbore perforations, thereby preventing formation fluids from entering the wellbore.

After the well is perforated, a stimulation control treatment process may be performed. For example, a work string including a service tool, a gravel pack packer, a ported housing and port closure sleeve, a sealbore housings, a check valve, a wash pipe extending through the screen, a lower seal assembly and a sump packer may be run downhole. A treatment fluid, which may contain sand, gravel or proppants, is then pumped down the work string and either into the wellbore annulus, into the formation or both depending upon the desired results of the treatment process.

Downhole tooling and equipment conventionally are made from relatively expensive materials, and alternatively are desirable. Materials made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O) are known. These general types of materials have great, but unrealized promise; and have failed to find large-scale applications or market acceptance. Instead, their use has been relegated to very narrow, limited, low volume, high priced and highly specific applications, such as a ceramic component in a rocket nozzle, or a patch for the space shuttle. Thus, they have failed to obtain wide spread use ceramics, and it is believed they have obtained even less acceptance and use, if any, as a plastic material, e.g., cured but not pyrolized.

To a greater or lesser extent all of these materials and the process used to make them suffer from one or more failings, including for example: they are exceptionally expensive and difficult to make, having costs in the thousands and tens-of-thousands of dollars per pound; they require high and very high purity starting materials; the process requires hazardous organic solvents such as toluene, tetrahydrofuran (THF), and hexane; the materials are incapable of making non-reinforced structures having any usable strength; the process produces undesirable and hazardous byproducts, such as hydrochloric acid and sludge, which may contain magnesium; the process requires multiple solvent and reagent based reaction steps coupled with curing and pyrolizing steps; the materials are incapable of forming a useful prepreg; and their overall physical properties are mixed, e.g., good temperature properties but highly brittle.

As a result, although believed to have great promise, these types of materials have failed to find large-scale applications or market acceptance and have remained essentially scientific curiosities.

Accordingly, there has been a long-standing and unfulfilled need for new polymer derived ceramic materials and processes that address these and other deficiencies, and inadequacies associated with prior ceramic materials. There has also existed a longstanding and unfulfilled need for cost effective downhole tools and/or drilling assemblies and material having predetermined characteristics to enhance hydraulic fracturing operations and the recovery of resources for wells. The present disclosures, among other things, solve these needs by providing the articles of manufacture, devices and processes taught, disclosed and claimed herein.

### SUMMARY

Accordingly, there has been a long-standing and unfulfilled need for new polymer derived ceramic materials and processes that address these and other deficiencies, and inadequacies associated with prior ceramic materials. There has also existed a longstanding and unfulfilled need for cost effective downhole tools, marine risers, and drilling assemblies and material having predetermined characteristics to enhance hydraulic fracturing operations and the recovery of resources for wells. The present disclosures, among other things, solve these needs by providing the articles of manufacture, devices and processes taught, disclosed and claimed herein.

Briefly and in general terms, the present disclosure is directed towards polymer derived ceramic downhole equipment and equipment for use in the exploration and recovery of natural resources.

In various embodiments, one or more of completion assemblies, composite plugs, liner hanger systems, multilaterals, packer systems, subsurface systems and sucker rods, or components thereof, can be partially or wholly formed from specifically selected polymer derived ceramic material. Relevant specifications, such as those required under ANSI/ADP are met utilizing contemplated ceramic material.

In one aspect, a system for the production of natural resources from formation within the earth comprises downhole equipment, wherein components of the downhole drilling equipment are formed at least in part from polymer derived ceramic material.

In another aspect, a method involving production of natural resources from formation within the earth comprises providing downhole equipment, wherein components of the downhole drilling equipment are formed at least in part from polymer derived ceramic material.

Yet further there is provided a system for the production of natural resources from formation within the earth, having: downhole equipment, wherein components of the downhole drilling equipment are formed at least in part from polymer derived ceramic material.

Additionally, there is provided the present systems, methods and equipment having one or more of the following features: wherein the system includes a drill head formed from polymer derived ceramic material; wherein the system includes a drill pipe formed from polymer derived ceramic material; wherein the system includes a surface casing formed from polymer derived ceramic material; wherein the system includes a tubular casing formed from polymer derived ceramic material; wherein the system includes a completion assembly formed from polymer derived ceramic material; wherein the system includes a liner hanger assembly formed from polymer derived ceramic material; wherein the system includes one or multilateral assemblies formed from polymer derived ceramic material; wherein the system includes one or more packer assemblies formed from polymer derived ceramic material; wherein the system includes a sucker rod assembly formed from polymer derived ceramic material; wherein the polymer derived ceramic material is a polysilocarb derived ceramic material; wherein the polysilocarb formulation is a reaction type formulation; wherein the polysilocarb formulation is a reaction type formulation, wherein the formulation comprises at least one precursor selected from the group consisting of Phenyltriethoxysilane, Phenylmethyldiethoxysilane, Methyldiethoxysilane, Vinylmethyldiethoxysilane, Trimethyethoxysilane Triethoxysilane, and TES 40; wherein the drilling head comprises a cutting material selected from the group consisting of polysilocarb derived ceramic and polysilocarb derived SiC; and, wherein the polysilocarb formulation is a mixing type formulation.

Further, there is provided a down hole equipment for use in obtaining a natural resource from below a surface of the earth, the equipment having a component having a cured polysilocarb material.

Additionally, there is provided the present systems, methods and equipment having one or more of the following features: wherein the equipment is a drilling head; wherein the equipment is a blow out preventer; wherein the equipment is a marine riser assembly; wherein the equipment is a well head; wherein the equipment is a derrick; wherein the derrick is on a drill ship; wherein the equipment is a submersible pump; wherein the component having a cured polysilocarb formulation is a surface; and, wherein the surface is an inner surface.

Still further there is provided a down hole equipment for use in obtaining a natural resource from below a surface of the earth, the equipment having a component having a ceramic composite polysilocarb material.

In addition there is provided a down hole equipment for use in obtaining a natural resource from below a surface of the earth, the equipment having a component having a coating having a polysilocarb derived material.

Yet further there provided a method for obtaining a natural resource from a formation within the earth, the method having: providing a downhole equipment, wherein a component of the downhole equipment comprises a polymer derived ceramic material; advancing the downhole equipment in a bore hole below the surface of the earth.

Moreover there is provided a method of making a component for a downhole equipment, the method having: providing a polysilocarb formulation and forming the polysilocarb formulation into a component part of the downhole equipment.

Additionally, there is provided the present systems, methods and equipment having one or more of the following features: curing the component part; machining the component part; pyrolizing the cured component part; pyrolizing the component part; re-infiltrating the pyrolized component part.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a cross-sectional view, depicting an embodiment of drilling a first section of a bore hole in accordance with the present inventions.

FIG. 2 is a cross-sectional view, depicting an embodiment of further drilling of a bore hole beyond a fresh water aquifer in accordance with the present inventions.

FIG. 3 is a cross-sectional view, depicting an embodiment of further drilling in accordance with the present inventions.

FIG. 4 is a cross-sectional view, depicting an embodiment of inserting a surface casing within a bore hole in accordance with the present inventions.

FIG. 5 is a cross-sectional view, depicting an embodiment of pumping cement within a bore hole in accordance with the present inventions.

FIG. 6 is an enlarged cross-sectional view, depicting insertion of casing within the bore hole;

FIG. 7 is an enlarged cross-sectional view, depicting an embodiment further cementing and insertion of casing within the bore hole in accordance with the present inventions.

FIG. 8 is a cross-sectional view, depicting an embodiment of a kickoff point of a horizontal wellbore in accordance with the present inventions.

FIG. 9 is a cross-sectional view, depicting an embodiment to further drilling of a horizontal section of a wellbore;

FIG. 10 is a cross-sectional view, depicting an embodiment of removal of drilling equipment from the horizontal section of the wellbore in accordance with the present inventions.

FIG. 11 is a cross-sectional view, depicting an embodiment of insertion of a casing within the horizontal section of a wellbore in accordance with the present inventions.

FIG. 12 is a cross-sectional view, depicting an embodiment of inserting cement along casing placed in a horizontal section of a wellbore in accordance with the present inventions.

FIG. 13 is a cross-sectional view, depicting an embodiment of further insertion of cement within horizontal section of a wellbore in accordance with the present inventions.

FIG. 14 is a cross-sectional view, depicting the final casing cemented within a horizontal section of a wellbore in accordance with the present inventions.

FIG. 15 is a cross-sectional view, depicting an embodiment of insertion of a perforating gun along the distal section of a horizontal wellbore in accordance with the present inventions.

FIG. 16 is a cross-sectional view, depicting an embodiment of the firing of the perforating gun shown in FIG. 15 in accordance with the present inventions.

FIG. 17 is a cross-sectional view, depicting an embodiment of holes formed within the horizontal section of a wellbore in accordance with the present inventions.

FIG. 18 is a cross-sectional view, depicting an embodiment of the formation of fractures within the earth along the horizontal rail bore in accordance with the present inventions.

FIG. 19 is a cross-sectional view, depicting an embodiment of the insertion of a plug along a horizontal section of a wellbore in accordance with the present inventions.

FIG. 20 is a cross-sectional view, depicting an embodiment of the insertion of another perforating gun proximal of the plug placed in a horizontal section of the wellbore in accordance with the present inventions.

FIG. 21 is a cross-sectional view, depicting an embodiment of fracturing caused proximal the placement of a plug within the horizontal section of a wellbore in accordance with the present inventions.

FIG. 22 is a cross-sectional view, depicting an embodiment of a plurality of plugs placed between fractures formed in a horizontal section of a wellbore in accordance with the present inventions.

FIG. 23 is an enlarged cross-sectional view, depicting an embodiment of drilled out plugs placed between fractures formed in a horizontal section of a wellbore in accordance with the present inventions.

FIG. 24 is a cross-sectional view, depicting an embodiment of the flow of material through the drilled out plugs placed in a horizontal section of a wellbore in accordance with the present inventions.

FIG. 25 is a cross-sectional view, depicting an embodiment of further flowing of material from the fracturing caused in the earth's adjacently horizontal wellbore in accordance with the present inventions.

FIG. 26 is a cross-sectional view, depicting an embodiment of a drill string including a drill head forming a wellbore in accordance with the present inventions.

FIG. 27 is a side and cross-sectional view, depicting an embodiment of a drill pipe in accordance with the present inventions.

FIG. 28 is a cross-sectional view, depicting an embodiment of a component of a hangar system in accordance with the present inventions.

FIG. 29 is a cross-sectional view, depicting an embodiment of components of a multi-lateral system in accordance with the present inventions.

FIG. 30 is a cross-sectional view, depicting an embodiment of packer assemblies placed within a wellbore in accordance with the present inventions.

FIG. 31A is a side view, depicting an embodiment of a sucker rod structure in accordance with the present inventions.

FIG. 31B is an enlarged side view of the embodiment of FIG. 31A.

FIG. 32 is a cross-sectional view, depicting an embodiment of a structure of a perforating gun in accordance with the present inventions.

FIG. 33 is perspective partial cutaway view of an embodiment of a polymer derived riser assembly accordance with the present inventions.

FIG. 34 is a perspective partial cutaway view of a portion of an embodiment of a polymer derived riser assembly in accordance with the present inventions.

### DETAILED DESCRIPTION OF THE PREFERRED EMBODIMENTS

Embodiments of the present inventions relate to polymeric derived materials, and in particular, to polysilocarb derived materials for applications in downhole apparatus, equipment and components and methods for making and utilizing such apparatus. In particular, embodiments of the present inventions relate to drilling activities and structure that utilize polymeric derived siloxane based ceramics and cured materials. Thus, the present disclosure further relates to creating wells, e.g., hydrocarbon producing wells, water wells, geothermal wells, and other natural resource providing wells, to increase and enhance the production from these wells by employing siloxane based polymeric derived ceramic down hole drilling apparatus, equipment and components.

Formulations and methods of making polymeric derived ceramic materials are disclosed and taught in U.S. patent application Ser. Nos. 14/212,896; 14/268,150; 14/324,056; 14/634,814; 62/106,094; 61/788,632; 61/818,906; 61/818,981; 61/843,014; 61/890,808; and 61/946,598, the entire disclosures of each of which are incorporated herein by reference.

Generally, unique and novel silicon (Si) based materials that are easy to manufacture, handle and have surprising and unexpected properties and applications. These silicon based materials have applications and utilizations as a liquid material, a cured material, e.g., a plastic, a preceramic, and a pyrolized material, e.g., a ceramic.

The silicon based materials of the present inventions go against the general trends of the art of silicon chemistry and uses. Generally, the art of silicon chemistry, and in particular organosilicon chemistry, has moved toward greater and greater complexity in the functional groups that are appended to, and a part of, a silicon based polymeric backbone. Similarly, in general, the processes that are utilized to make these polymers have moved toward greater and greater complexity. The present inventions move away from this trend, by preferably functionalizing a silicon based polymeric backbone with simpler structures, such as phenyl, phenylethyl and smaller groups, and do so with processes that are simplified, e.g., solvent free, reduced solvent, lower cost starting materials, fewer steps, and reduction of reaction intermediates.

Further, and generally, the art views silicones as tacky, soft or liquid materials that are used with, on, or in conjunction with, other materials to enhance or provide a performance feature to those other materials. Silicon based materials generally are not viewed as stand alone products, primary products, or structural elements. The silicon based materials of the present inventions, however, move away from this trend and understanding in the art. The silicon based materials of the present inventions provide materials that, among other things, can function as stand alone products, primary products and structural elements. The silicon based materials of the present invention can also function as composites, coatings, components, additives, material performance enhancers, and other applications and utilizations.

Thus, the present inventions provide a new material systems and platform having many varied formulations, applications and uses, which could not generally have been obtained with prior silicon based products, and in particular, could not generally have been obtained with prior silicon based products at acceptable costs, volumes, manufacturing conditions, handling requirements, or processing conditions among other things.

Generally, the present inventions are directed toward “polysilocarb” materials, e.g., material containing silicon (Si), oxygen (O) and carbon (C), and materials that have been pyrolized from such materials. Polysilocarb materials may also contain other elements. Polysilocarb materials are made from one or more polysilocarb precursor formulation or precursor formulation. The polysilocarb precursor formulation contains one or more functionalized silicon polymers, or monomers, as well as, potentially other ingredients, such as for example, inhibitors, catalysts, pore formers, fillers, reinforcers, fibers, particles, colorants, pigments, dies, polymer derived ceramics (“PDC”), ceramics, metals, metal complexes, and combinations and variations of these and other materials and additives.

The polysilocarb precursor formulation is then cured to form a solid or semi-sold material, e.g., a plastic. The polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon it's intended use and purpose. For example, in some situations the end cure and the hard cure may be the same.

The curing may be done at standard ambient temperature and pressure (“SATP”, 1 atmosphere, 25° C.), at temperatures above or below that temperature, at pressures above or below that pressure, and over varying time periods (both continuous and cycled, e.g., heating followed by cooling and reheating), from less than a minute, to minutes, to hours, to days (or potentially longer), and in air, in liquid, or in a preselected atmosphere, e.g., Argon (Ar) or nitrogen (N₂).

The polysilocarb precursor formulations can be made into non-reinforced, non-filled, composite, reinforced, and filled structures, intermediates and end products, and combinations and variations of these and other types of materials. Further, these structures, intermediates and end products can be cured (e.g., green cured, end cured, or hard cured), uncured, pyrolized to a ceramic, and combinations and variations of these (e.g., a cured material may be filled with pyrolized beads derived from the same polysilocarb as the cured material).

The precursor formulations may be used to form a “neat” materials, (by “neat” material it is meant that all, and essentially all of the structure is made from the precursor material or unfilled formulation; and thus, there are no fillers or reinforcements). They may be used to form composite materials, e.g., reinforced products. They may be used to form non-reinforced materials, which are materials that are made of primarily, essentially, and preferably only from the precursor materials, for example a pigmented polysiloxane structure having only precursor material and a colorant would be considered non-reinforced material.

In making the polysilocarb precursor formulation into a structure, part, intermediate, or end product, the polysilocarb formulation can be, for example, sprayed, flowed, thermal sprayed, painted, molded, formed, extruded, spun, dropped, injected or otherwise manipulated into essentially any volumetric shape, including planer shape (which still has a volume, but is more akin to a coating, skin, film, or even a counter top, where the thickness is significantly smaller, if not orders of magnitude smaller, than the other dimensions), and combinations and variations of these. These volumetric shapes would include, for example, spheres, pellets, rings, lenses, disks, panels, cones, frustoconical shapes, squares, rectangles, trusses, angles, channels, hollow sealed chambers, hollow spheres, blocks, sheets, coatings, films, skins, particulates, beams, rods, angles, columns, fibers, staple fibers, tubes, cups, pipes, and combinations and various of these and other more complex shapes, both engineering and architectural. Additionally, they may be shaped into preforms, or preliminary shapes that correspond to, or with, a final product, such as for example use in or with, a break pad, a clutch plate, a break shoe, a motor, high temperature parts of a motor, a diesel motor, rocket components, turbine components, air plane components, space vehicle components, building materials, shipping container components, and other structures or components.

The polysilocarb precursor formulations may be used with reinforcing materials to form a composite material. Thus, for example, the formulation may be flowed into, impregnated into, absorbed by or otherwise combined with a reinforcing material, such as carbon fibers, glass fiber, woven fabric, non-woven fabric, copped fibers, fibers, rope, braided structures, ceramic powders, glass powders, carbon powders, graphite powders, ceramic fibers, metal powders, carbide pellets or components, staple fibers, tow, nanostructures of the above, PDCs, any other material that meets the temperature requirements of the process and end product, and combinations and variations of these. Thus, for example, the reinforcing materials may be any of the high temperature resistant reinforcing materials currently used, or capable of being used with, existing plastics and ceramic composite materials. Additionally, because the polysilocarb precursor formulation may be formulated for a lower temperature cure (e.g., SATP) or a cure temperature of for example about 100° F. to about 400° F., the reinforcing material may be polymers, organic polymers, such as nylons, polypropylene, and polyethylene, as well as aramid fibers, such as NOMEX or KEVLAR.

The reinforcing material may also be made from, or derived from the same material as the formulation that has been formed into a fiber and pyrolized into a ceramic, or it may be made from a different precursor formulation material, which has been formed into a fiber and pyrolized into a ceramic. In addition to ceramic fibers derived from the precursor formulation materials that may be used as reinforcing material, other porous, substantially porous, and non-porous ceramic structures derived from a precursor formulation material may be used.

The polysilocarb precursor formulation may be used to form a filled material. A filled material would be any material having other solid, or semi-solid, materials added to the polysilocarb precursor formulation. The filler material may be selected to provide certain features to the cured product, the ceramic product or both. These features may relate to or be aesthetic, tactile, thermal, density, radiation, chemical, magnetic, electric, and combinations and variations of these and other features. These features may be in addition to strength. Thus, the filler material may not affect the strength of the cured or ceramic material, it may add strength, or could even reduce strength in some situations. The filler material could impart color, magnetic capabilities, fire resistances, flame retardance, heat resistance, electrical conductivity, anti-static, optical properties (e.g., reflectivity, refractivity and iridescence), aesthetic properties (such as stone like appearance in building products), chemical resistivity, corrosion resistance, wear resistance, abrasions resistance, thermal insulation, UV stability, UV protective, and other features that may be desirable, necessary, and both, in the end product or material. Thus, filler materials could include copper lead wires, thermal conductive fillers, electrically conductive fillers, lead, optical fibers, ceramic colorants, pigments, oxides, dyes, powders, ceramic fines, PDC particles, pore-formers, carbosilanes, silanes, silazanes, silicon carbide, carbosilazanes, siloxane, powders, ceramic powders, metals, metal complexes, carbon, tow, fibers, staple fibers, boron containing materials, milled fibers, glass, glass fiber, fiber glass, and nanostructures (including nanostructures of the forgoing) to name a few. For example, crushed, PDC particles, e.g., fines or beads, can be added to a polysilocarb formulation and then cured to form a filled cured plastic material, which has significant fire resistant properties as a coating or structural material.

As used herein, unless specifically provided otherwise, the terms flame retardant, fire retardant, flame resistant, fire resistant, flame protection, fire protection, flame suppression, fire suppression, and similar such terms are to be given their broadest possible meanings, and would include all burning, fire, combustion or flame related meanings that are found, described or set forth in standards, codes, certifications, regulations, and guidelines, and would include the lessening, reduction, and avoidance of fire, combustion or smoke.

The fill material may also be made from, or derived from the same material as the formulation that has been formed into a cured or pyrolized solid, or it may be made from a different precursor formulation material, which has been formed into a cured solid or semi-solid, or pyrolized solid.

The polysilocarb formulation and products derived or made from that formulation may have metals and metal complexes. Thus, metals as oxides, carbides or silicides can be introduced into precursor formulations, and thus into a silica matrix in a controlled fashion. Thus, using organometallic, metal halide (chloride, bromide, iodide), metal alkoxide and metal amide compounds of transition metals and then copolymerizing in the silica matrix, through incorporation into a precursor formulation is contemplated.

For example, Cyclopentadienyl compounds of the transition metals can be utilized. Cyclopentadienyl compounds of the transition metals can be organized into two classes: Bis-cyclopentadienyl complexes; and Mono-cyclopentadienyl complexes. Cyclopentadienyl complexes can include C₅H₅, C₅Me₅, C₅H₄Me, CH₅R₅ (where R=Me, Et, Propyl, i-Propyl, butyl, Isobutyl, Sec-butyl). In either of these cases Si can be directly bonded to the Cyclopentadienyl ligand or the Si center can be attached to an alkyl chain, which in turn is attached to the Cyclopentadienyl ligand.

Cyclopentadienyl complexes, that can be utilized with precursor formulations and in products, can include: bis-cyclopentadienyl metal complexes of first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum); Lanthanide series (La, Ce, Pr, Nd, Pm, Sm, Eu, Gd, Tb, Dy, Ho); Actinide series (Ac, Th, Pa, U, Np).

Monocyclopentadienyl complexes may also be utilized to provide metal functionality to precursor formulations and would include monocyclopentadienyl complexes of: first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum) when preferably stabilized with proper ligands, (for instance Chloride or Carbonyl).

Alky complexes of metals may also be used to provide metal functionality to precursor formulations and products. In these alkyl complexes the Si center has an alkyl group (ethyl, propyl, butyl, vinyl, propenyl, butenyl) which can bond to transition metal direct through a sigma bond. Further, this would be more common with later transition metals such as Pd, Rh, Pt, Ir.

Coordination complexes of metals may also be used to provide metal functionality to precursor formulations and products. In these coordination complexes the Si center has an unsaturated alkyl group (vinyl, propenyl, butenyl, acetylene, butadienyl) which can bond to carbonyl complexes or ene complexes of Cr, Mo, W, Mn, Re, Fe, Ru, Os, Co, Rh, Ir, Ni. The Si center may also be attached to a phenyl, substituted phenyl or other aryl compound (pyridine, pyrimidine) and the phenyl or aryl group can displace carbonyls on the metal centers.

Metal alkoxides may also be used to provide metal functionality to precursor formulations and products. Metal alkoxide compounds can be mixed with the Silicon precursor compounds and then treated with water to form the oxides at the same time as the polymer, copolymerize. This can also be done with metal halides and metal amides. Preferably, this may be done using early transition metals along with Aluminum, Gallium and Indium, later transition metals: Fe, Mn, Cu, and alkaline earth metals: Ca, Sr, Ba, Mg.

Compounds where Si is directly bonded to a metal center which is stabilized by halide or organic groups may also be utilized to provide metal functionality to precursor formulations and products.

Additionally, it should be understood that the metal and metal complexes may be the continuous phase after pyrolysis, or subsequent heat treatment. Formulations can be specifically designed to react with selected metals to in situ form metal carbides, oxides and other metal compounds, generally known as cermets (e.g., ceramic metallic compounds). The formulations can be reacted with selected metals to form in situ compounds such as mullite, alumino silicate, and others. The amount of metal relative to the amount of silica in the formulation or end product can be from about 0.1 mole to 99.9 mole %, about 1 mole % or greater, about 10 mole % or greater, about 20 mole percent or greater % and greater. The forgoing use of metals with the present precursor formulas can be used to control and provide predetermined stoichiometries.

Filled materials would include reinforced materials. In many cases, cured, as well as pyrolized polysilocarb filled materials can be viewed as composite materials. Generally, under this view, the polysilocarb would constitute the bulk or matrix phase, (e.g., a continuous, or substantially continuous phase), and the filler would constitute the dispersed (e.g., non-continuous), phase.

It should be noted, however, that by referring to a material as “filled” or “reinforced” it does not imply that the majority (either by weight, volume, or both) of that material is the polysilocarb. Thus, generally, the ratio (either weight or volume) of polysilocarb to filler material could be from about 0.1:99.9 to 99.9:0.1. Smaller amounts of filler material or polysilocarb could also be present or utilized, but would more typically be viewed as an additive or referred to in other manners. Thus, the terms composite, filled material, polysilocarb filled materials, reinforced materials, polysilocarb reinforced materials, polysilocarb filled materials, polysilocarb reinforced materials and similar such terms should be viewed as non-limiting as to amounts and ratios of the material's constitutes, and thus in this context, be given their broadest possible meaning.

The polysilocarb precursor formulation may be specifically formulated to cure under conditions (e.g., temperature, and perhaps time) that match, e.g., are predetermined to match, the properties of the reinforcing material, filler material or substrate. These materials may also be made from, or derived from, the same material as the polysilocarb precursor formulation that is used as the matrix, or it may be made from a different polysilocarb precursor formulation. In addition to ceramic fibers derived from the polysilocarb precursor formulation materials, porous, substantially porous, and non-porous ceramic structures derived from a polysilocarb precursor formulation material may be used as filler or reinforcing material.

The polysilocarb precursor formulations may be used to coat or impregnate a woven or non-woven fabric, made from for example carbon fiber, glass fibers or fibers made from a polysilocarb precursor formulation (the same or different formulation), to from a prepreg material. Further, a polysilocarb precursor formulation may be used as an interface coating on the reinforcing material, for use either with a polysilocarb precursor formulation as the matrix material. Further, carbon fiber may be heat treated to about 1,400° to about 1,800° or higher, which creates a surface feature that eliminates the need for a separate interface coating, for use with polysilocarb precursor formulations.

Fillers can reduce the amount of shrinkage that occurs during the processing of the formulation into a ceramic, they can be used to provide a predetermined density of the product, either reducing or increasing density, and can be used to provide other customized and predetermined product and processing features. Fillers, at larger amounts, e.g., greater than 10%, can have the effect of reducing shrinkage during cure.

Depending upon the particular application, product or end use, the filler can be evenly distributed in the precursor formulation, unevenly distributed, a predetermined rate of settling, and can have different amounts in different formulations, which can then be formed into a product having a predetermined amounts of filler in predetermined areas, e.g., striated layers having different filler concentration.

Preferably, for a typical filled product, the filler is substantially evenly distributed and more preferably evenly distributed within the end product. In this manner localize stresses or weak points can be avoided. Generally, for a non-reinforced material each filler particle may have a volume that is less than about 0.3%, less than about 0.2%, less than about 0.1%, and less than about 0.05% of the volume of a product, intermediate or part. For example if the product is spherical in shape and the filler is spherical in shape the diameter of the filler should preferable be about 1/10 to about 1/20 of the diameter of the proppant particle, and more preferably the filler diameter should be less than about 1/20 of the diameter of the proppant particle. Generally, the relative amount of filler used in a material should preferable be about 30% to about 65% of the volume of the sphere, e.g., volume %.

Generally, when a small particulate filler, e.g., fines, beads, pellets, is used for the purposes of increasing strength, without the presence of fibers, fabric, etc., generally at least about 2% to at least about 5 volume %, can show an increase in the strength, although this may be greater or smaller depending upon other factors, such as the shape and volume of the product, later processing conditions, e.g., cure time, temperature, number of pyrolysis reinfiltrations. Generally, as the filler level increases from about above 5 volume % no further strength benefits may be realized. Such small particulate filled products, in which appreciable strength benefits are obtained from the filler, and in particular an increase in strength of at least about 5%, at last about 10% and preferably at least about 20% would be considered to be reinforced products and materials.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

At various points during the manufacturing process, the polysilocarb structures, intermediates and end products, and combinations and variations of these, may be machined, milled, molded, shaped, drilled or otherwise mechanically processed and shaped.

Generally, the term “about” is meant to encompass a variance or range of ±10%, the experimental or instrument error associated with obtaining the stated value, and preferably the larger of these.

The precursor formulations are preferably clear or are essentially colorless and generally transmissive to light in the visible wavelengths. They may, depending upon the formulation have a turbid, milky or clouding appearance. They may also have color bodies, pigments or colorants, as well as color filler (which can survive pyrolysis, for ceramic end products, such as those used in ceramic pottery glazes). The precursor may also have a yellow or amber color or tint, without the need of the addition of a colorant.

The precursor formulations may be packaged, shipped and stored for later use in forming products, e.g., structures or parts, or they may be used directly in these processes, e.g., continuous process to make a product. Thus, a precursor formulation may be stored in 55 gallon drums, tank trucks, rail tack cars, onsite storage tanks having the capable of holding hundreds of gals, and shipping totes holding 1,000 liters, by way of example. Additionally, in manufacturing process the formulations may be made and used in a continuous, and semi-continuous processes.

The present inventions, among other things, provide substantial flexibility in designing processes, systems, ceramics, having processing properties and end product performance features to meet predetermined and specific performance criteria. Thus, for example the viscosity of the precursor formulation may me predetermined by the formulation to match a particular morphology of the reinforcing material, the cure temperature of the precursor formulation may be predetermined by the formulation to enable a prepreg to have an extended shelf life. The viscosity of the of the precursor formulation may be established so that the precursor readily flows into the reinforcing material of the prepreg while at the same time being thick enough to prevent the precursor formulation from draining or running off of the reinforcing material. The formulation of the precursor formulation may also, for example, be such that the strength of a cured preform is sufficient to allow rough or initial machining of the preform, prior to pyrolysis.

Custom and predetermined control of when chemical reactions occur in the various stages of the process from raw material to final end product can provide for reduced costs, increased process control, increased reliability, increased efficiency, enhanced product features, and combinations and variation of these and other benefits. The sequencing of when chemical reactions take place can be based primarily upon the processing or making of precursors, and the processing or making of precursor formulations; and may also be based upon cure and pyrolysis conditions. Further, the custom and predetermined selection of these steps, formulations and conditions, can provide enhanced product and processing features through chemical reactions, molecular arrangements and rearrangements, and microstructure arrangements and rearrangements, that preferably have been predetermined and controlled.

Generally, the process form making the present polysilocarb materials involves one or more steps. The starting materials are obtained, made or derived. Precursors are obtained or can be made from starting materials. The precursors are combined to form a precursor formulation. The precursor formulation is then shaped, formed, molded, etc. into a desired form, which form is then cured, which among other things transforms the precursor formulation into a plastic like material. This cured plastic like material can then be pyrolyzed into a ceramic. It being understood, that these steps may not all be used, that some of these steps may be repeated, once, twice or several times, and that combinations and variations of these general steps may be utilized to obtain a desired product or result.

Depending upon the specific process and desired features of the product the precursors and starting materials, the process type and conditions and the precursors can be predetermined and preselected. This regime of precursors and processes provides great flexibility to create custom features for intermediate, end and final products, and thus, typically, combinations and variations of them, can provide a specific predetermined product. Factors such as cost, controllability, shelf life, scale up, manufacturing ease, etc., can also be considered.

In embodiments, precursor materials may be methyl hydrogen, and substituted and modified methyl hydrogens, siloxane backbone additives, reactive monomers, hydrocarbons, reaction products of a siloxane backbone additive with a silane modifier or an organic modifier, and other similar types of materials, such as silane based materials, silazane based materials, carbosilane based materials, phenol/formaldehyde based materials, and combinations and variations of these and others.

Additionally, inhibitors such as cyclohexane, 1-Ethynyl-1-cyclohexanol (which may be obtained from ALDRICH), Octamethylcyclotetrasiloxane, tetramethyltetravinylcyclotetrasiloxane (which may act, depending upon amount and temperature as a reactant or a reactant retardant (i.e., slows down a reaction to increase pot life), e.g., at room temperature it is a retardant and at elevated temperatures it is a reactant), may be added to the polysilocarb precursor formulation, e.g., an inhibited polysilocarb precursor formulation. Other materials, as well, may be added to the polysilocarb precursor formulation, e.g., a filled polysilocarb precursor formulation, at this point in processing, including fillers such as SiC powder, carbon black, PDC particles, pigments, particles, nano-tubes, whiskers, or other materials, discussed in this specification or otherwise known to the arts. Further, a formulation with both inhibitors and fillers would be considered an inhibited, filled polysilocarb precursor formulation.

Precursors and precursor formulations are preferably non-hazardous materials. Generally they have flash points that are preferably above room and typical storage temperatures, are preferably noncorrosive, preferably have low vapor pressure, low or no odor, and may be non- or mildly irritating to the skin. A catalyst may be used, and can be added at the time of, prior to, shortly before, or at an earlier time before the precursor formulation is formed or made into a structure, prior to curing. Precursor formulations can have pot lives, that meet the needs of the manufacturing process. Generally, catalysts can be used and can be balance with, or used in conjunction with the inhibitor to have a predetermined and predictable shelf life, cure time, cure temperature profiles. These profiles can be tailored to the specific manufacturing processes, e.g., ship and hold for a month before curing, or ship hold and process directly from liquid to ceramic, or make and cure with minimal shipping or hold times.

In this mixing type process for making a precursor formulation, preferably chemical reactions or molecular rearrangements only take place during the making of the precursors, the curing process of the preform, and in the pyrolizing process. Thus, chemical reactions, e.g., polymerizations, reductions, condensations, substitutions, take place or are utilized in the making of a precursor. In making a polysilocarb precursor formulation preferably no and essentially no, chemical reactions and molecular rearrangements take place. These embodiments of the present mixing type process, which avoid the need to, and do not, utilize a polymerization or other reaction during the making of a precursor formulation, provides significant advantages over prior methods of making polymer derived ceramics. Preferably, in the embodiments of these mixing type of formulations and processes, polymerization, crosslinking or other chemical reactions take place primarily, preferably essentially, and more preferably solely in the preform during the curing process.

The precursors may also be selected from the following:

| | | |
|---|---|---|
| SiSIB ® | TRIMETHYLSILYL TERMINATED METHYL | 63148- |
| HF2020 | HYDROGEN SILICONE FLUID | 57-2 |

This is a type of material commonly called methylhydrogen fluid, and has the formula below:

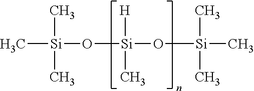

| | | |
|---|---|---|
| SiSiB ® | TRIMETHYLSILYL TERMINATED | 68037- |
| HF2050 | METHYLHYDROSILOXANE | 59-2 |
| | DIMETHYLSILOXANE COPOLYMER | |

This may be called methyl terminated with dimethyl groups and has the formula below.

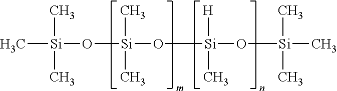

In some embodiments this precursor can decrease the exotherm and decrease shrinkage

| | | |
|---|---|---|
| SiSiB ® | HYDRIDE TERMINATED | 69013- |
| HF2060 | METHYLHYDROSILOXANE | 23-6 |
| | DIMETHYLSILOXANE COPOLYMER | |

This may be called hydride terminated with dimethyl groups and has the formula below.

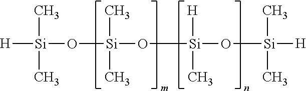

In some embodiments this precursor can decrease the exotherm and decrease shrinkage and provide branch points

### SiSiB® HF2038 HYDROGEN TERMINATED POLYDIPHENYL SILOXANE

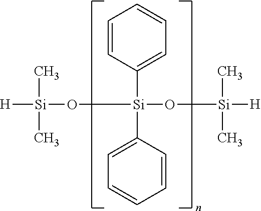

In some embodiments this precursor can improve as-cured toughness and decrease shrinkage and improve thermal stability of as-cured material

| | | |
|---|---|---|
| SiSIB ® | HYDRIDE TERMINATED | 115487- |
| HF2068 | METHYLHYDROSILOXANE | 49-5 |
| | DIMETHYLSILOXANE COPOLYMER | |

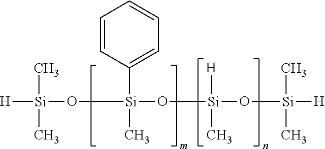

In some embodiments this precursor can improve as-cured toughness and decrease shrinkage and improve thermal stability of as-cured material; but, may allow for higher cross-link density

| | | |
|---|---|---|
| iSiB ® | HYDRIDE TERMINATED POLY(PHENYL- | 68952- |
| HF2078 | DIMETHYLSILOXY) SILOXANE | 30-7 |
| | PHENYL SILSESQUIOXANE, HYDROGEN- | |
| | TERMINATED | |

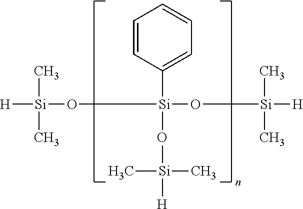

In some embodiments this precursor's tri-functionality can be used for controlled branching, as well as in some embodiments to reduced shrinkage.

| | | |
|---|---|---|
| SiSiB ® | VINYLDIMETHYL TERMINATED VINYLMETHYL- | 68083- |
| VF6060 | DIMETHYL POLYSILOXANE COPOLYMERS | 18-1 |

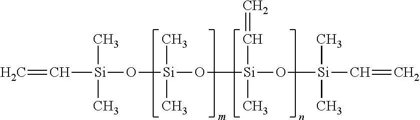

In some embodiments this precursor's tri-functionality can be used for controlled branching, as well as in some embodiments to reduced shrinkage.

| | | |
|---|---|---|
| SiSiB ® | VINYLDIMETHYL TERMINATED DIMETHYL- | 68951- |
| VF6862 | DIPHENYL POLYSILOXANE COPOLYMER | 96-2 |

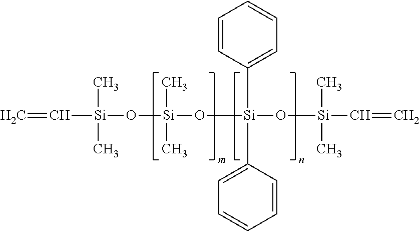

In some embodiments this precursor can be used to improve as cured toughness and decreased shrinkage

| | | |
|---|---|---|
| SiSiB ® | VINYLDIMETHYL TERMINATED | — |
| VF6872 | DIMETHYL-METHYLVINYL- | |
| | DIPHENYL POLYSILOXANE COPOLYMER | |

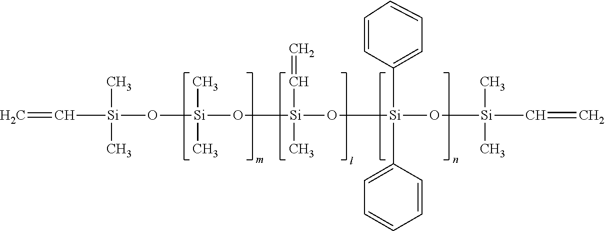

In some embodiments this precursor can be used to improve as cured toughness and decreased shrinkage; as well as providing the ability to improve crosslink density through branching if needed.

### SiSiB® PC9401 1,1,3,3-TETRAMETHYL-1,3-DIVINYLDISILOXANE 2627-95-4

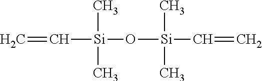

In some embodiments this precursor may provided for less shrinkage than the tetravinyl; but still can provide for high crosslink density due to high vinyl percentage, but primarily through 2-dimensional crosslinking, without any branching

| | | |
|---|---|---|
| SiSiB ® | SILANOL TERMINATED | 70131-67- |
| PF1070 | POLYDIMETHYLSILOXANE (OF1070) | 8 |

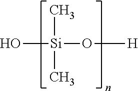

In some embodiments this precursor may assist in decreasing the density by in-situ nano/micro pore formation.

| | | |
|---|---|---|
| SiSiB ® | SILANOL TERMINATED | 70131-67- |
| OF1070 | POLYDIMETHYSILOXANE | 8 |
| | OH-ENDCAPPED POLYDIMETHYLSILOXANE | |
| | HYDROXY TERMINATED | 73138-87- |
| | POLYDIMETHYLSILOXANE | 1 |

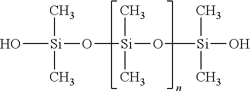

In some embodiments this precursor may assist in decreasing the density by in-situ nano/micro pore formation.

### SiSiB® VF6030 VINYL TERMINATED POLYDIMETHYL SILOXANE 68083-19-2

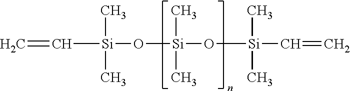

In some embodiments this precursor can increase cure speed, decrease shrinkage slightly, and improves thermal/structural stability of cured and pyrolyzed material

| | | |
|---|---|---|
| SiSiB ® | HYDROGEN TERMINATED | 70900-21- |
| HF2030 | POLYDIMETHYLSILOXANE FLUID | 9 |

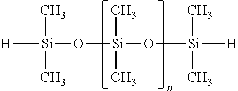

In general, embodiments of formulations for polysilocarb formulations may for example have from about 20% to about 99% MH, about 0% to about 30% siloxane backbone additives, about 1% to about 60% reactive monomers, and, about 0% to about 90% reaction products of a siloxane backbone additives with a silane modifier or an organic modifier reaction products.

In mixing the formulations a sufficient time to permit the precursors to become effectively mixed and dispersed. Typically, the precursor formulations are relatively, and essentially, shear insensitive, and thus the type of pumps or mixing are not critical. It is further noted that in higher viscosity formulations additional mixing time may be required. Embodiments of processes can provide the ability to build custom precursor formulations that when cured can provide plastics having unique and desirable features such as high temperature, flame resistance and retardation, strength and other features. The cured materials can also be pyrolized to form ceramics having unique features. This allows for the predetermined balancing of different types of functionality in the end product by selecting function groups for incorporation into the polymer that makes up the precursor formulation.

Embodiments of a preform can be cured in a controlled atmosphere, such as an inert gas, or it can be cured in the atmosphere. The cure conditions, e.g., temperature, time, rate, etc., can be predetermined by the formulation and other processing conditions. For example, such conditions can be selected to match, the size of the preform, the shape of the preform, or the mold holding the preform to prevent stress cracking, off gassing, or other problems associated with the curing process. Further, the curing conditions may be such as to take advantage of, in a controlled manner, what may have been previously perceived as problems associated with the curing process. Thus, for example, off gassing may be used to create a foam material having either open or closed structure. Further, the porosity of the material may be predetermined such that, for example, a particular pore size may be obtained, and in this manner a filter or ceramic screen having predetermined pore sizes, flow characteristic may be made.

The preforms, either unreinforced, neat, or reinforced, may be used as a stand alone product, an end product, a final product, or a preliminary product for which later machining or processing may be performed on. The preforms may also be subject to pyrolysis, which converts the preform material into a ceramic.

In pyrolizing the preform, or cured structure or cured material, in some embodiments it is heated to above about 650° C. to about 1,200° C. At these temperatures typically all organic structures are either removed or combined with the inorganic constituents to form a ceramic. Typically at temperatures in the 650° C. to 1,200° C. range the material is an amorphous glassy ceramic. When heated above 1,200° C. the material may from nano crystalline structures, or micro crystalline structures, such as SiC, Si3N₄, SiCN, β SiC, and above 1,900° C. an α SiC structure may form.

During pyrolysis material is loss through off gassing. The amount of material remaining at the end of a pyrolysis set is referred to as char yield (or pyrolysis yield). Embodiments of formulations are capable of being air pyrolized to form a ceramic and to preferably do so at char yield in excess of at least about 80% and above 88%. The initial or first pyrolysis step generally yields a structure that is not very dense. However, in some examples, such as the use of light weight spheres, the first pyrolysis may be sufficient. Thus, there can be in some embodiments a reinfiltration process that may be performed on the pyrolized material, to add in additional polysilocarb precursor formulation material, to fill in, or fill the voids and spaces in the structure. This reinfiltrated material is they repyrolized. This process of pyrolization, reinfiltration may be repeated, through one, two, three, and up to 10 or more times to obtain the desired density of the final product. Additionally, with formulations of embodiments of the present inventions, the viscosity of the formulation may be tailored to provide more efficient reinfiltrations, and thus, a different formulation may be used at later reinfiltration steps, as the voids or pores become smaller and more difficult to get the formulation material into it. The high char yields, and other features of embodiments of the present invention, enable the manufacture of completely closed structures, e.g., “helium tight” materials, with less than twelve reinfiltration steps, less than about 10 reinfiltrations steps and less than five reinfiltrations steps. Thus, by way of example, an initial inert gas pyrolysis may be performed with a high char yield formulation followed by four reinfiltration air pyrolysis steps.

Embodiments of the present inventions have the ability to utilize precursors that have impurities, high-level impurities and significant impurities. Thus, the precursors may have more than about 0.1% impurities, more than about 0.5%, more than about 1% impurities, more than about 5% impurities, more than about 10% impurities, and more than about 50% impurities. In using materials with impurities, the amounts of these impurities, or at least the relative amounts, so that the amount of actual precursor is known, should preferably be determined by for example GPC (Gel Permeation Chromatography) or other methods of analysis. In this manner the formulation of the polysilocarb precursor formulation may be adjusted for the amount of impurities present. The ability of embodiments of the present invention to utilize lower level impurity materials, and essentially impure materials, and highly impure materials, provides significant advantages over other method of making polymer derived ceramics. This provides two significant advantages, among other things. First, the ability to use impure, lower purity, materials in embodiments of the present inventions, provides the ability to greatly reduce the cost of the formulations and end products, e.g., cured preforms, cured parts, and ceramic parts or structures. Second, the ability to use impure, lower purity, materials in embodiments of the present inventions, provides the ability to have end products, e.g., cured preforms, cured parts, and ceramic parts or structures, that have a substantially greater consistence from part to part, because variations in starting materials can be adjusted for during the formulation of each polysilocarb precursor formulation.

The equipment, processes and techniques to make the present inventions can be any of the systems, processes and techniques disclosed and taught in this specification, know to the art for molding, forming, extruding, coating, and assembling components, as well as, those disclosed and taught in U.S. patent application Ser. Nos. 14/212,986, 14/268,150, 14/324,056, 14/514,257, 61/946,598 and 62/055,397 and 62/106,094, the entire disclosure of each of which are incorporated herein by reference.

It should be understood that the use of headings in this specification is for the purpose of clarity, reference, and is not limiting in any way. Thus, the processes compositions, and disclosures described under a heading should be read in context with the entirely of this specification, including the various examples. The use of headings in this specification should not limit the scope of protection afford the present inventions.

General Processes for Obtaining a Polysilocarb Precursor

Typically polymer derived ceramic precursor formulations, and in particular polysilocarb precursor formulations can generally be made by three types of processes, although other processes, and variations and combinations of these processes may be utilized. These processes generally involve combining precursors to form a precursor formulation. One type of process generally involves the mixing together of precursor materials in preferably a solvent free process with essentially no chemical reactions taking place, e.g., “the mixing process.” The other type of process generally involves chemical reactions, e.g., “the reaction type process,” to form specific, e.g., custom, precursor formulations, which could be monomers, dimers, trimers and polymers. A third type of process has a chemical reaction of two or more components in a solvent free environment, e.g., “the reaction blending type process.” Generally, in the mixing process essentially all, and preferably all, of the chemical reactions take place during subsequent processing, such as during curing, pyrolysis and both.

It should be understood that these terms—reaction type process, reaction blending type process, and the mixing type process—are used for convenience and as a short hand reference. These terms are not, and should not be viewed as, limiting. For example, the reaction process can be used to create a precursor material that is then used in the mixing process with another precursor material.

These process types are described in this specification, among other places, under their respective headings. It should be understood that the teachings for one process, under one heading, and the teachings for the other processes, under the other headings, can be applicable to each other, as well as, being applicable to other sections, embodiments and teachings in this specification, and vice versa. The starting or precursor materials for one type of process may be used in the other type of processes. Further, it should be understood that the processes described under these headings should be read in context with the entirely of this specification, including the various examples and embodiments.

It should be understood that combinations and variations of these processes may be used in reaching a precursor formulation, and in reaching intermediate, end and final products. Depending upon the specific process and desired features of the product the precursors and starting materials for one process type can be used in the other. A formulation from the mixing type process may be used as a precursor, or component in the reaction type process, or the reaction blending type process. Similarly, a formulation from the reaction type process may be used in the mixing type process and the reaction blending process. Similarly, a formulation from the reaction blending type process may be used in the mixing type process and the reaction type process. Thus, and preferably, the optimum performance and features from the other processes can be combined and utilized to provide a cost effective and efficient process and end product. These processes provide great flexibility to create custom features for intermediate, end, and final products, and thus, any of these processes, and combinations of them, can provide a specific predetermined product. In selecting which type of process is preferable, factors such as cost, controllability, shelf life, scale up, manufacturing ease, etc., can be considered.

In addition to being commercially available the precursors may be made by way of an alkoxylation type process, e.g., an ethoxylation process. In this process chlorosilanes are reacted with ethanol in the presences of a catalysis, e.g., HCl, to provide the precursor materials, which materials may further be reacted to provide longer chain precursors. Other alcohols, e.g., methanol may also be used. Thus, for example SiCl₄, SiCl₃H, SiCl₂(CH₃)₂, SiCl₂(CH₃)H, Si(CH₃)3Cl, Si(CH₃)ClH, are reacted with ethanol CH₃CH₂OH to form precursors. In some of these reactions phenols may be the source of the phenoxy group, which is substituted for a hydride group that has been placed on the silicon. One, two or more step reactions may need to take place.

Precursor materials may also be obtained by way of an acetylene reaction route. In general there are several known paths for adding acetylene to Si—H. Thus, for example, tetramethylcyclotetrasiloxane can be reacted with acetylene in the presence of a catalyst to produce tetramethyltetravinylcyclotetrasiloxane. This product can then be ring opened and polymerized in order to form linear vinyl, methylsiloxanes. Alternatively, typical vinyl silanes can be produced by reacting methyl, dichlorosilane (obtained from the direct process or Rochow process) with acetylene. These monomers can then be purified (because there may be some scrambling) to form vinyl, methyl, dichlorosilane. Then the vinyl monomer can be polymerized via hydrolysis to form many cyclic, and linear siloxanes, having various chain lengths, including for example various cyclotetrasiloxanes (e.g., D₄′) and various cyclopentasiloxanes (e.g., D₅′). These paths, however, are costly, and there has been a long standing and increasing need for a lower cost raw material source to produce vinyl silanes. Prior to the present inventions, it was not believed that MHF could be used in an acetylene addition process to obtain vinyl silanes. MHF is less expensive than vinyl, methyl (either linear or cyclic), and adding acetylene to MHF to make vinyl meets, among other things, the long standing need to provide a more cost effective material and at relatively inexpensive costs. In making this addition the following variables, among others, should be considered and controlled: feed (D₄′, linear methyl, hydrogen siloxane fluids); temperature; ratio of acetylene to Si—H; homogeneous catalysts (Karstedt's, DBT Laureate, no catalyst, Karstedt's with inhibitor); supported catalysts (Pt on carbon, Pt on alumina, Pd on alumina); flow rates (liquid feed, acetylene feed); pressure; and, catalyst concentration. Examples of embodiments of reactions providing for the addition of acetylene to MHF (cyclic and linear) are provided in Tables A and B. Table A are batch acetylene reactions. Table B are continuous acetylene reactions. It should be understood that batch, continuous, counter current flow of MHF and acetylene feeds, continuous recycle of single pass material to achieve higher conversions, and combinations and variations of these and other processes can be utilized.

TABLE A
Batch Acetylene Reactions

| | | Methyl | | | | Amount of | | Acetylene | Reaction | Acetyl Mol % |
|---|---|---|---|---|---|---|---|---|---|---|
| | | Hydride | Catalyst % | | | Solvent | Temp | Flow | Time | (rel to Total |
| Run | Si—H | (grams) | (rel to MeH) | Inhibitor | Solvent | (grams) | (° C.) | (ccm) | (hrs) | Hydride) |
| 1 | MHF | 400 | 0.48% | 0.00% | — | — | 80-100 | — | 0.20 | — |
| 2 | MHF | 1000 | 0.27% | 0.00% | — | — | 65-75 | 276-328 | 0.75 | 3.4% |
| 3 | MHF | 1000 | 0.00% | 0.00% | — | — | 80 | 378-729 | 6.33 | 49.4% |
| | | | | | | | 100 | | | |
| | | | | | | | 120 | | | |
| 4 | MHF | 117 | 0.20% | 0.00% | Hexane | 1000 | 60-66 | 155-242 | 4.50 | 188.0% |
| 5 | MHF | 1000 | 0.40% | 0.40% | — | — | 55-90 | 102 | 7.5 | 15.7% |
| 6 | MHF | 360 | 1.00% | 0.00% | Hexane | 392 | 65 | 102 | 6.4 | 40.3% |
| 7a | MHF | 360 | 0.40% | 0.00% | Hexane | 400 | 65 | — | 2.0 | 23.4% |
| 7b | MHF | 280 | 0.40% | 0.00% | Hexane | 454 | 68 | — | 137.0 | 23.4% |
| 8 | D4′ | 1000 | 0.27% | 0.00% | — | — | 79 | 327-745 | 6.5 | 61.3% |
| 9 | MHF | 370 | 0.40% | 0.00% | Hexane | 402 | 65 | 155-412 | 8.0 | 140.3% |

TABLE B
Continuous Acetylene Reactions

| | | | | | | Reactor | Reactor | Acetyl Mol % |
|---|---|---|---|---|---|---|---|---|
| | | Catalyst % | | Silane Conc | | Temp | Pressure | (rel to Total |
| Run | Si—H | (rel to MeH) | Inhibitor | (wt %) | Solvent | (° C.) | (psig) | Hydride) |
| 10 | D4′ | 5% Pt on | 0.00% | 100.0% | — | 60-100 | 50 | 40.0% |
| | | Carbon | | | | | | |
| 11 | D4′ | 5% Pt on | 0.00% | 100.0% | — | 50-90 | 100 | 20.0% |
| | | Carbon | | | | | | |
| 12 | D4′ | 1% Pt on | 0.00% | 100.0% | — | 40-50 | 50 | 23.8% |
| | | Alumina | | | | | | |
| 13 | MHF | 5% Pt on | 0.00% | 100.0% | — | 55-60 | 55-60 | 13.6% |
| | | Carbon | | | | | | |
| 14 | MHF | 0.01% Pt on | 0.00% | 20.0% | Hexane | 20-25 | 50 | 108.5% |
| | | Alumina | | | | | | |
| 15 | MHF | 0.01% Pt on | 0.00% | 20.0% | Hexane | 60 | 50-55 | 117.1% |
| | | Alumina | | | | | | |
| 16 | MHF | 0.01% Pt on | 0.00% | 20.0% | Hexane | 70 | 50 | 125.1% |
| | | Alumina | | | | | | |
| 17 | MHF | 0.12% Pt on | 0.00% | 20.0% | Hexane | 60 | 50 | 133.8% |
| | | Alumina | | | | | | |
| 18 | MHF | 0.12% Pt on | 0.00% | 4.0% | Hexane | 60 | 50 | 456.0% |
| | | Alumina | | | | | | |

(D4′ is tetramethyl tetrahydride cyclotetrasiloxane)

Continuous High Pressure Reactor (“CHPR”) embodiments may be advantageous for, among other reasons: reaction conversion saving more acetylene needed in liquid phase; tube reactors providing pressures which in turn increases solubility of acetylene; reaction with hexyne saving concentration and time (e.g., 100 hours,); can eliminate homogeneous catalyst and thus eliminate hydrosilylation reaction with resultant vinyls once complete; and, using a heterogeneous (Solid) catalyst to maintain product integrity, increased shelf-life, increase pot-life and combinations and variations of these.

In addressing the various conditions in the acetylene addition reactions, some factors may be: crosslinking retardation by dilution, acetylene and lower catalyst concentration; and conversion (using heterogeneous catalyst) may be lower for larger linear molecules compared to smaller molecules.

The presence and quality of vinyl and vinyl conversions can be determined by, among other things: FT-IR for presence of vinyl absorptions, decrease in SiH absorption; ¹H NMR for presence of vinyls and decrease in SiH; ¹³C NMR for presence of vinyls.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

The Mixing Type Process

Precursor materials may be methyl hydrogen, and substituted and modified methyl hydrogens, siloxane backbone additives, reactive monomers, reaction products of a siloxane backbone additive with a silane modifier or an organic modifier, and other similar types of materials, such as silane based materials, silazane based materials, carbosilane based materials, phenol/formaldehyde based materials, and combinations and variations of these. The precursors are preferably liquids at room temperature, although they may be solids that are melted, or that are soluble in one of the other precursors. (In this situation, however, it should be understood that when one precursor dissolves another, it is nevertheless not considered to be a “solvent” as that term is used with respect to the prior art processes that employ non-constituent solvents, e.g., solvents that do not form a part or component of the end product, are treated as waste products, and both.)

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation” or a “formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or over a time period, prior to being cured.

The precursors can be mixed under numerous types of atmospheres and conditions, e.g., air, inert, N₂, Argon, flowing gas, static gas, reduced pressure, elevated pressure, ambient pressure, and combinations and variations of these.

Additionally, inhibitors such as cyclohexane, 1-Ethynyl-1-cyclohexanol (which may be obtained from ALDRICH), Octamethylcyclotetrasiloxane, and tetramethyltetravinylcyclotetrasiloxane, may be added to the polysilocarb precursor formulation, e.g., an inhibited polysilocarb precursor formulation. It should be noted that tetramethyltetravinylcyclotetrasiloxane may act as both a reactant and a reaction retardant (e.g., an inhibitor), depending upon the amount present and temperature, e.g., at room temperature it is a retardant and at elevated temperatures it is a reactant. Other materials, as well, may be added to the polysilocarb precursor formulation, e.g., a filled polysilocarb precursor formulation, at this point in processing, including fillers such as SiC powder, carbon black, sand, polymer derived ceramic particles, pigments, particles, nano-tubes, whiskers, or other materials, discussed in this specification or otherwise known to the arts. Further, a formulation with both inhibitors and fillers would be considered an inhibited, filled polysilocarb precursor formulation.

Depending upon the particular precursors and their relative amounts in the polysilocarb precursor formulation, polysilocarb precursor formulations may have shelf lives at room temperature of greater than 12 hours, greater than 1 day, greater than 1 week, greater than 1 month, and for years or more. These precursor formulations may have shelf lives at high temperatures, for example, at about 90° F., of greater than 12 hours, greater than 1 day, greater than 1 week, greater than 1 month, and for years or more. The use of inhibitors may further extend the shelf life in time, for higher temperatures, and combinations and variations of these. The use of inhibitors, may also have benefits in the development of manufacturing and commercial processes, by controlling the rate of reaction, so that it takes place in the desired and intended parts of the process or manufacturing system.

As used herein the term “shelf life” should be given its broadest possible meaning, unless specified otherwise, and would include, for example, the formulation being capable of being used for its intended purpose, or performing, e.g., functioning, for its intended use, at 100% percent as well as a freshly made formulation, at least about 90% as well as a freshly made formulation, at least about 80% as well as a freshly made formulation, and at least about 70% as well as a freshly made formulation.

Precursors and precursor formulations are preferably non-hazardous materials. They have flash points that are preferably above about 70° C., above about 80° C., above about 100° C. and above about 300° C., and above. Preferably, they may be noncorrosive. Preferably, they may have a low vapor pressure, may have low or no odor, and may be non- or mildly irritating to the skin.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a preform.

The time period where the precursor formulation remains useful for curing after the catalysis is added is referred to as “pot life”, e.g., how long can the catalyzed formulation remain in its holding vessel before it should be used. Depending upon the particular formulation, whether an inhibitor is being used, and if so the amount being used, storage conditions, e.g., temperature, low O₂ atmosphere, and potentially other factors, precursor formulations can have pot lives, for example, of from about 5 minutes to about 10 days, about 1 day to about 6 days, about 4 to 5 days, about 30 minutes, about 15 minutes, about 1 hour to about 24 hours, and about 12 hours to about 24 hours.

The catalyst can be any platinum (Pt) based catalyst, which can, for example, be diluted to a ranges of: about 0.01 parts per million (ppm) Pt to about 250 ppm Pt, about 0.03 ppm Pt, about 0.1 ppm Pt, about 0.2 ppm Pt, about 0.5 ppm Pt, about 0.02 to 0.5 ppm Pt, about 1 ppm to 200 ppm Pt and preferably, for some applications and embodiments, about 5 ppm to 50 ppm Pt. The catalyst can be a peroxide based catalyst with, for example, a 10 hour half life above 90 C at a concentration of between 0.1% to 3% peroxide, and about 0.5% and 2% peroxide. It can be an organic based peroxide. It can be any organometallic catalyst capable of reacting with Si—H bonds, Si—OH bonds, or unsaturated carbon bonds, these catalysts may include: dibutyltin dilaurate, zinc octoate, peroxides, organometallic compounds of for example titanium, zirconium, rhodium, iridium, palladium, cobalt or nickel. Catalysts may also be any other rhodium, rhenium, iridium, palladium, nickel, and ruthenium type or based catalysts. Combinations and variations of these and other catalysts may be used. Catalysts may be obtained from ARKEMA under the trade name LUPEROX, e.g., LUPEROX 231; and from Johnson Matthey under the trade names: Karstedt's catalyst, Ashby's catalyst, Speier's catalyst.

Further, custom and specific combinations of these and other catalysts may be used, such that they are matched to specific formulations, and in this way selectively and specifically catalyze the reaction of specific constituents. Moreover, the use of these types of matched catalyst—formulations systems may be used to provide predetermined product features, such as for example, pore structures, porosity, densities, density profiles, high purity, ultra high purity, and other morphologies or features of cured structures and ceramics.

In this mixing type process for making a precursor formulation, preferably chemical reactions or molecular rearrangements only take place during the making of the starting materials, the curing process, and in the pyrolizing process. Chemical reactions, e.g., polymerizations, reductions, condensations, substitutions, take place or are utilized in the making of a starting material or precursor. In making a polysilocarb precursor formulation by the mixing type process, preferably no and essentially no, chemical reactions and molecular rearrangements take place. These embodiments of the present mixing type process, which avoid the need to, and do not, utilize a polymerization or other reaction during the making of a precursor formulation, provides significant advantages over prior methods of making polymer derived ceramics. Preferably, in the embodiments of these mixing type of formulations and processes, polymerization, crosslinking or other chemical reactions take place primarily, preferably essentially, and more preferably solely during the curing process.

The precursor may be a siloxane backbone additive, such as, methyl hydrogen (MH), which formula is shown below.

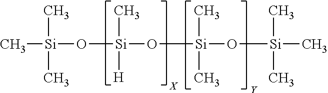

The MH may have a molecular weight (“mw” which can be measured as weight averaged molecular weight in amu or as g/mol) from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. This precursor may also, among other things, be modified by reacting with unsaturated carbon compounds to produce new, or additional, precursors. Typically, methyl hydrogen fluid (MHF) has minimal amounts of “Y”, and more preferably “Y” is for all practical purposes zero.

The precursor may be a siloxane backbone additive, such as vinyl substituted polydimethyl siloxane, which formula is shown below.

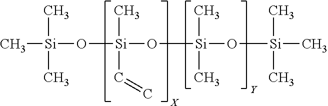

This precursor may have a molecular weight (mw) from about 400 mw to about 10,000 mw, and may have a viscosity preferably from about 50 cps to about 2,000 cps. The percentage of methylvinylsiloxane units “X” may be from 1% to 100%. The percentage of the dimethylsiloxane units “Y” may be from 0% to 99%. Preferably, X is about 100%. This precursor may be used to decrease cross-link density and improve toughness, as well as, other features and characteristics to the cured preform and ceramic material.

The precursor may be a siloxane backbone additive, such as vinyl substituted and vinyl terminated polydimethyl siloxane, which formula is shown below.

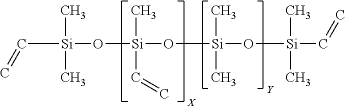

This precursor may have a molecular weight (mw) from about 500 mw to about 15,000 mw, and may preferably have a molecular weight from about 500 mw to 1,000 mw, and may have a viscosity preferably from about 10 cps to about 200 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be a siloxane backbone additive, such as vinyl substituted and hydrogen terminated polydimethyl siloxane, which formula is shown below.

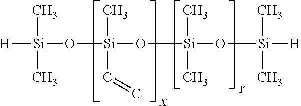

This precursor may have a molecular weight (mw) from about 300 mw to about 10,000 mw, and may preferably have a molecular weight from about 400 mw to 800 mw, and may have a viscosity preferably from about 20 cps to about 300 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be a siloxane backbone additive, such as allyl terminated polydimethyl siloxane, which formula is shown below.

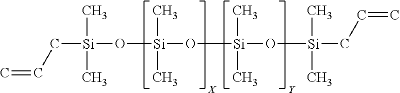

This precursor may have a molecular weight (mw) from about 400 mw to about 10,000 mw, and may have a viscosity preferably from about 40 cps to about 400 cps. The repeating units are the same. This precursor may be used to provide UV curability and to extend the polymeric chain, as well as, other features and characteristics to the cured preform and ceramic material.

The precursor may be a siloxane backbone additive, such as vinyl terminated polydimethyl siloxane, which formula is shown below.

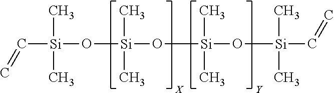

This precursor may have a molecular weight (mw) from about 200 mw to about 5,000 mw, and may preferably have a molecular weight from about 400 mw to 1,500 mw, and may have a viscosity preferably from about 10 cps to about 400 cps. The repeating units are the same. This precursor may be used to provide a polymeric chain extender, improve toughness and to lower cure temperature down to for example room temperature curing, as well as, other features and characteristics to the cured preform and ceramic material.

The precursor may be a siloxane backbone additive, such as silanol (hydroxy) terminated polydimethyl siloxane, which formula is shown below.

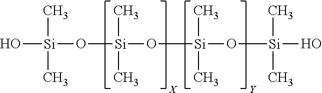

This precursor may have a molecular weight (mw) from about 400 mw to about 10,000 mw, and may preferably have a molecular weight from about 600 mw to 1,000 mw, and may have a viscosity preferably from about 30 cps to about 400 cps. The repeating units are the same. This precursor may be used to provide a polymeric chain extender, a toughening mechanism, can generate nano- and micro-scale porosity, and allows curing at room temperature, as well as other features and characteristics to the cured preform and ceramic material.

The precursor may be a siloxane backbone additive, such as silanol (hydroxy) terminated vinyl substituted dimethyl siloxane, which formula is shown below.

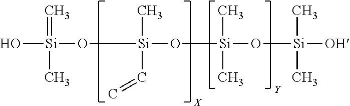

This precursor may have a molecular weight (mw) from about 400 mw to about 10,000 mw, and may preferably have a molecular weight from about 600 mw to 1,000 mw, and may have a viscosity preferably from about 30 cps to about 400 cps. The percentage of methylvinylsiloxane units “X” may be from 1% to 100%. The percentage of the dimethylsiloxane units “Y” may be from 0% to 99%. This precursor may be used, among other things, in a dual-cure system; in this manner the dual-cure can allow the use of multiple cure mechanisms in a single formulation. For example, both condensation type cure and addition type cure can be utilized. This, in turn, provides the ability to have complex cure profiles, which for example may provide for an initial cure via one type of curing and a final cure via a separate type of curing.

The precursor may be a siloxane backbone additive, such as hydrogen (hydride) terminated polydimethyl siloxane, which formula is shown below.

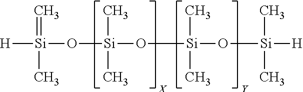

This precursor may have a molecular weight (mw) from about 200 mw to about 10,000 mw, and may preferably have a molecular weight from about 500 mw to 1,500 mw, and may have a viscosity preferably from about 20 cps to about 400 cps. The repeating units are the same. This precursor may be used to provide a polymeric chain extender, as a toughening agent, and it allows lower temperature curing, e.g., room temperature, as well as, other features and characteristics to the cured preform and ceramic material.

The precursor may be a siloxane backbone additive, such as di-phenyl terminated siloxane, which formula is shown below.

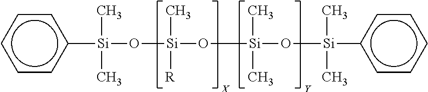

Where here R is a reactive group, such as vinyl, hydroxy, or hydride. This precursor may have a molecular weight (mw) from about 500 mw to about 2,000 mw, and may have a viscosity preferably from about 80 cps to about 300 cps. The percentage of methyl-R-siloxane units “X” may be from 1% to 100%. The percentage of the dimethylsiloxane units “Y” may be from 0% to 99%. This precursor may be used to provide a toughening agent, and to adjust the refractive index of the polymer to match the refractive index of various types of glass, to provide for example transparent fiberglass, as well as, other features and characteristics to the cured preform and ceramic material.

The precursor may be a siloxane backbone additive, such as a mono-phenyl terminated siloxane, which formulas are shown below.

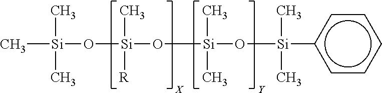

Where R is a reactive group, such as vinyl, hydroxy, or hydride. This precursor may have a molecular weight (mw) from about 500 mw to about 2,000 mw, and may have a viscosity preferably from about 80 cps to about 300 cps. The percentage of methyl-R-siloxane units “X” may be from 1% to 100%. The percentage of the dimethylsiloxane units “Y” may be from 0% to 99%. This precursor may be used to provide a toughening agent and to adjust the refractive index of the polymer to match the refractive index of various types of glass, to provide for example transparent fiberglass, as well as, other features and characteristics to the cured preform and ceramic material.

The precursor may be a siloxane backbone additive, such as diphenyl dimethyl polysiloxane, which formula is shown below.

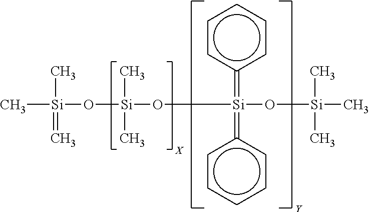

This precursor may have a molecular weight (mw) from about 500 mw to about 20,000 mw, and may have a molecular weight from about 800 to about 4,000, and may have a viscosity preferably from about 100 cps to about 800 cps. The percentage of dimethylsiloxane units “X” may be from 25% to 95%. The percentage of the diphenyl siloxane units “Y” may be from 5% to 75%. This precursor may be used to provide similar characteristics to the mono-phenyl terminated siloxane, as well as, other features and characteristics to the cured preform and ceramic material.

The precursor may be a siloxane backbone additive, such as vinyl terminated diphenyl dimethyl polysiloxane, which formula is shown below.

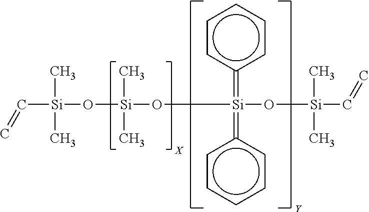

This precursor may have a molecular weight (mw) from about 400 mw to about 20,000 mw, and may have a molecular weight from about 800 to about 2,000, and may have a viscosity preferably from about 80 cps to about 600 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, as well as, other features and characteristics to the cured preform and ceramic material.

The precursor may be a siloxane backbone additive, such as hydroxy terminated diphenyl dimethyl polysiloxane, which formula is shown below.

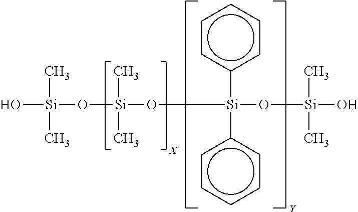

This precursor may have a molecular weight (mw) from about 400 mw to about 20,000 mw, and may have a molecular weight from about 800 to about 2,000, and may have a viscosity preferably from about 80 cps to about 400 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, can generate nano- and micro-scale porosity, as well as other features and characteristics to the cured preform and ceramic material.

A variety of cyclosiloxanes can be used as reactive molecules in the formulation. They can be described by the following nomenclature system or formula: DₓD*_{y}, where “D” represents a dimethyl siloxy unit and “D*” represents a substituted methyl siloxy unit, where the “*” group could be vinyl, allyl, hydride, hydroxy, phenyl, styryl, alkyl, cyclopentadienyl, or other organic group, x is from 0-8, y is >=1, and x+y is from 3-8.

The precursor batch may also contain non-silicon based cross-linking agents, be the reaction product of a non-silicon based cross linking agent and a siloxane backbone additive, and combinations and variation of these. The non-silicon based cross-linking agents are intended to, and provide, the capability to cross-link during curing. For example, non-silicon based cross-linking agents that can be used include: cyclopentadiene (CP), methylcyclopentadiene (MeCP), dicyclopentadiene (“DCPD”), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, Si—OH, or other Si bond in a precursor, can be used as a cross-linking agent. Some organic materials containing oxygen, nitrogen, and sulphur may also function as cross-linking moieties.

The precursor may be a reactive monomer. These would include molecules, such as tetramethyltetravinylcyclotetrasiloxane (“TV”), which formula is shown below.

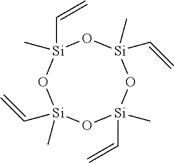 [SMILES: C=C[Si]1(C)O[Si](C)(C=C)O[Si](C)(C=C)O[Si](C)(C=C)O1]

This precursor may be used to provide a branching agent, a three-dimensional cross-linking agent, as well as, other features and characteristics to the cured preform and ceramic material. (It is also noted that in certain formulations, e.g., above 2%, and certain temperatures, e.g., about from about room temperature to about 60° C., this precursor may act as an inhibitor to cross-linking, e.g., in may inhibit the cross-linking of hydride and vinyl groups.)

The precursor may be a reactive monomer, for example, such as trivinyl cyclotetrasiloxane,

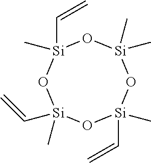 [SMILES: C=C[Si]1(C)O[Si](C)(C)O[Si](C)(C=C)O[Si](C)(C=C)O1]

divinyl cyclotetrasiloxane,

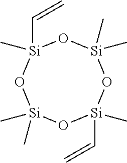

trivinyl monohydride cyclotetrasiloxane,

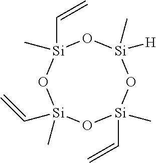 [SMILES: C=C[Si]1(C)O[SiH](C)O[Si](C)(C=C)O[Si](C)(C=C)O1]

divinyl dihydride cyclotetrasiloxane,

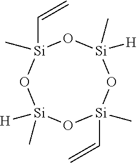 [SMILES: C=C[Si]1(C)O[SiH](C)O[Si](C)(C=C)O[SiH](C)O1]

and a hexamethyl cyclotetrasiloxane, such as,

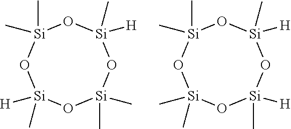

The precursor may be a silane modifier, such as vinyl phenyl methyl silane, diphenyl silane, diphenyl methyl silane, and phenyl methyl silane (some of which may be used as an end capper or end termination group). These silane modifiers can provide chain extenders and branching agents. They also improve toughness, alter refractive index, and improve high temperature cure stability of the cured material, as well as improving the strength of the cured material, among other things. A precursor, such as diphenyl methyl silane, may function as an end capping agent, that may also improve toughness, alter refractive index, and improve high temperature cure stability of the cured material, as well as, improving the strength of the cured material, among other things.

The precursor may be a reaction product of a silane modifier with a vinyl terminated siloxane backbone additive. The precursor may be a reaction product of a silane modifier with a hydroxy terminated siloxane backbone additive. The precursor may be a reaction product of a silane modifier with a hydride terminated siloxane backbone additive. The precursor may be a reaction product of a silane modifier with TV. The precursor may be a reaction product of a silane. The precursor may be a reaction product of a silane modifier with a cyclosiloxane, taking into consideration steric hindrances. The precursor may be a partially hydrolyzed tetraethyl orthosilicate, such as TES 40 or Silbond 40. The precursor may also be a methylsesquisiloxane such as SR-350 available from General Electric Company, Wilton, Conn. The precursor may also be a phenyl methyl siloxane such as 604 from Wacker Chemie AG. The precursor may also be a methylphenylvinylsiloxane, such as H62 C from Wacker Chemie AG.

The precursors may also be selected from the following: SiSiB® HF2020, TRIMETHYLSILYL TERMINATED METHYL HYDROGEN SILICONE FLUID 63148-57-2; SiSiB® HF2050 TRIMETHYLSILYL TERMINATED METHYLHYDROSILOXANE DIMETHYLSILOXANE COPOLYMER 68037-59-2; SiSiB® HF2060 HYDRIDE TERMINATED METHYLHYDROSILOXANE DIMETHYLSILOXANE COPOLYMER 69013-23-6; SiSiB® HF2038 HYDROGEN TERMINATED POLYDIPHENYL SILOXANE; SiSiB® HF2068 HYDRIDE TERMINATED METHYLHYDROSILOXANE DIMETHYLSILOXANE COPOLYMER 115487-49-5; SiSiB® HF2078 HYDRIDE TERMINATED POLY(PHENYLDIMETHYLSILOXY) SILOXANE PHENYL SILSESQUIOXANE, HYDROGEN-TERMINATED 68952-30-7; SiSiB® VF6060 VINYLDIMETHYL TERMINATED VINYLMETHYL DIMETHYL POLYSILOXANE COPOLYMERS 68083-18-1; SiSiB® VF6862 VINYLDIMETHYL TERMINATED DIMETHYL DIPHENYL POLYSILOXANE COPOLYMER 68951-96-2; SiSiB® VF6872 VINYLDIMETHYL TERMINATED DIMETHYL-METHYLVINYL-DIPHENYL POLYSILOXANE COPOLYMER; SiSiB® PC9401 1,1,3,3-TETRAMETHYL-1,3-DIVINYLDISILOXANE 2627-95-4; SiSiB® PF1070 SILANOL TERMINATED POLYDIMETHYLSILOXANE (OF1070) 70131-67-8; SiSiB® OF1070 SILANOL TERMINATED POLYDIMETHYSILOXANE 70131-67-8; OH-ENDCAPPED POLYDIMETHYLSILOXANE HYDROXY TERMINATED OLYDIMETHYLSILOXANE 73138-87-1; SiSiB® VF6030 VINYL TERMINATED POLYDIMETHYL SILOXANE 68083-19-2; and, SiSiB® HF2030 HYDROGEN TERMINATED POLYDIMETHYLSILOXANE FLUID 70900-21-9.

Thus, in additional to the forgoing type of precursors, it is contemplated that a precursor may be a compound of the following general formula.

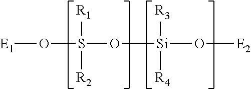

Wherein end cappers E₁ and E₂ are chosen from groups such as trimethyl silicon (—Si(CH₃)₃), dimethyl silicon hydroxy (—Si(CH₃)₂OH), dimethyl silicon hydride (—Si(CH₃)₂H), dimethyl vinyl silicon (—Si(CH₃)₂(CH═CH₂)), (—Si(CH₃)₂(C₆H₅)) and dimethyl alkoxy silicon (—Si(CH₃)₂(OR). The R groups R₁, R₂, R₃, and R₄ may all be different, or one or more may be the same. Thus, for example, R₂ is the same as R₃, R₃ is the same as R₄, R₁ and R₂ are different with R₃ and R₄ being the same, etc. The R groups are chosen from groups such as hydride (—H), methyl (Me)(—C), ethyl (—C—C), vinyl (—C═C), alkyl (—R)(CₙH₂ₙ₊₁), allyl (—C—C═C), aryl (′R), phenyl (Ph)(—C₆H₅), methoxy (—O—C), ethoxy (—O—C—C), siloxy (—O—Si—R₃), alkoxy (—O—R), hydroxy (—O—H), phenylethyl (—C—C—C₆H₅) and methyl, phenyl-ethyl (—C—C(—C)(—C₆H₅).

In general, embodiments of formulations for polysilocarb formulations may for example have from about 0% to 50% MH, about 20% to about 99% MH, about 0% to about 30% siloxane backbone additives, about 1% to about 60% reactive monomers, about 30% to about 100% TV, and, about 0% to about 90% reaction products of a siloxane backbone additives with a silane modifier or an organic modifier reaction products.

In mixing the formulations sufficient time should be used to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should preferably be kept below about 45° C., and preferably about 10° C. (It is noted that these mixing conditions are for the pre-catalyzed formulations.)

The Reaction Type Process

In the reaction type process, in general, a chemical reaction is used to combine one, two or more precursors, typically in the presence of a solvent, to form a precursor formulation that is essentially made up of a single polymer that can then be, catalyzed, cured and pyrolized. This process provides the ability to build custom precursor formulations that when cured can provide plastics having unique and desirable features such as high temperature, flame resistance and retardation, strength and other features. The cured materials can also be pyrolized to form ceramics having unique features. The reaction type process allows for the predetermined balancing of different types of functionality in the end product by selecting functional groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

In general a custom polymer for use as a precursor formulation is made by reacting precursors in a condensation reaction to form the polymer precursor formulation. This precursor formulation is then cured into a preform through a hydrolysis reaction. The condensation reaction forms a polymer of the type shown below.

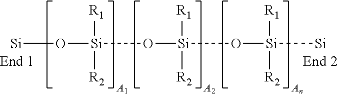

Where R₁ and R₂ in the polymeric units can be a hydride (—H), a methyl (Me)(—C), an ethyl (—C—C), a vinyl (—C═C), an alkyl (—R)(CₙH₂ₙ₊₁), an unsaturated alkyl (—CₙH₂ₙ₋₁), a cyclic alkyl (—CₙN₂ₙ₊₁), an allyl (—C—C═C), a butenyl (—C₄H₇), a pentenyl (—C₅H₉), a cyclopentenyl (—C₅H₇), a methyl cyclopentenyl (—C₅H₆(CH₃)), a norbornenyl (—C_{X}H_{Y}, where X=7-15 and Y=9-18), an aryl (′R), a phenyl (Ph)(—C₆H₅), a cycloheptenyl (—C₇H₁₁), a cyclooctenyl (—C₈H₁₃), an ethoxy (—O—C—C), a siloxy (—O—Si—R₃), a methoxy (—O—C), an alkoxy, (—O—R), a hydroxy, (—O—H), a phenylethyl (—C—C—C₆H₅) a methyl, phenyl-ethyl (—C—C(—C)(—C₆H₅)) and a vinylphenyl-ethyl (—C—C(C₆H₄(—C═C))). R₁ and R₂ may be the same or different. The custom precursor polymers can have several different polymeric units, e.g., A₁, A₂, Aₙ, and may include as many as 10, 20 or more units, or it may contain only a single unit, for example, MHF made by the reaction process may have only a single unit.

Embodiments may include precursors, which include among others, a triethoxy methyl silane, a diethoxy methyl phenyl silane, a diethoxy methyl hydride silane, a diethoxy methyl vinyl silane, a dimethyl ethoxy vinyl silane, a diethoxy dimethyl silane. an ethoxy dimethyl phenyl silane, a diethoxy dihydride silane, a triethoxy phenyl silane, a diethoxy hydride trimethyl siloxane, a diethoxy methyl trimethyl siloxane, a trimethyl ethoxy silane, a diphenyl diethoxy silane, a dimethyl ethoxy hydride siloxane, and combinations and variations of these and other precursors, including other precursors set forth in this specification.

The end units, Si End 1 and Si End 2, can come from the precursors of dimethyl ethoxy vinyl silane, ethoxy dimethyl phenyl silane, and trimethyl ethoxy silane. Additionally, if the polymerization process is properly controlled a hydroxy end cap can be obtained from the precursors used to provide the repeating units of the polymer.

In general, the precursors are added to a vessel with ethanol (or other material to absorb heat, e.g., to provide thermal mass), an excess of water, and hydrochloric acid (or other proton source). This mixture is heated until it reaches its activation energy, after which the reaction typically is exothermic. Generally, in this reaction the water reacts with an ethoxy group of the silicon of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Control factors for determining chain length, among others, are: the monomers chosen (generally, the smaller the monomers the more that can be added before they begin to coil around and bond to themselves); the amount and point in the reaction where end cappers are introduced; and the amount of water and the rate of addition, among others. Thus, the chain lengths can be from about 180 mw (viscosity about 5 cps) to about 65,000 mw (viscosity of about 10,000 cps), greater than about 1000 mw, greater than about 10,000 mw, greater than about 50,000 mw and greater. Further, the polymerized precursor formulation may, and typically does, have polymers of different molecular weights, which can be predetermined to provide formulation, cured, and ceramic product performance features.

Upon completion of the polymerization reaction the material is transferred into a separation apparatus, e.g., a separation funnel, which has an amount of deionized water that, for example, is from about 1.2× to about 1.5× the mass of the material. This mixture is vigorously stirred for about less than 1 minute and preferably from about 5 to 30 seconds. Once stirred the material is allowed to settle and separate, which may take from about 1 to 2 hours. The polymer is the higher density material and is removed from the vessel. This removed polymer is then dried by either warming in a shallow tray at 90° C. for about two hours; or, preferably, is passed through a wiped film distillation apparatus, to remove any residual water and ethanol. Alternatively, sodium bicarbonate sufficient to buffer the aqueous layer to a pH of about 4 to about 7 is added. It is further understood that other, and commercial, manners of mixing, reacting and separating the polymer from the material may be employed.

Preferably a catalyst is used in the curing process of the polymer precursor formulations from the reaction type process. The same polymers, as used for curing the precursor formulations from the mixing type process can be used. It is noted that, generally unlike the mixing type formulations, a catalyst is not necessarily required to cure a reaction type polymer. Inhibitors may also be used. However, if a catalyst is not used, reaction time and rates will be slower. The curing and the pyrolysis of the cured material from the reaction process is essentially the same as the curing and pyrolysis of the cured material from the mixing process and the reaction blending process.

The reaction type process can be conducted under numerous types of atmospheres and conditions, e.g., air, inert, N₂, Argon, flowing gas, static gas, reduced pressure, ambient pressure, elevated pressure, and combinations and variations of these.

The Reaction Blending Type Process

In the reaction blending type process precursor are reacted to from a precursor formulation, in the absence of a solvent.

For example, an embodiment of a reaction blending type process has a precursor formulation that is prepared from MHF and Dicyclopentadiene (“DCPD”). Using the reactive blending process a MHF/DCPD polymer is created and this polymer is used as a precursor formulation. (It can be used alone to form a cured or pyrolized product, or as a precursor in the mixing or reaction processes.) MHF of known molecular weight and hydride equivalent mass; “P01” (P01 is a 2% Pt(0) tetravinylcyclotetrasiloxane complex (e.g., tetramethyltetravinylcyclotetrasiloxane) in tetravinylcyclotetrasiloxane, diluted 20× with tetravinylcyclotetrasiloxane to 0.1% of Pt(0) complex. In this manner 10 ppm Pt is provided for every 1% loading of bulk cat.) catalyst 0.20 wt % of MHF starting material (with known active equivalent weight), from 40 to 90%; and Dicyclopentadiene with 83% purity, from 10 to 60% are utilized. In an embodiment of the process, a sealable reaction vessel, with a mixer, can be used for the reaction. The reaction is conducted in the sealed vessel, in air; although other types of atmosphere can be utilized. Preferably, the reaction is conducted at atmospheric pressure, but higher and lower pressures can be utilized. Additionally, the reaction blending type process can be conducted under numerous types of atmospheres and conditions, e.g., air, inert, N₂, Argon, flowing gas, static gas, reduced pressure, ambient pressure, elevated pressure, and combinations and variations of these.

In an embodiment, 850 grams of MHF (85% of total polymer mixture) is added to reaction vessel and heated to about 50° C. Once this temperature is reached the heater is turned off, and 0.20% by weight P01 Platinum catalyst is added to the MHF in the reaction vessel. Typically, upon addition of the catalyst bubbles will form and temp will initially rise approximately 2-20° C.

When the temperature begins to fall, about 150 g of DCPD (15 wt % of total polymer mixture) is added to the reaction vessel. The temperature may drop an additional amount, e.g., around 5-7° C.

At this point in the reaction process the temperature of the reaction vessel is controlled to, maintain a predetermined temperature profile over time, and to manage the temperature increase that may be accompanied by an exotherm. Preferably, the temperature of the reaction vessel is regulated, monitored and controlled throughout the process.

In an embodiment of the MHF/DCPD embodiment of the reaction process, the temperature profile can be as follows: let temperature reach about 80° C. (may take ˜15-40 min, depending upon the amount of materials present); temperature will then increase and peak at ˜104° C., as soon as temperature begins to drop, the heater set temperature is increased to 100° C. and the temperature of the reaction mixture is monitored to ensure the polymer temp stays above 80° C. for a minimum total of about 2 hours and a maximum total of about 4 hours. After 2-4 hours above 80° C., the heater is turned off, and the polymer is cooled to ambient. It being understood that in larger and smaller batches, continuous, semi-continuous, and other type processes the temperature and time profile may be different.

In larger scale, and commercial operations, batch, continuous, and combinations of these, may be used. Industrial factory automation and control systems can be utilized to control the reaction, temperature profiles and other processes during the reaction.

Table C sets forth various embodiments of reaction blending processes.

TABLE C

| | | | | | | | | | grams/mole |
|---|---|---|---|---|---|---|---|---|---|
| | degree of | Equivalents | Equivalents | Equivalents | Equivalents | Equivalents | Equivalents | | of |
| Material Name | polymerization | Si/mole | O/mole | H/mol | Vi/mol | methyl/mole | C/mole | MW | vinyl |
| tetramethyl- | 4 | 4 | 4 | 4 | 0 | 4 | 4 | 240.51 | |
| cyclotetrasiloxane | | | | | | | | | |
| (D₄) | | | | | | | | | |
| MHF | 33 | 35 | 34 | 33 | 0 | 39 | 39 | 2145.345 | |
| VMF | 5 | 7 | 6 | 0 | 5 | 11 | 21 | 592.959 | 118.59 |
| TV | 4 | 4 | 4 | 0 | 4 | 4 | 12 | 344.52 | 86.13 |
| VT 0200 | 125 | 127 | 126 | 0 | 2 | 254 | 258 | 9451.206 | 4725.60 |
| VT 0020 | 24 | 26 | 25 | 0 | 2 | 52 | 56 | 1965.187 | 982.59 |
| VT 0080 | 79 | 81 | 80 | 0 | 2 | 162 | 166 | 6041.732 | 3020.87 |
| Styrene | | | | | 2 | | | 104.15 | 52.08 |
| Dicyclopentadiene | | | | | 2 | | | 132.2 | 66.10 |
| 1,4-divinylbenzene | | | | | 2 | | | 130.19 | 65.10 |
| isoprene | | | | | 2 | | | 62.12 | 31.06 |
| 1,3 Butadiene | | | | | 2 | | | 54.09 | 27.05 |
| Catalyst 10 ppm Pt | | | | | | | | | |
| Catalyst LP 231 | | | | | | | | | |

In the above table, the “degree of polymerization” is the number of monomer units, or repeat units, that are attached together to form the polymer. “Equivalents _/mol” refers to the molar equivalents. “Grams/mole of vinyl” refers to the amount of a given polymer needed to provide 1 molar equivalent of vinyl functionality. “VMH” refers to methyl vinyl fluid, a linear vinyl material from the ethoxy process, which can be a substitute for TV. The numbers “0200” etc. for VT are the viscosity in centipoise for that particular VT.

Curing and Pyrolysis

Precursor formulations, including the polysilocarb precursor formulations from the above types of processes, as well as others, can be cured to form a solid, semi-sold, or plastic like material. Typically, the precursor formulations are spread, shaped, or otherwise formed into a preform, which would include any volumetric structure, or shape, including thin and thick films. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon its intended use and purpose. For example, in some situations the end cure and the hard cure may be the same. Curing conditions such as atmosphere and temperature may affect the composition of the cured material.

In making the precursor formulation into a structure, or preform, the precursor formulation, e.g., polysilocarb formulation, can be, for example, formed using the following techniques: spraying, spray drying, atomization, nebulization, phase change separation, flowing, thermal spraying, drawing, dripping, forming droplets in liquid and liquid-surfactant systems, painting, molding, forming, extruding, spinning, ultrasound, vibrating, solution polymerization, emulsion polymerization, micro-emulsion polymerization, injecting, injection molding, or otherwise manipulated into essentially any volumetric shape. These volumetric shapes may include for example, the following: spheres, pellets, rings, lenses, disks, panels, cones, frustoconical shapes, squares, rectangles, trusses, angles, channels, hollow sealed chambers, hollow spheres, blocks, sheets, coatings, films, skins, particulates, beams, rods, angles, slabs, columns, fibers, staple fibers, tubes, cups, pipes, and combinations and various of these and other more complex shapes, both engineering and architectural.

The forming step, the curing steps, and the pyrolysis steps may be conducted in batch processes, serially, continuously, with time delays (e.g., material is stored or held between steps), and combinations and variations of these and other types of processing sequences. Further, the precursors can be partially cured, or the cure process can be initiated and on going, prior to the precursor being formed into a volumetric shape. These steps, and their various combinations may be, and in some embodiments preferably are, conducted under controlled and predetermined conditions (e.g., the material is exposed to a predetermined atmosphere, and temperature profile during the entirely of its processing, e.g., reduced oxygen, temperature of cured preform held at about 140° C. prior to pyrolysis). It should be further understood that the system, equipment, or processing steps, for forming, curing and pyrolizing may be the same equipment, continuous equipment, batch and linked equipment, and combinations and variations of these and other types of industrial processes. Thus, for example, a spray drying technique could form cured particles that are feed directly into a fluidized bed reactor for pyrolysis.

The polysilocarb precursor formulations can be made into neat, non-reinforced, non-filled, composite, reinforced, and filled structures, intermediates, end products, and combinations and variations of these and other compositional types of materials. Further, these structures, intermediates and end products can be cured (e.g., green cured, end cured, or hard cured), uncured, pyrolized to a ceramic, and combinations and variations of these (e.g., a cured material may be filled with pyrolized material derived from the same polysilocarb as the cured material).

The precursor formulations may be used to form a “neat” material, (by “neat” material it is meant that all, and essentially all of the structure is made from the precursor material or unfilled formulation; and thus, there are no fillers or reinforcements).

The polysilocarb precursor formulations may be used to coat or impregnate a woven or non-woven fabric, made from for example carbon fiber, glass fibers or fibers made from a polysilocarb precursor formulation (the same or different formulation), to from a prepreg material. Thus, the polysilocarb precursor formulations may be used to form composite materials, e.g., reinforced products. For example, the formulation may be flowed into, impregnated into, absorbed by or otherwise combined with a reinforcing material, such as carbon fibers, glass fiber, woven fabric, grapheme, carbon nanotubes, thin films, precipitates, sand, non-woven fabric, copped fibers, fibers, rope, braided structures, ceramic powders, glass powders, carbon powders, graphite powders, ceramic fibers, metal powders, carbide pellets or components, staple fibers, tow, nanostructures of the above, polymer derived ceramics, any other material that meets the temperature requirements of the process and end product, and combinations and variations of these. The reinforcing material may also be made from, or derived from the same material as the formulation that has been formed into a fiber and pyrolized into a ceramic, or it may be made from a different precursor formulation material, which has been formed into a fiber and pyrolized into a ceramic.

The polysilocarb precursor formulation may be used to form a filled material. A filled material would be any material having other solid, or semi-solid, materials added to the polysilocarb precursor formulation. The filler material may be selected to provide certain features to the cured product, the ceramic product and both. These features may relate to, or be, for example, aesthetic, tactile, thermal, density, radiation, chemical, cost, magnetic, electric, and combinations and variations of these and other features. These features may be in addition to strength. Thus, the filler material may not affect the strength of the cured or ceramic material, it may add strength, or could even reduce strength in some situations. The filler material could impart color, magnetic capabilities, fire resistances, flame retardance, heat resistance, electrical conductivity, anti-static, optical properties (e.g., reflectivity, refractivity and iridescence), aesthetic properties (such as stone like appearance in building products), chemical resistivity, corrosion resistance, wear resistance, reduced cost, abrasions resistance, thermal insulation, UV stability, UV protective, and other features that may be desirable, necessary, and both, in the end product or material. Thus, filler materials could include carbon black, copper lead wires, thermal conductive fillers, electrically conductive fillers, lead, optical fibers, ceramic colorants, pigments, oxides, sand, dyes, powders, ceramic fines, polymer derived ceramic particles, pore-formers, carbosilanes, silanes, silazanes, silicon carbide, carbosilazanes, siloxane, powders, ceramic powders, metals, metal complexes, carbon, tow, fibers, staple fibers, boron containing materials, milled fibers, glass, glass fiber, fiber glass, and nanostructures (including nanostructures of the forgoing) to name a few.

The polysilocarb formulation and products derived or made from that formulation may have metals and metal complexes. Filled materials would include reinforced materials. In many cases, cured, as well as pyrolized polysilocarb filled materials can be viewed as composite materials. Generally, under this view, the polysilocarb would constitute the bulk or matrix phase, (e.g., a continuous, or substantially continuous phase), and the filler would constitute the dispersed (e.g., non-continuous), phase. Depending upon the particular application, product or end use, the filler can be evenly distributed in the precursor formulation, unevenly distributed, distributed over a predetermined and controlled distribution gradient (such as from a predetermined rate of settling), and can have different amounts in different formulations, which can then be formed into a product having a predetermined amounts of filler in predetermined areas (e.g., striated layers having different filler concentration). It should be noted, however, that by referring to a material as “filled” or “reinforced” it does not imply that the majority (either by weight, volume, or both) of that material is the polysilcocarb. Thus, generally, the ratio (either weight or volume) of polysilocarb to filler material could be from about 0.1:99.9 to 99.9:0.1.

The polysilocarb precursor formulations may be used to form non-reinforced materials, which are materials that are made of primarily, essentially, and preferably only from the precursor materials; but may also include formulations having fillers or additives that do not impart strength.

The curing may be done at standard ambient temperature and pressure (“SATP”, 1 atmosphere, 25° C.), at temperatures above or below that temperature, at pressures above or below that pressure, and over varying time periods. The curing can be conducted over various heatings, rate of heating, and temperature profiles (e.g., hold times and temperatures, continuous temperature change, cycled temperature change, e.g., heating followed by maintaining, cooling, reheating, etc.). The time for the curing can be from a few seconds (e.g., less than about 1 second, less than 5 seconds), to less than a minute, to minutes, to hours, to days (or potentially longer). The curing may also be conducted in any type of surrounding environment, including for example, gas, liquid, air, water, surfactant containing liquid, inert atmospheres, N₂, Argon, flowing gas (e.g., sweep gas), static gas, reduced O₂, reduced pressure, elevated pressure, ambient pressure, controlled partial pressure and combinations and variations of these and other processing conditions. For high purity materials, the furnace, containers, handling equipment, atmosphere, and other components of the curing apparatus and process are clean, essentially free from, and do not contribute any elements or materials, that would be considered impurities or contaminants, to the cured material. In an embodiment, the curing environment, e.g., the furnace, the atmosphere, the container and combinations and variations of these can have materials that contribute to or effect, for example, the composition, catalysis, stoichiometry, features, performance and combinations and variations of these in the preform, the ceramic and the final applications or products.

Preferably, in embodiments of the curing process, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., A degrees/time), hold times, and temperatures) can be utilized.

The cure conditions, e.g., temperature, time, ramp rate, may be dependent upon, and in some embodiments can be predetermined, in whole or in part, by the formulation to match, for example the size of the preform, the shape of the preform, or the mold holding the preform to prevent stress cracking, off gassing, or other phenomena associated with the curing process. Further, the curing conditions may be such as to take advantage of, preferably in a controlled manner, what may have previously been perceived as problems associated with the curing process. Thus, for example, off gassing may be used to create a foam material having either open or closed structure. Similarly, curing conditions can be used to create or control the microstructure and the nanostructure of the material. In general, the curing conditions can be used to affect, control or modify the kinetics and thermodynamics of the process, which can affect morphology, performance, features and functions, among other things.

Upon curing the polysilocarb precursor formulation a cross linking reaction takes place that provides in some embodiments a cross-linked structure having, among other things, an —R₁—Si—C—C—Si—O—Si—C—C—Si—R₂— where R₁ and R₂ vary depending upon, and are based upon, the precursors used in the formulation. In an embodiment of the cured materials they may have a cross-linked structure having 3-coordinated silicon centers to another silicon atom, being separated by fewer than 5 atoms between silicons.

During the curing process some formulations may exhibit an exotherm, i.e., a self heating reaction, that can produce a small amount of heat to assist or drive the curing reaction, or that may produce a large amount of heat that may need to be managed and removed in order to avoid problems, such as stress fractures. During the cure off gassing typically occurs and results in a loss of material, which loss is defined generally by the amount of material remaining, e.g., cure yield. Embodiments of the formulations, cure conditions, and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material typically shrinks, this shrinkage may be, depending upon the formulation, cure conditions, and the nature of the preform shape, and whether the preform is reinforced, filled, neat or unreinforced, from about 20%, less than 20%, less than about 15%, less than about 5%, less than about 1%, less than about 0.5%, less than about 0.25% and smaller.

Curing of the preform may be accomplished by any type of heating apparatus, or mechanisms, techniques, or morphologies that has the requisite level of temperature and environmental control, for example, heated water baths, electric furnaces, microwaves, gas furnaces, furnaces, forced heated air, towers, spray drying, falling film reactors, fluidized bed reactors, lasers, indirect heating elements, direct heating, infrared heating, UV irradiation, RF furnace, in-situ during emulsification via high shear mixing, in-situ during emulsification via ultrasonication.

The cured preforms, either unreinforced, neat, filled or reinforced, may be used as a stand alone product, an end product, a final product, or a preliminary product for which later machining or processing may be performed on. The preforms may also be subject to pyrolysis, which converts the preform material into a ceramic.

In pyrolizing the preform, or cured structure, or cured material, it is heated to about 600° C. to about 2,300° C.; from about 650° C. to about 1,200° C., from about 800° C. to about 1300° C., from about 900° C. to about 1200° C. and from about 950° C. to 1150° C. At these temperatures typically all organic structures are either removed or combined with the inorganic constituents to form a ceramic. Typically at temperatures in the about 650° C. to 1,200° C. range the resulting material is an amorphous glassy ceramic. When heated above about 1,200° C. the material typically may from nano crystalline structures, or micro crystalline structures, such as SiC, Si3N₄, SiCN, β SiC, and above 1,900° C. an α SiC structure may form, and at and above 2,200° C. α SiC is typically formed. The pyrolized, e.g., ceramic materials can be single crystal, polycrystalline, amorphous, and combinations, variations and subgroups of these and other types of morphologies.

The pyrolysis may be conducted under many different heating and environmental conditions, which preferably include thermo control, kinetic control and combinations and variations of these, among other things. For example, the pyrolysis may have various heating ramp rates, heating cycles and environmental conditions. In some embodiments, the temperature may be raised, and held a predetermined temperature, to assist with known transitions (e.g., gassing, volatilization, molecular rearrangements, etc.) and then elevated to the next hold temperature corresponding to the next known transition. The pyrolysis may take place in reducing atmospheres, oxidative atmospheres, low O₂, gas rich (e.g., within or directly adjacent to a flame), inert, N₂, Argon, air, reduced pressure, ambient pressure, elevated pressure, flowing gas (e.g., sweep gas, having a flow rate for example of from about from about 15.0 GHSV to about 0.1 GHSV, from about 6.3 GHSV to about 3.1 GHSV, and at about 3.9 GHSV), static gas, and combinations and variations of these.

The pyrolysis is conducted over a time period that preferably results in the complete pyrolysis of the preform. For high purity materials, the furnace, containers, handling equipment, and other components of the pyrolysis apparatus are clean, essentially free from, free from and do not contribute any elements or materials, that would be considered impurities or contaminants, to the pyrolized material. A constant flow rate of “sweeping” gas can help purge the furnace during volatile generation. In an embodiment, the pyrolysis environment, e.g., the furnace, the atmosphere, the container and combinations and variations of these, can have materials that contribute to or effect, for example, the composition, stoichiometry, features, performance and combinations and variations of these in the ceramic and the final applications or products.

During pyrolysis material may be lost through off gassing. The amount of material remaining at the end of a pyrolysis step, or cycle, is referred to as char yield (or pyrolysis yield). The formulations and polysilocarb precursor formulations of embodiments of the present formulations can have char yields for SiOC formation of at least about 60%, about 70%, about 80%, and at least about 90%, at least about 91% and greater. In fact, with air pyrolysis the materials may have char yields well above 91%, which can approach 100%. In order to avoid the degradation of the material in an air pyrolysis (noting that typically pyrolysis is conducted in inert atmospheres, reduced oxygen atmosphere, essentially inert atmosphere, minimal oxygen atmospheres, and combinations and variations of these) specifically tailored formulations can be used. For example, formulations high in phenyl content (at least about 11%, and preferably at least about 20% by weight phenyls), formulations high in allyl content (at least about 15% to about 60%) can be used for air pyrolysis to mitigate the degradation of the material.

The initial or first pyrolysis step for SiOC formation, in some embodiments and for some uses, generally yields a structure that is not very dense, and for example, may not reached the density required for its intended use. However, in some examples, such as the use of lightweight spheres, proppants, pigments, and others, the first pyrolysis may be, and is typically sufficient. Thus, generally a reinfiltration process may be performed on the pyrolized material, to add in additional polysilocarb precursor formulation material, to fill in, or fill, the voids and spaces in the structure. This reinfiltrated material may then be cured and repyrolized. (In some embodiments, the reinfiltrated materials is cured, but not pyrolized.) This process of pyrolization, reinfiltration may be repeated, through one, two, three, and up to 10 or more times to obtain the desired density of the final product.

In some embodiments, upon pyrolization, graphenic, graphitic, amorphous carbon structures and combinations and variations of these are present in the Si—O—C ceramic. A distribution of silicon species, consisting of SiOxCy structures, which result in SiO4, SiO3C, SiO2C2, SiOC3, and SiC4 are formed in varying ratios, arising from the precursor choice and their processing history. Carbon is generally bound between neighboring carbons and/or to a Silicon atom. In general, in the ceramic state, carbon is largely not coordinated to an oxygen atom, thus oxygen is largely coordinated to silicon

The pyrolysis may be conducted in any heating apparatus that maintains the request temperature and environmental controls. Thus, for example pyrolysis may be done with gas fired furnaces, electric furnaces, direct heating, indirect heating, fluidized beds, kilns, tunnel kilns, box kilns, shuttle kilns, coking type apparatus, lasers, microwaves, and combinations and variations of these and other heating apparatus and systems that can obtain the request temperatures for pyrolysis.

Custom and predetermined control of when chemical reactions, arrangements and rearrangements, occur in the various stages of the process from raw material to final end product can provide for reduced costs, increased process control, increased reliability, increased efficiency, enhanced product features, increased purity, and combinations and variation of these and other benefits. The sequencing of when these transformations take place can be based upon the processing or making of precursors, and the processing or making of precursor formulations; and may also be based upon cure and pyrolysis conditions. Further, the custom and predetermined selection of these steps, formulations and conditions, can provide enhanced product and processing features through the various transformations, e.g., chemical reactions; molecular arrangements and rearrangements; and microstructure arrangements and rearrangements.

At various points during the manufacturing process, the polymer derived ceramic structures, e.g., polysilocarb structures, intermediates and end products, and combinations and variations of these, may be machined, milled, molded, shaped, drilled, etched, or otherwise mechanically processed and shaped.

Starting materials, precursor formulations, polysilocarb precursor formulations, as well as, methods of formulating, making, forming, curing and pyrolizing, precursor materials to form polymer derived materials, structures and ceramics, are set forth in Published US Patent Applications, Publication Nos. 2014/0343220, 2014/0274658, and 2014/0326453, and U.S. Patent Applications, Ser. Nos. 61/946,598, 62/055,397 and 62/106,094, the entire disclosures of each of which are incorporated herein by reference.

In preferred embodiments of the polysilocarb derived ceramics the amounts of Si, O, C for the total amount of ceramic are set forth in the Table 1.

TABLE 1

| | Si | | O | | C | |
|---|---|---|---|---|---|---|
| | Lo | Hi | Lo | Hi | Lo | Hi |
| Wt % | 35.00% | 50.00% | 10.00% | 35.00% | 5.00% | 30.00% |
| Mole | 1.000 | 1.429 | 0.502 | 1.755 | 0.334 | 2.004 |
| Ratio | | | | | | |
| Mole | 15.358% | 63.095% | 8.821% | 56.819% | 6.339% | 57.170% |
| % | | | | | | |

In general, embodiments of the pyrolized polysilocarb ceramics can have about 30% to about 60% Si, can have about 5% to about 40% 0, and can have about 3% to about 35% carbon. Greater and lesser amounts are also contemplated.

The type of carbon present in preferred embodiments of the polysilocarb derived ceramics can be free carbon, (e.g., turbostratic, amorphous, graphenic, graphitic forms of carbon) and Carbon that is bound to Silicon. Embodiments having preferred amounts of free carbon and Silicon-bound-Carbon (Si—C) are set forth in Table 2.

TABLE 2

| Embodiment | % Free Carbon | % Si—C type |
|---|---|---|
| 1 | 64.86 | 35.14 |
| 2 | 63.16 | 36.85 |
| 3 | 67.02 | 32.98 |
| 4 | 58.59 | 41.41 |
| 5 | 65.70 | 31.66 |
| 6 | 62.72 | 30.82 |
| 7 | 61.68 | 34.44 |
| 8 | 69.25 | 27.26 |
| 9 | 60.00 | 27.54 |

Generally, embodiments of polysilocarb derived ceramics can have from about 20% free carbon to about 80% free carbon, and from about 20% Si—C bonded carbon to about 80% Si—C bonded carbon. Greater and lesser amounts are also contemplated.

Typically, embodiments of the pyrolized polysilocarb ceramics can have other elements present, such as Nitrogen and Hydrogen. Embodiments can have the amounts of these other materials as set out in Table 3. (Note that these are typical for embodiments of net materials. If fillers, additives, or other materials are combined with or into the precursor formulation; then such materials can generally be present to a greater or lesser extent in the pyrolized ceramic material)

TABLE 3

| | H | | N | |
|---|---|---|---|---|
| | Lo | Hi | Lo | Hi |
| Wt % | 0.00% | 2.20% | 0% | 2% |
| Mole Ratio | 0.000 | 1.751 | 0 | 0.1 |
| Mole % | 0.000% | 48.827% | 0% | 3% |

Embodiment of articles used for, or in association with, the exploration and recovery of natural resources (e.g., hydrocarbons and geothermal), and the configuration and components of these articles, such as, equipment, structural components, derricks, rigs, pipes, tanks, tubulars, pumps, injectors, well completion components and structures, risers, ESP (electronic submersible pump), subsea trees, subsea completion and production equipment and lines, down hole tools, bits, down hole equipment, and other types of equipment, structures and devices are, made from polysilocarb materials, have surfaces made from polysilocarb materials and combinations and variations of these, and other materials. Depending upon the performance requirements, e.g., load, stress, strain, impact, environmental, etc., for these articles, they can be hard cured polysilocarb materials, pyrolized polysilocarb materials, pyrolized materials that are reinfiltrated to a very high density, filled and unfilled polysilocarb materials, ready to press sintered SiC (which is derived from polysilocarb materials as disclosed and taught in U.S. Patent Application Ser. No. 62/055,397, 62/055,461 and 62/112,025, the entire disclosures of each of which are incorporated herein by reference) and combinations, variations, and composites of these and other materials, e.g., metal, steel, aluminum, metal matrix complexes, plastic, carbon fiber, and wood, among others materials.

### EXAMPLES

The following examples are provided to illustrate various embodiments of processes, precursors, polysilocarb formulations, prepregs, cured preforms, and ceramics of the present inventions. These examples are for illustrative purposes, and should not be viewed as, and do not otherwise limit the scope of the present inventions. The percentages used in the examples, unless specified otherwise, are weight percents of the total formulation, preform or structure.

### Example 1

A polysilocarb formulation using the mixing type method is formulated. The formulation is made by mixing together at room temperature 70% of the MHF precursor and a molecular weight of about 800 and 30% of the allyl terminated precursor having a molecular weight of about 500 in a vessel and placing in storage for later use. The polysilocarb formulation has good shelf life and room temperature and the precursors have not, and do not react with each other. The polysilocarb formulation has a viscosity of about 12 cps.

### Example 2

A polysilocarb formulation using the mixing type method is formulated. The formulation is made by mixing together at room temperature 60% of the MHF precursor and a molecular weight of about 800 and 40% of the vinyl terminated precursor having a molecular weight of about 9,400 in a vessel and placing in storage for later use. The polysilocarb formulation has good shelf life and room temperature and the precursors have not, and do not react with each other. The polysilocarb formulation has a viscosity of about 200 cps.

### Example 3

A polysilocarb formulation using the mixing type method is formulated. The formulation is made by mixing together 50% of the MH precursor having a molecular weight of about 800 and 50% of the vinyl terminated precursor having a molecular weight of about 800 in a vessel and placing in storage for later use. The polysilocarb formulation has good shelf life and room temperature and the precursors have not, and do not react with each other. The polysilocarb formulation has a viscosity of about 55 cps.

### Example 4

A polysilocarb formulation using the mixing type method is formulated. The formulation is made by mixing together 40% of the MH precursor having a molecular weight of about 1,000 and 60% of the vinyl terminated precursor having a molecular weight of about 500 in a vessel and placing in storage for later use. The polysilocarb formulation has good shelf life and room temperature and the precursors have not, and do not react with each other. The polysilocarb formulation has a viscosity of about 25 cps.

### Example 5

A polysilocarb formulation using the mixing type method is formulated. The formulation is made by mixing together 30% of the MHF precursor having a molecular weight of about 800 and 70% of the vinyl terminated precursor having a molecular weight of about 500 in a vessel and placing in storage for later use. The polysilocarb formulation has good shelf life and room temperature and the precursors have not, and do not react with each other. The polysilocarb formulation has a viscosity of about 10 cps.

### Example 6

The polysilocarb formulation of Example 1 has 40% of an about 80 micron to about 325 mesh SiC filler added to the formulation to make a filled polysilocarb formulation, which can be kept for later use.

### Example 7

The polysilocarb formulation of Example 2 has 30% of an about 80 micron to about 325 mesh SiC filler added to the formulation to make a filled polysilocarb formulation, which can be kept for later use.

### Example 8

A polysilocarb formulation using the mixing type method is formulated. The formulation is made by mixing together 10% of the MHF precursor having a molecular weight of about 800 and 73% of the styrene (phenylethyl) precursor (having 10% X) and a molecular weight of about 1,000, and 16% of the TV precursor, and 1% of the OH terminated precursor, having a molecular weight of about 1,000 in a vessel and placing in storage for later use. The polysilocarb formulation has good shelf life and room temperature and the precursors have not, and do not react with each other. The polysilocarb formulation has a viscosity of about 72 cps.

### Example 9

A polysilocarb formulation using the mixing type method is formulated. The formulation is made by mixing together 0-90% of the MH precursor having a molecular weight of about 800, and 0-90% of the styrene precursor (having 10% X) and a molecular weight of about 1000, and 0-30% of the TV precursor, and 0-30% of the vinyl terminated precursor having a molecular weight of about 9400 and 0-20% of the OH terminated precursor, having a molecular weight of about 800 in a vessel and placing in storage for later use. The polysilocarb formulation has good shelf life and room temperature and the precursors have not, and do not react with each other. The polysilocarb formulation has a viscosity of about 100 cps.

### Example 10

A polysilocarb formulation using the mixing type method is formulated. The formulation is made by mixing together 70% of the MHF precursor and 30% of the vinyl terminated precursor having a molecular weight of about 500 and about 42% of a submicron and a 325 mesh silica in a vessel and placing in storage for later use. The polysilocarb formulation has good shelf life and room temperature and the precursors have not, and do not react with each other. The polysilocarb formulation has a viscosity of about 300 cps.

### Example 11

A polysilocarb formulation using the mixing type method is formulated. The formulation is made by mixing together 20-80% of the MH precursor having a molecular weight of about 800, and 0-10% of the TV precursor, and 5-80% of the vinyl terminated precursor having a molecular weight of about and about 500 of submicron, 325 mesh, and 8 micron SiC in a vessel and placing in storage for later use. The polysilocarb formulation has good shelf life and room temperature and the precursors have not, and do not react with each other. The polysilocarb formulation has a viscosity of about 300 cps.

### Example 12

A precursor formulation of having 75% MHF, 15% TV, and 10% VT is formed using the mixing type process and stored.

### Example 13a

1% catalyst (10 ppm platinum and 0.5% LUPEROX 231 peroxide) is added to the precursor formulation of Example 12. The catalyzed precursor is then impregnated into a reinforcing material and cured to form a composite.

### Example 13b

The cured material of Example 12a is pyrolized to form a polysilocarb derived ceramic composite material.

### Example 13c

1% catalyst (10 ppm platinum and 0.5% LUPEROX 231 peroxide) is added to the precursor formulation of Example 12, impregnated into a reinforcing material and cured into a composite material.

### Example 13d

1% catalyst (10 ppm platinum and 0.5% LUPEROX 231 peroxide) is added to the formulation of Example 12, and the polysilocarb formulation is formed into a prepreg having carbon fiber reinforcement. The prepreg curing is done in Argon and at 200° C. for 2 hours. The hard cured preform are pyrolized at 1000° C. under vacuum for 5 hours.

### Example 14

A polysilocarb precursor formulation having 70% MHF, 20% TV, and 10% VT is formed using the mixing type process and placed in a container.

### Example 15

1% catalyst (10 ppm platinum and 0.5% LUPEROX 231 peroxide) is added to the precursor formulation of Example 14. The catalyzed precursor is then impregnated into a reinforcing material and cured to form a composite.

### Example 16a

The cured material of Example 15 is pyrolized to form a polysilocarb derived ceramic composite material.

### Example 16b

1% catalyst (10 ppm platinum and 0.5% LUPEROX 231 peroxide) is added to the formulation of Example 14, and the polysilocarb formulation is formed into a prepreg having carbon fiber reinforcement. The prepreg curing is done in Argon and at 200° C. for 2 hours. The hard cured preform are pyrolized at 1000° C. under vacuum for 5 hours.

### Example 17

The pyrolized preform of Example 16b, is infused with a polysiloxane precursor formulation and pyrolized.

### Example 18

The pyrolized preform of Example 17, is re-infused with a polysiloxane precursor formulation and pyrolized.

### Example 19

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Methyltriethoxysilane (FIG. | 120.00 | 19.5% | 178.30 | 0.67 | 47.43% | 0.67 | 2.02 |
| 37) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 70.00 | 11.4% | 148.28 | 0.47 | 33.27% | 0.47 | 0.94 |
| (FIG. 42) | | | | | | | |
| Methyldiethoxysilane (FIG. | 20.00 | 3.3% | 134.25 | 0.15 | 10.50% | 0.15 | 0.30 |
| 39) | | | | | | | |
| Vinylmethyldiethoxysilane | 20.00 | 3.3% | 160.29 | 0.12 | 8.79% | 0.12 | 0.25 |
| (FIG. 40) | | | | | | | |
| Trimethyethoxysilane (FIG. | 0.00 | 0.0% | 118.25 | — | 0.00% | — | — |
| 48) | | | | | | | |
| Hexane in hydrolyzer | 0.00 | 0.0% | 86.18 | — | | | |
| Acetone in hydrolyzer | 320.00 | 52.0% | 58.08 | 5.51 | | | |
| Ethanol in hydrolyzer | 0.00 | 0.0% | 46.07 | — | | | |
| Water in hydrolyzer | 64.00 | 10.4% | 18.00 | 3.56 | | | |
| HCl | 0.36 | 0.1% | 36.00 | 0.01 | | | |
| Sodium bicarbonate | 0.84 | 0.1% | 84.00 | 0.01 | | | |

### Example 20

Using the reaction type process a precursor formulation was made using the following formulation. The temperature of the reaction was maintained at 72° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 234.00 | 32.0% | 240.37 | 0.97 | 54.34% | 0.97 | 2.92 |
| 45) | | | | | | | |
| Phenylmethyldiethoxysilane | 90.00 | 12.3% | 210.35 | 0.43 | 23.88% | 0.43 | 0.86 |
| (FIG. 38) | | | | | | | |
| Dimethyldiethoxysilane (FIG. | 0.00 | 0.0% | 148.28 | — | 0.00% | — | — |
| 42) | | | | | | | |
| Methyldiethoxysilane (FIG. | 28.50 | 3.9% | 134.25 | 0.21 | 11.85% | 0.21 | 0.42 |
| 39) | | | | | | | |
| Vinylmethyldiethoxysilane | 28.50 | 3.9% | 160.29 | 0.18 | 9.93% | 0.18 | 0.36 |
| (FIG. 40) | | | | | | | |
| Trimethyethoxysilane (FIG. | 0.00 | 0.0% | 118.25 | — | 0.00% | — | — |
| 48) | | | | | | | |
| Acetone in hydrolyzer | 0.00 | 0.0% | 58.08 | — | | | |
| Ethanol in hydrolyzer | 265.00 | 36.3% | 46.07 | 5.75 | | | |
| Water in hydrolyzer | 83.00 | 11.4% | 18.00 | 4.61 | | | |
| HCl | 0.36 | 0.0% | 36.00 | 0.01 | | | |
| Sodium bicarbonate | 0.84 | 0.1% | 84.00 | 0.01 | | | |

### Example 21

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 142.00 | 21.1% | 240.37 | 0.59 | 37.84% | 0.59 | 1.77 |
| 45) | | | | | | | |
| Phenylmethyldiethoxysilane | 135.00 | 20.1% | 210.35 | 0.64 | 41.11% | 0.64 | 1.28 |
| (FIG. 38) | | | | | | | |
| Dimethyldiethoxysilane | 0.00 | 0.0% | 148.28 | — | 0.00% | — | — |
| (FIG. 42) | | | | | | | |
| Methyldiethoxysilane (FIG. | 24.00 | 3.6% | 134.25 | 0.18 | 11.45% | 0.18 | 0.36 |
| 39) | | | | | | | |
| Vinylmethyldiethoxysilane | 24.00 | 3.6% | 160.29 | 0.15 | 9.59% | 0.15 | 0.30 |
| (FIG. 40) | | | | | | | |
| Trimethyethoxysilane (FIG. | 0.00 | 0.0% | 118.25 | — | 0.00% | — | — |
| 48) | | | | | | | |
| Acetone in hydrolyzer | 278.00 | 41.3% | 58.08 | 4.79 | | | |
| Ethanol in hydrolyzer | 0.00 | 0.0% | 46.07 | — | | | |
| Water in hydrolyzer | 69.00 | 10.2% | 18.00 | 3.83 | | | |
| HCl | 0.36 | 0.1% | 36.00 | 0.01 | | | |
| Sodium bicarbonate | 0.84 | 0.1% | 84.00 | 0.01 | | | |

### Example 22

Using the reaction type process a precursor formulation was made using the following formulation. The temperature of the reaction was maintained at 72° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Methyltriethoxysilane (FIG. | 0.00 | 0.0% | 178.30 | — | 0.00% | — | — |
| 37) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 56 | 7.2% | 148.28 | 0.38 | 17.71% | 0.38 | 0.76 |
| (FIG. 42) | | | | | | | |
| Methyldiethoxysilane (FIG. | 182 | 23.2% | 134.25 | 1.36 | 63.57% | 1.36 | 2.71 |
| 39) | | | | | | | |
| Vinylmethyldiethoxysilane | 64 | 8.2% | 160.29 | 0.40 | 18.72% | 0.40 | 0.80 |
| (FIG. 40) | | | | | | | |
| Triethoxysilane (FIG. 44) | 0.00 | 0.0% | 164.27 | — | 0.00% | — | — |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 400.00 | 51.1% | 46.07 | 8.68 | | | |
| Water in hydrolyzer | 80.00 | 10.2% | 18.00 | 4.44 | | | |
| HCl | 0.36 | 0.0% | 36.00 | 0.01 | | | |
| Sodium bicarbonate | 0.84 | 0.1% | 84.00 | 0.01 | | | |

### Example 23

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 198.00 | 26.6% | 240.37 | 0.82 | 52.84% | 0.82 | 2.47 |
| 45) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 109.00 | 14.6% | 148.28 | 0.74 | 47.16% | 0.74 | 1.47 |
| (FIG. 42) | | | | | | | |
| Methyldiethoxysilane (FIG. | 0.00 | 0.0% | 134.25 | — | 0.00% | — | — |
| 39) | | | | | | | |
| Vinylmethyldiethoxysilane | 0.00 | 0.0% | 160.29 | — | 0.00% | — | — |
| (FIG. 40) | | | | | | | |
| Trimethyethoxysilane (FIG. | 0.00 | 0.0% | 118.25 | — | 0.00% | — | — |
| 48) | | | | | | | |
| Acetone in hydrolyzer | 365.00 | 49.0% | 58.08 | 6.28 | | | |
| Ethanol in hydrolyzer | 0.00 | 0.0% | 46.07 | — | | | |
| Water in hydrolyzer | 72.00 | 9.7% | 18.00 | 4.00 | | | |
| HCl | 0.36 | 0.0% | 36.00 | 0.01 | | | |
| Sodium bicarbonate | 0.84 | 0.1% | 84.00 | 0.01 | | | |

### Example 24

Using the reaction type process a precursor formulation was made using the following formulation. The temperature of the reaction was maintained at 72° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 180.00 | 22.7% | 240.37 | 0.75 | 44.10% | 0.75 | 2.25 |
| 45) | | | | | | | |
| Phenylmethyldiethoxysilane | 50.00 | 6.3% | 210.35 | 0.24 | 14.00% | 0.24 | 0.48 |
| (FIG. 38) | | | | | | | |
| Dimethyldiethoxysilane | 40.00 | 5.0% | 148.28 | 0.27 | 15.89% | 0.27 | 0.54 |
| (FIG. 42) | | | | | | | |
| Methyldiethoxysilane (FIG. | 30.00 | 3.8% | 134.25 | 0.22 | 13.16% | 0.22 | 0.45 |
| 39) | | | | | | | |
| Vinylmethyldiethoxysilane | 35.00 | 4.4% | 160.29 | 0.22 | 12.86% | 0.22 | 0.44 |
| (FIG. 40) | | | | | | | |
| Trimethyethoxysilane (FIG. | 0.00 | 0.0% | 118.25 | — | 0.00% | — | — |
| 48) | | | | | | | |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 380.00 | 48.0% | 46.07 | 8.25 | | | |
| Water in hydrolyzer | 76.00 | 9.6% | 18.00 | 4.22 | | | |
| HCl | 0.36 | 0.0% | 36.00 | 0.01 | | | |
| Sodium bicarbonate | 0.84 | 0.1% | 84.00 | 0.01 | | | |

### Example 25

Using the reaction type process a precursor formulation was made using the following formulation. The temperature of the reaction was maintained at 72° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 190.00 | 23.8% | 240.37 | 0.79 | 47.22% | 0.79 | 2.37 |
| 45) | | | | | | | |
| Phenylmethyldiethoxysilane | 75.00 | 9.4% | 210.35 | 0.36 | 21.30% | 0.36 | 0.71 |
| (FIG. 38) | | | | | | | |
| Dimethyldiethoxysilane | 45.00 | 5.6% | 148.28 | 0.30 | 18.13% | 0.30 | 0.61 |
| (FIG. 42) | | | | | | | |
| Methyldiethoxysilane | 30.00 | 3.8% | 134.25 | 0.22 | 13.35% | 0.22 | 0.45 |
| (FIG. 39) | | | | | | | |
| Vinylmethyldiethoxysilane | 0.00 | 0.0% | 160.29 | — | 0.00% | — | — |
| (FIG. 40) | | | | | | | |
| Trimethyethoxysilane | 0.00 | 0.0% | 118.25 | — | 0.00% | — | — |
| (FIG. 48) | | | | | | | |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 380.00 | 47.7% | 46.07 | 8.25 | | | |
| Water in hydrolyzer | 76.00 | 9.5% | 18.00 | 4.22 | | | |
| HCl | 0.36 | 0.0% | 36.00 | 0.01 | | | |
| Sodium bicarbonate | 0.84 | 0.1% | 84.00 | 0.01 | | | |

### Example 26

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 0.00 | 0.0% | 240.37 | — | 0.00% | — | — |
| 45) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 235.00 | 31.5% | 148.28 | 1.58 | 83.32% | 1.58 | 3.17 |
| (FIG. 42) | | | | | | | |
| Methyldiethoxysilane (FIG. | 0.00 | 0.0% | 134.25 | — | 0.00% | — | — |
| 39) | | | | | | | |
| Vinylmethyldiethoxysilane | 0.00 | 0.0% | 160.29 | — | 0.00% | — | — |
| (FIG. 40) | | | | | | | |
| TES 40 (FIG. 35) | 66.00 | 8.8% | 208.00 | 0.32 | 16.68% | 0.32 | 1.27 |
| Hexane in hydrolyzer | 0.00 | 0.0% | 86.18 | — | | | |
| Acetone in hydrolyzer | 370.00 | 49.6% | 58.08 | 6.37 | | | |
| Ethanol in hydrolyzer | 0.00 | 0.0% | 46.07 | — | | | |
| Water in hydrolyzer | 74.00 | 9.9% | 18.00 | 4.11 | | | |
| HCl | 0.36 | 0.0% | 36.00 | 0.01 | | | |
| Sodium bicarbonate | 0.84 | 0.1% | 84.00 | 0.01 | | | |

### Example 27

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 0.00 | 0.0% | 240.37 | — | 0.00% | — | — |
| 45) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 95.00 | 11.8% | 148.28 | 0.64 | 34.95% | 0.64 | 1.28 |
| (FIG. 42) | | | | | | | |
| Methyldiethoxysilane (FIG. | 60.80 | 7.6% | 134.25 | 0.45 | 24.71% | 0.45 | 0.91 |
| 39) | | | | | | | |
| Vinylmethyldiethoxysilane | 73.15 | 9.1% | 160.29 | 0.46 | 24.90% | 0.46 | 0.91 |
| (FIG. 40) | | | | | | | |
| TES 40 (FIG. 35) | 58.90 | 7.3% | 208.00 | 0.28 | 15.45% | 0.28 | 1.13 |
| Hexane in hydrolyzer | 0.00 | 0.0% | 86.18 | — | | | |
| Acetone in hydrolyzer | 430.00 | 53.4% | 58.08 | 7.40 | | | |
| Ethanol in hydrolyzer | 0.00 | 0.0% | 46.07 | — | | | |
| Water in hydrolyzer | 86.00 | 10.7% | 18.00 | 4.78 | | | |
| HCl | 0.36 | 0.0% | 36.00 | 0.01 | | | |
| Sodium bicarbonate | 0.84 | 0.1% | 84.00 | 0.01 | | | |

### Example 28

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 0.00 | 0.0% | 240.37 | — | 0.00% | — | — |
| 45) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 140.00 | 17.9% | 148.28 | 0.94 | 58.38% | 0.94 | 1.89 |
| (FIG. 42) | | | | | | | |
| Methyldiethoxysilane (FIG. | 0.00 | 0.0% | 134.25 | — | 0.00% | — | — |
| 39) | | | | | | | |
| Vinylmethyldiethoxysilane | 0.00 | 0.0% | 160.29 | — | 0.00% | — | — |
| (FIG. 40) | | | | | | | |
| TES 40 (F(G. 35) | 140.00 | 17.9% | 208.00 | 0.67 | 41.62% | 0.67 | 2.69 |
| Hexane in hydrolyzer | 0.00 | 0.0% | 86.18 | — | | | |
| Acetone in hydrolyzer | 420.00 | 53.6% | 58.08 | 7.23 | | | |
| Ethanol in hydrolyzer | 0.00 | 0.0% | 46.07 | — | | | |
| Water in hydrolyzer | 84.00 | 10.7% | 18.00 | 4.67 | | | |

### Example 29

Using the reaction type process a precursor formulation was made using the following formulation. The temperature of the reaction was maintained at 61° C. for 21 hours.

| | | | | | % of | | |
|---|---|---|---|---|---|---|---|
| | | | | Moles of | Total | | Moles |
| | | % of | | Reactant/ | Moles of | Moles | of |
| Reactant or Solvent | Mass | Total | MW | solvent | Silane | of Si | EtOH |
| Phenyltriethoxysilane (FIG. | 0.00 | 0.0% | 240.37 | — | 0.00% | — | — |
| 45) | | | | | | | |
| Phenylmethyldiethoxysilane | 0.00 | 0.0% | 210.35 | — | 0.00% | — | — |
| (FIG. 38) | | | | | | | |
| Dimethyldiethoxysilane | 20.00 | 2.6% | 148.28 | 0.13 | 10.67% | 0.13 | 0.27 |
| (FIG. 42) | | | | | | | |
| Methyldiethoxysilane (FIG. | 0.00 | 0.0% | 134.25 | — | 0.00% | — | — |
| 39) | | | | | | | |
| Vinylmethyldiethoxysilane | 0.00 | 0.0% | 160.29 | — | 0.00% | — | — |
| (FIG. 40) | | | | | | | |
| TES 40 (FIG. 35) | 235.00 | 30.0% | 208.00 | 1.13 | 89.33% | 1.13 | 4.52 |
| Hexane in hydrolyzer | 0.00 | 0.0% | 86.18 | — | | | |
| Acetone in hydrolyzer | 440.00 | 56.2% | 58.08 | 7.58 | | | |
| Ethanol in hydrolyzer | 0.00 | 0.0% | 46.07 | — | | | |
| Water in hydrolyzer | 88.00 | 11.2% | 18.00 | 4.89 | | | |

### Example 30

A polysilocarb formulation is combined with a reinforcing material to form a preform, which is partially or completely cured to form a reinforced composite material in the shape of a component part. The component part is cured, and preferably hard cured. The hard cured component part is pyrolized to form a polysicocarb derived reinforced composite component part, which is taken through from two to five reinfiltration, cure and pyrolysis cycles. The end reinforced component part is ready for further processing, e.g., machining to tolerances, assembly steps, integration steps, or use. The polysicocarb derived ceramic component part may find applications, or be designed for use in, or as, among other things components of and the embodiments illustrated in the figures of this specification. The use of the polysilocarb derived ceramic composite component parts can provide several features, including among other things, high temperature resistance, corrosion resistance, UV resistance, lightweight, low cost (significantly lower, by as much as several orders of magnitude over silicon carbide and conventional polymer derived ceramics), increased strength to weight rations (e.g., stronger and lighter, same strength and lighter, stronger and same weight), and fire resistance.

### Example 31

The polysilocarb derived ceramic composite component parts of Example 30 where the polysilocarb formulation includes a vinyl terminated siloxane.

### Example 32

The polysilocarb derived ceramic composition component parts of Example 30 where the polysilocarb formulation is 60% MHF, 20% TV, 5% Vt and 10% MVF (a reacted formulation of all vinylmethyldiethoxysilane, e.g., the formulations of Examples 66-68)

### Example 33

The polysilocarb derived ceramic composite component parts of Example 30 where the polysilocarb formulation includes about 10% of the vinyl terminated siloxane.

### Example 34

A polysilocarb formulation is combined with a reinforcing material to form a precursor, which is partially or completely cured to form a reinforced composite material in the shape of a component part. The component part is cured, and preferably end cured. The end component part is ready for further processing, e.g., machining to tolerances, assembly steps or use. The polysicocarb derived plastic component part may find applications, or be designed for use in, or as, among other things components of and the embodiments illustrated in the figures of this specification. The use of the polysilocarb derived reinforced composite component parts can provide several features, including among other things, higher temperature resistance (including the ability to retain, or substantially maintain structural integrity during exposure to higher temperatures), include increased strength to weight rations (e.g., stronger and lighter, same strength and lighter, stronger and same weight), light weight, low cost, UV resistance, corrosion resistance, fire resistance, and fire retardation.

### Example 35

The polysilocarb derived ceramic composite component parts of Example 34 where the polysilocarb formulation includes a vinyl terminated siloxane.

### Example 36

The polysilocarb derived ceramic composition component parts of Example 34 where the polysilocarb formulation is 60% MHF, 20% TV, 5% Vt and 10% MVF (a reacted formulation of all vinylmethyldiethoxysilane, e.g., the formulations of Examples 66-68).

### Example 37

The polysilocarb derived ceramic composite component parts of Example 34 where the polysilocarb formulation includes about 10% of the vinyl terminated siloxane.

### Example 38

A polysilocarb formulation is combined with a reinforcing material to form a precursor to a reinforced composite, which is cured to form a reinforced composite material in the shape of a component part. The component part is cured, and preferably hard cured. The hard cured component part is pyrolized to form a polysicocarb derived composite component part, which is then infiltrated with a polysilocarb formulation, which is then cured. This material can be referred to as a polysilocarb plastic-ceramic, or plastic-ceramic, reinforced structure is ready for further processing, assembly steps or use, such as in the components of, and the embodiments illustrated in the figures of this specification.

### Example 39

A polysilocarb formulation is formed into the shape of a larger internal diameter (from about 5 inches to about 36 inches, or larger) tube structure. This tube structure is reinforced with reinforcing material arranged to provide both hoop strength (e.g., burst and crush) and axial strength (e.g., bending, elongation, and compression). The thickness of the wall of the tube is dependent upon the end use requirements, the reinforcement material, and whether the material is a plastic, ceramic or plastic-ceramic. By way of example, the thickness could range from about less than a ¼ inch to 5 inches or more. These polysilocarb tube structures are then cured, to preferable to an end cure. They may also be pyrolized into a ceramic, which may be subject to additional reinfiltration, curing and pyrolysis steps (one to five or more) to provide a ceramic, or they may be subjected to additional reinfiltration and curing steps (one to three or more) to provide a plastic-ceramic. Once so formed, the tube structures can be subject to: further processing, e.g., machining to specification; the incorporation of end assemblies, e.g., flanges, couplings, joints, connectors; the incorporation of secondary lines (external, internal and both), e.g., data lines, choke lines, kill lines, hydraulic lines, electric lines, etc.; they may have a second tube formed around them, or may be inserted into or over a second tube forming a tube-in-tube structure (e.g., a double walled pipeline); and the addition of sensors and monitoring equipment (although it should be noted that break detection devices, in for example the form of wires, or optical fibers, could be incorporated into the wall of the tube structure during formation). These tube structures provide many features include increased strength to weight rations (e.g., stronger and lighter, same strength and lighter, stronger and same weight).

### Example 40

The polysilocarb tube structure of EXAMPLE 39 is a marine riser for off shore hydrocarbon exploration and production activities. Each riser section is about 75 feet long and the riser sections are capable of being assembled into a deep sea rise that can extend down from the surface to the sea floor for depth of more than 5,000 ft, 10,000 ft, 15,000 ft, 20,000 ft or more. The riser has is substantially less dense than traditional steel risers. Thus, the riser wall can have a density of less than about 5 g/cm³, and less than about 3 g/cm³, which is substantially less than the density of steel, which is about 7.8 g/cm³. The reduced density of the polysilocarb riser reduces the amount of flotation needed, and thus reduces the over all outer diameter of the as deployed riser. The smaller outer diameter provides the advantage of reducing the amount of surface area that is subject to currents and thus reduces the stresses placed upon the riser.

### Example 41

A polysilocarb formulation is coated onto the surface of a pipe and soft cured. The polysilocarb formulation can be net or it can be filled, for example, with pyrolized polysilocarb ceramic fines. This process is repeated until the desired thickness of the coating is obtained. Once the desired thickness of the coating has been obtained the soft cured layers are end cured. A coating along the exterior of the pipe can provide thermal insulation to the pipe, as well as, corrosion resistance. An internal coating to the pipe may also provide thermal insulation for the materials in the pipe, and provides corrosion resistance. The corrosion resistance provided by the cured polysilocarb internal coating can enable the replacement of more expensive stainless steel and other high priced alloys with lower priced metals.

### PDC Based Articles and Hydrocarbon Exploration and Production

Geologists have known for years that substantial deposits of oil and natural gas are trapped in deep shale formations. These shale reservoirs were created tens of millions of years ago. With modern horizontal drilling techniques and hydraulic fracturing, the trapped oil and natural gas in these shale reservoirs is being safely and efficiently produced, gathered and distributed to customers.

Conventional approaches to drilling and completing wells are documented in the “Rotary Drilling Series” published by the Petroleum Extension Service of the University of Texas at Austin, the entire contents of which are hereby incorporated by reference.

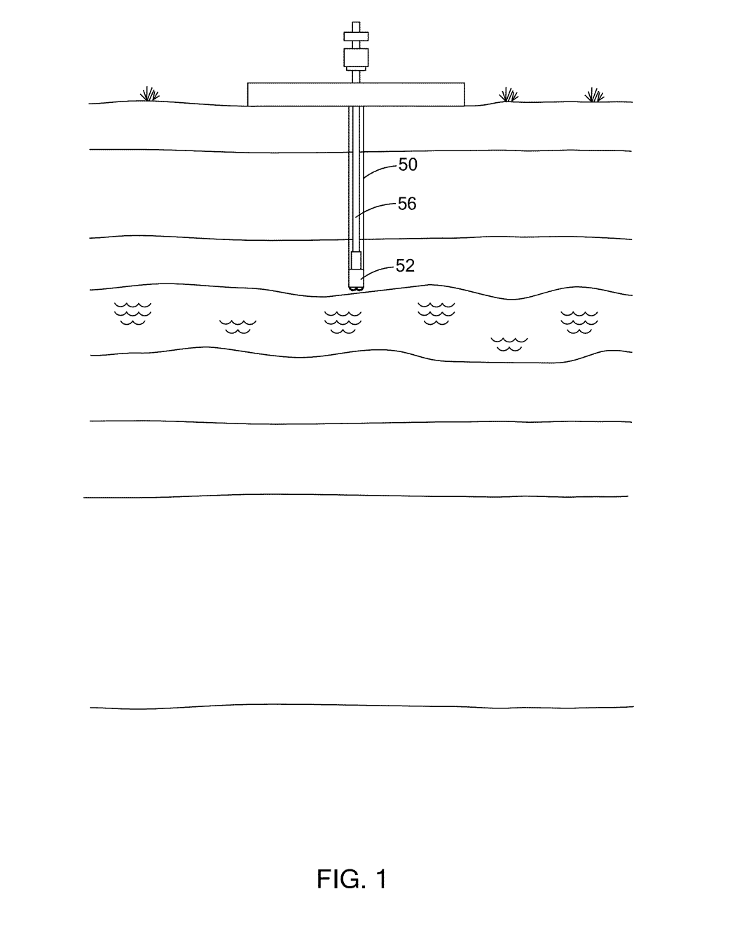

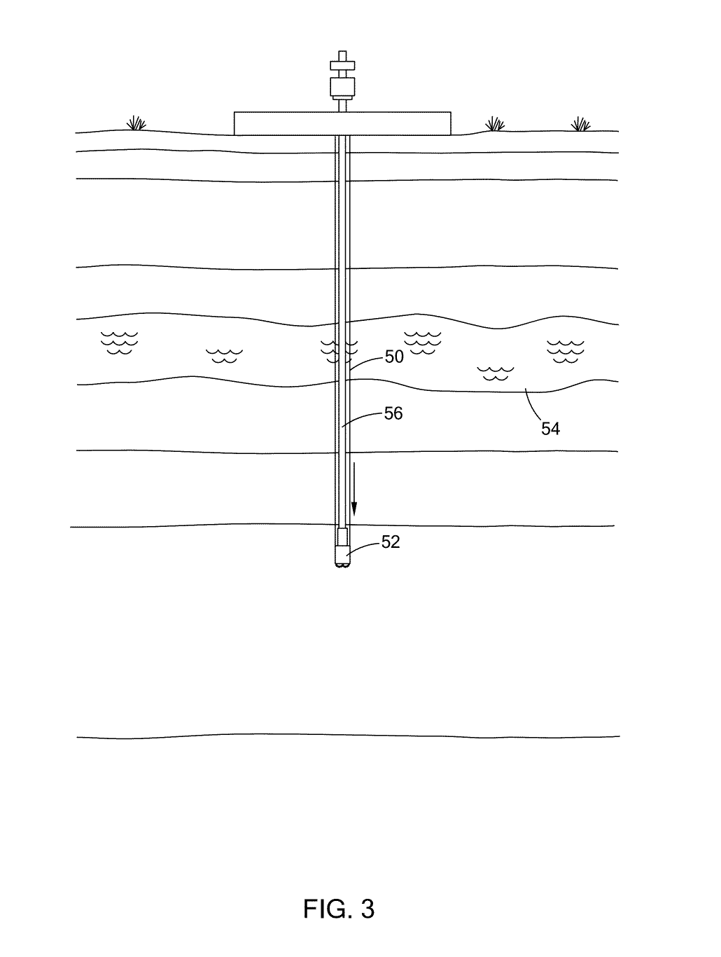

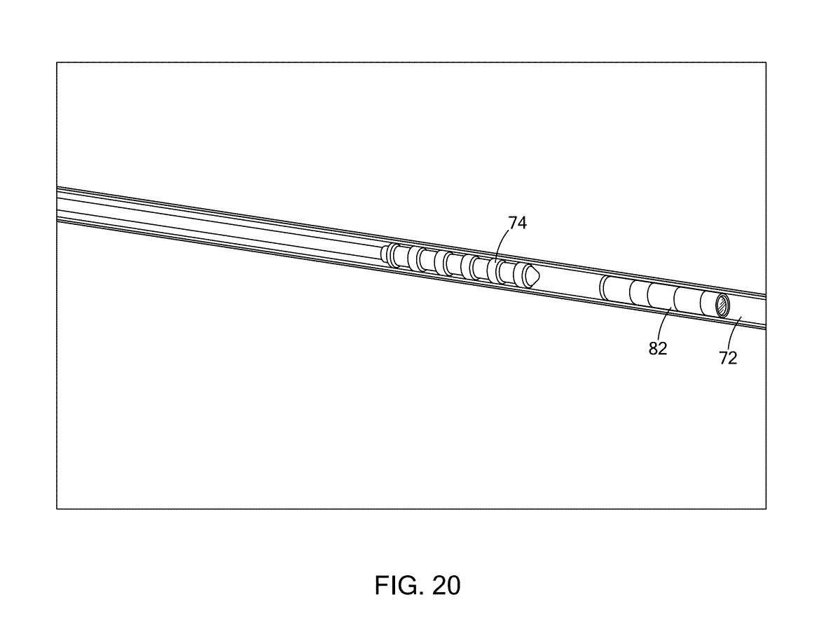

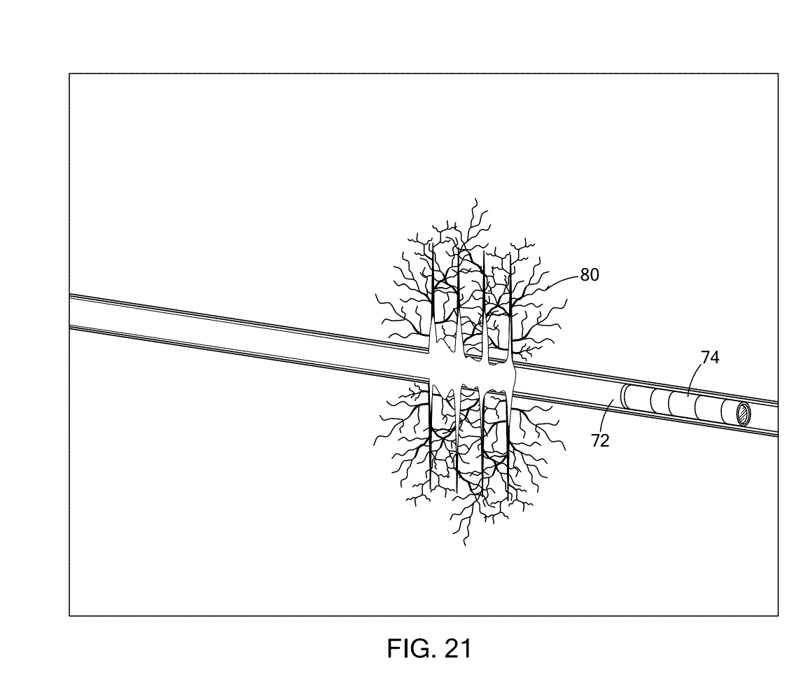

With reference now to FIGS. 1 to 34, there are illustrated embodiments of the present polymer derived ceramic structures for the drilling, completion, production and other processes for conventional and unconventional oil and natural gas wells. Shale reservoirs are usually one mile or more below the surface of the earth, well below any underground source of drinking water, which is typically no more than 300 to 1000 feet below the surface. Typically, during the drilling process, the rig is in constant operation 24 hours a day, 7 days a week for approximately 21 to 28 days. As an added precaution, a protective mat can be placed to cover the pad site. Utilizing heavy-duty industrial strength drill bits, a typical well is drilled in several stages starting with a large diameter drill bit and then successively smaller drill bits as the drilling is advanced.

Such drill bits can be manufactured from polymer derived ceramic materials. Further the cutters, or cutting members can be made from abrasive materials derived from the present polysilocarb precursors, including SiC (the making and use of polysilocarb derived abrasives, including SiC, abrasive members, and cutters, etc., are disclosed and taught in U.S. patent application Ser. No. 14/634,814 and 62/112,025 the entire disclosure of each of which are incorporated herein by reference).

After drilling each portion of the well, nested protective casing is cemented into place. Again, such casing can be formed from polymer derived ceramic materials. This will protect ground water and maintain the integrity of the well. Initially, prior to removing in the drilling rig, a large diameter hole is drilled for the first 50 to 80 feet. Conductor casing is then cemented into place stabilizing the ground around the drilling rig and well hole and isolating the well from most private water wells. That is, pipes called casing cemented in place provide a multi layered barrier to protect fresh water aquifers. During the past 60 years, the oil and gas industry has conducted fracture stimulations in over one million wells worldwide. The initial steps are essentially the same as for any conventional well.

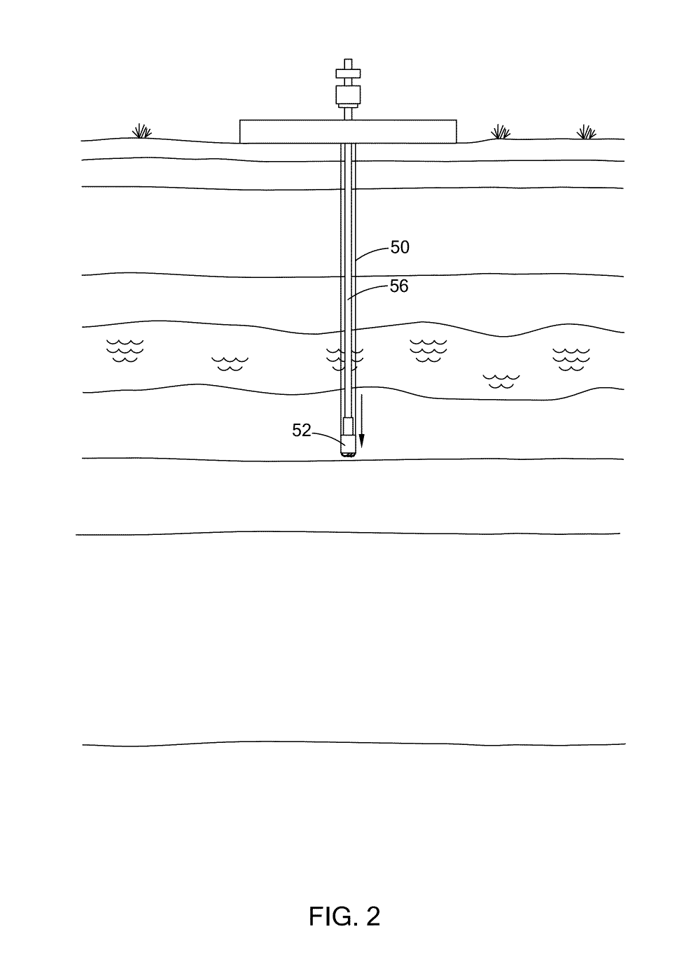

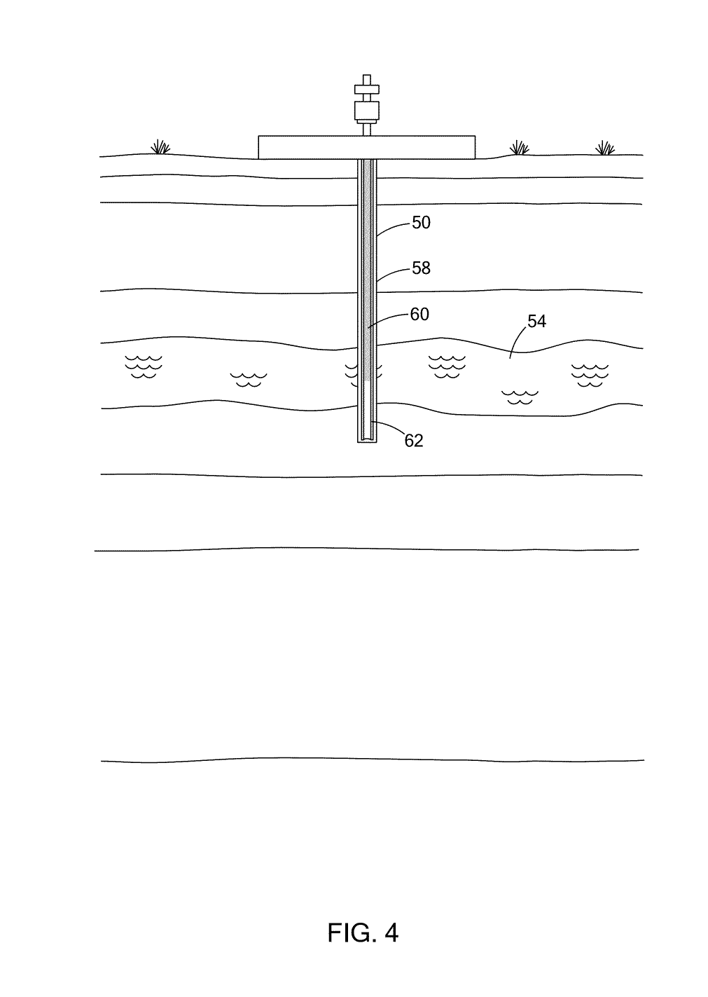

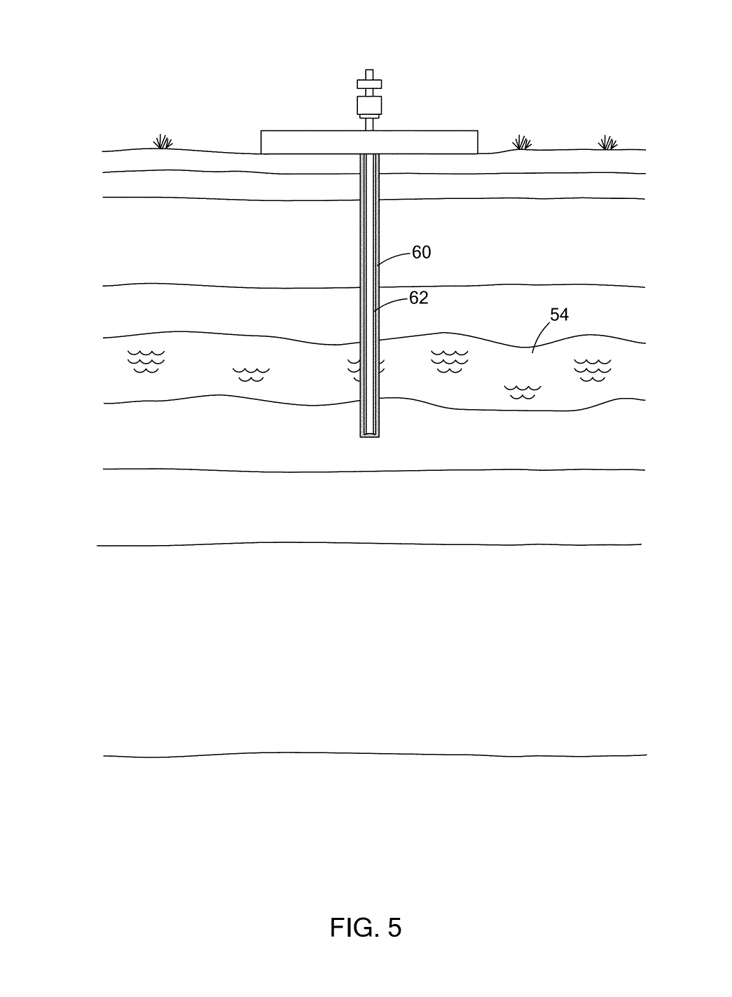

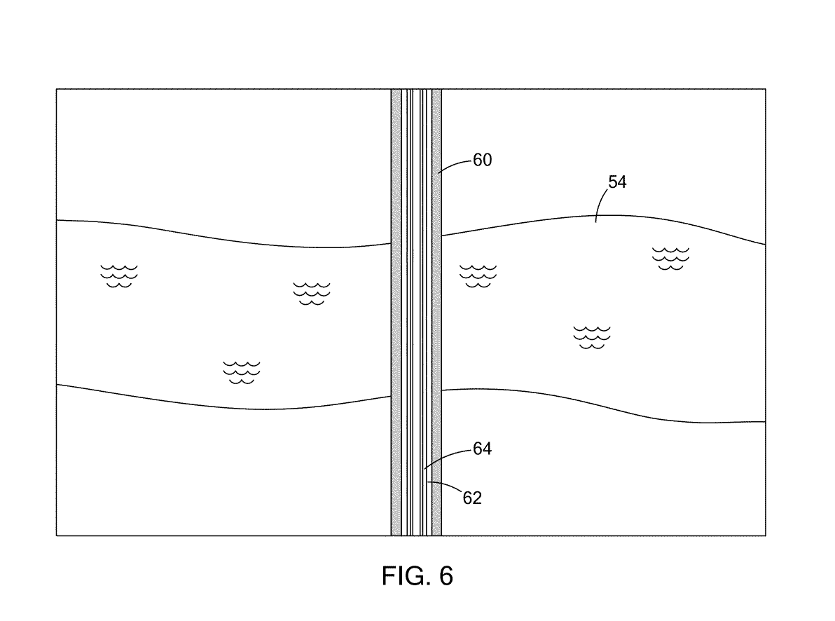

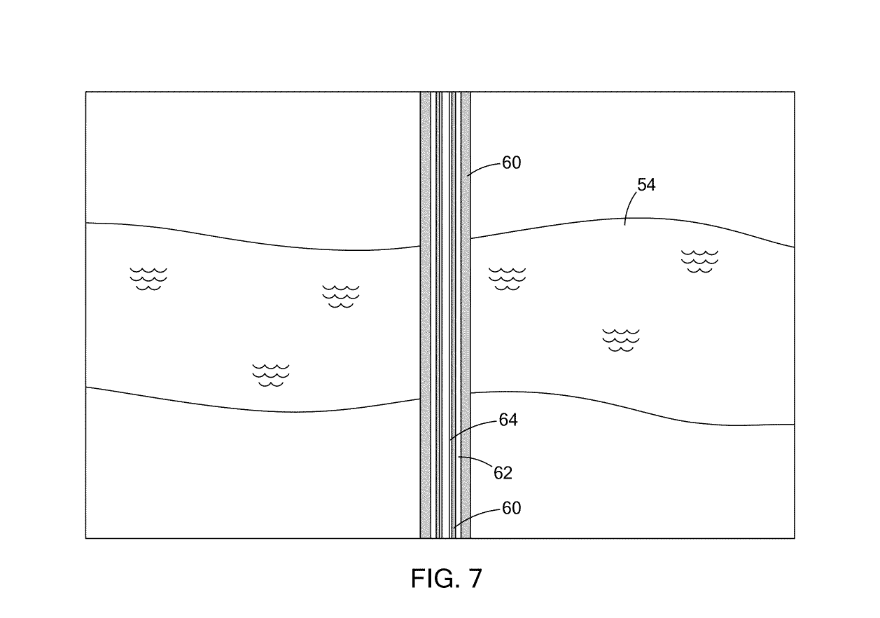

As shown in FIG. 1, a hole 50 is drilled straight down using fresh water based fluids which cools the drill bit 52, carries the rock cuttings back to the surface, and stabilizes the wall of the wellbore. A series of compressors and boosters generate the air that is used to move the rock cuttings and fresh water into steel bins. The rock cuttings are then disposed of within regulation guidelines and permits. Once the hole extends below the deepest fresh water aquifer, the drill pipe 56 is removed and replaced with pipe called surface casing 58 (See FIGS. 2-4). Again, the drill pipe can be formed from polymer derived ceramic material. Next, cement 60 is pumped down the casing 62 (FIG. 4). When it reaches the bottom, it is pumped down and then back up between the casing 62 and the bore hole wall creating an impermeable additional protective barrier between the wellbore and any fresh water sources 54 (FIG. 5). A blowout preventer (not shown) is installed after the surface casing has been cemented. The blowout preventer is a series of high-pressure safety valves and seals attached to the top of the casing to control well pressure and prevent surface releases. In some cases, depending on the geology of the area and the depth of the well, additional casing sections 64, 66 may be run and like surface casing are then cemented in place to ensure no movement of fluids or gas between those layers and the ground water sources (See FIGS. 6 and 7).

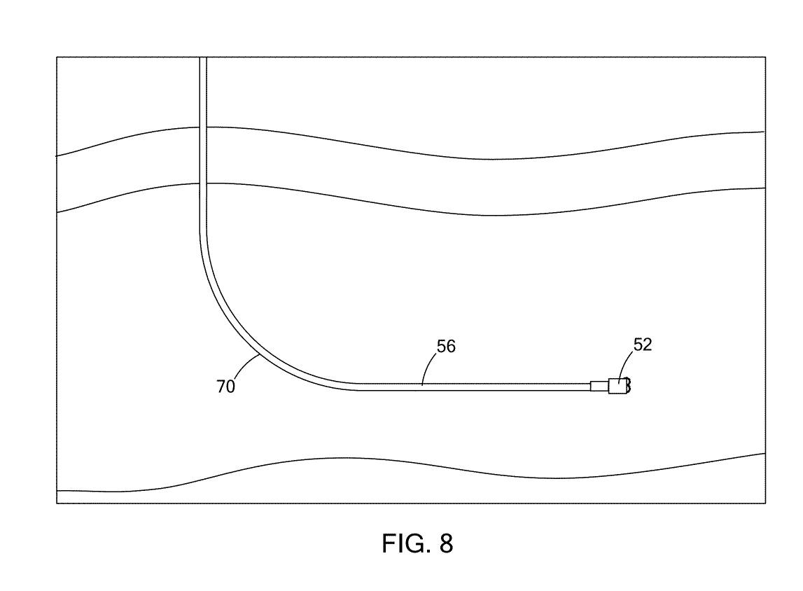

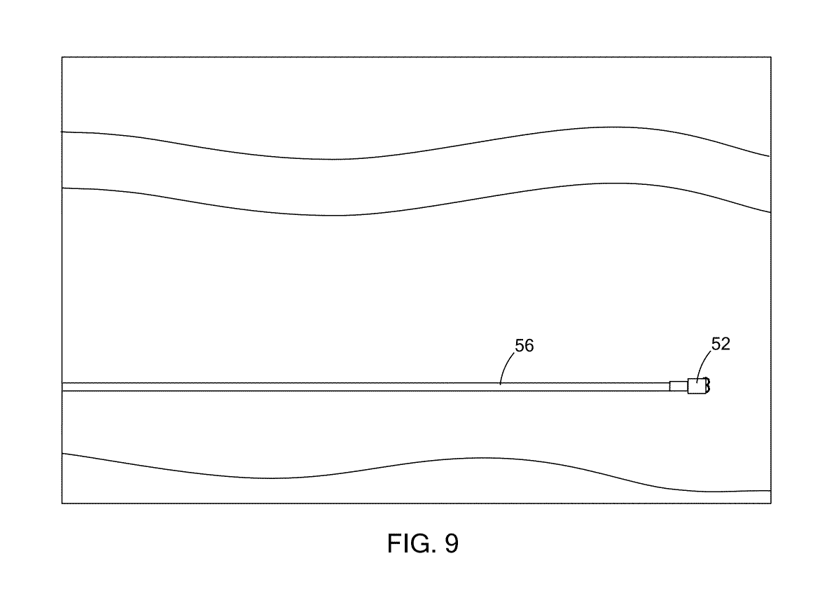

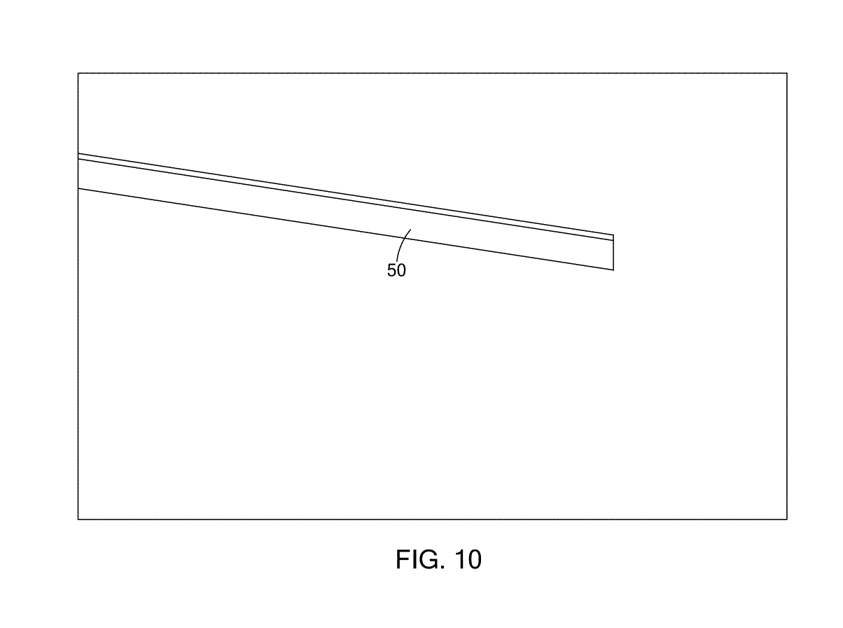

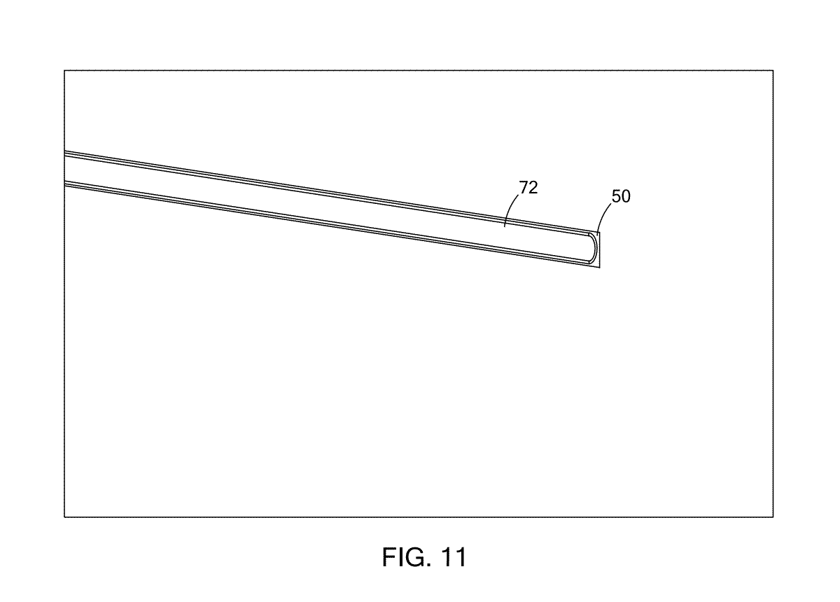

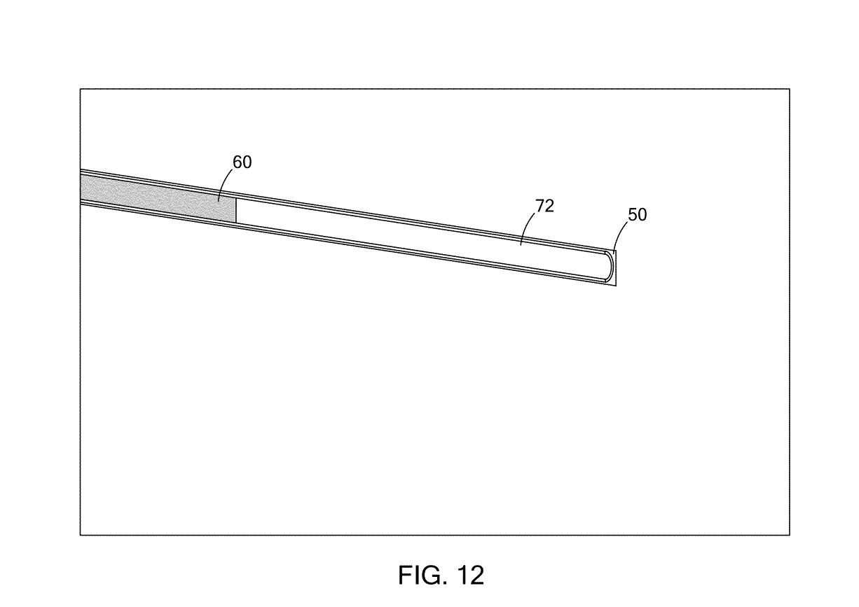

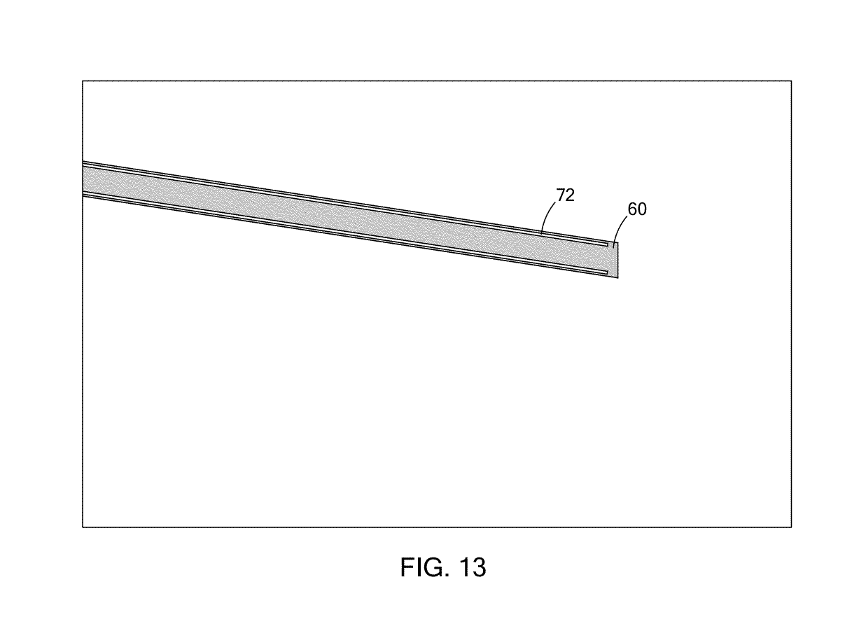

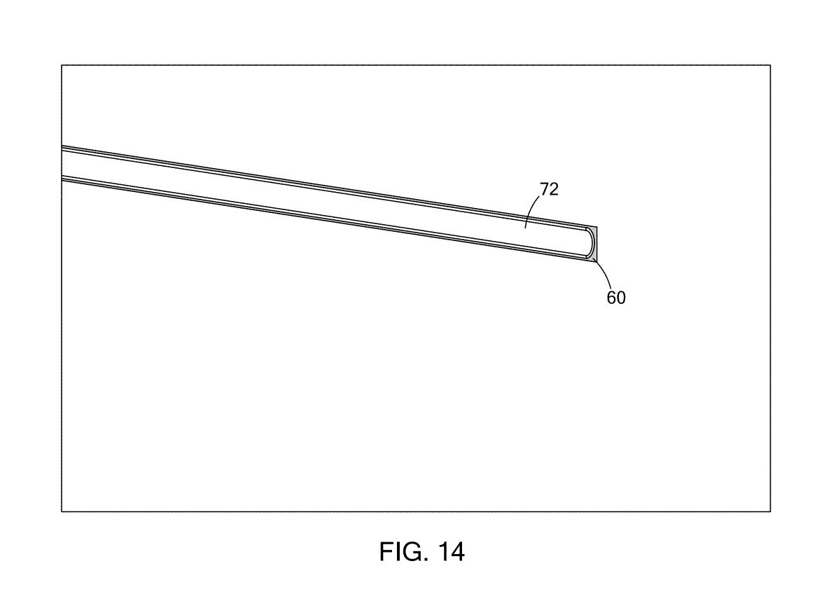

Next, a small drilling assembly is passed down through the surface casing. At the bottom of the casing, the bit drills through float equipment and cement continuing its journey to the natural gas target area as deep as 8000 feet below the surface. What makes drilling for hydrocarbons in a shale formation unique is the horizontal drilling approach. Vertical drilling continues to a depth called the kickoff point 70. This is where the wellbore begins curving to become horizontal (FIGS. 8 and 9). One of the advantages of horizontal drilling is that it is possible to drill several wells from only one drilling pad minimizing the impact to the surface environment. When the targeted distance is reached, the drill pipe is removed leaving the bore 50 (FIG. 10) and additional casing 72 is inserted through the full length of the wellbore (FIG. 11). Once again, the casing 72 is cemented 60 in place (FIGS. 12 and 13). For some horizontal developments, new technology in the form of sliding sleeves and mechanical isolation devices, replace cement in the creation of isolations along the wellbore. In addition to lifting the rock cuttings out of the hole, drilling mud also helps to stabilize the hole, cool the drill bit and control the downhole pressure. A few 100 feet above the target shale, the drilling assembly comes to a stop. Drilling continues horizontally through the shale at lengths greater than 4000 feet from the point where it entered the formation. Once drilling is completed, the equipment is retracted to the surface. Once the drilling is finished and the final casing 72 has been installed (FIG. 14) the drilling rig is removed and preparations are made for the well completion.

The first step in completing a well is the creation of a connection between the final casing 72 and the reservoir rock. A smaller diameter casing called production casing is installed throughout the total length of the well. Here also, production casing can be formed from polymer derived ceramics. The production casing is cemented and secured in place by pumping cement down through the end of the casing. Depending on regional geologic conditions, the cement is pumped around the outside casing wall through approximately 2500 feet above the producing shale formation or to the surface. The cement creates a seal to ensure that formation fluids can only be produced via the production casing. After each layer of each casing is installed, the well is pressure tested to ensure its integrity for continued drilling. A cross section of the well below surface builds several protective layers of cement and conductor or surface casing.

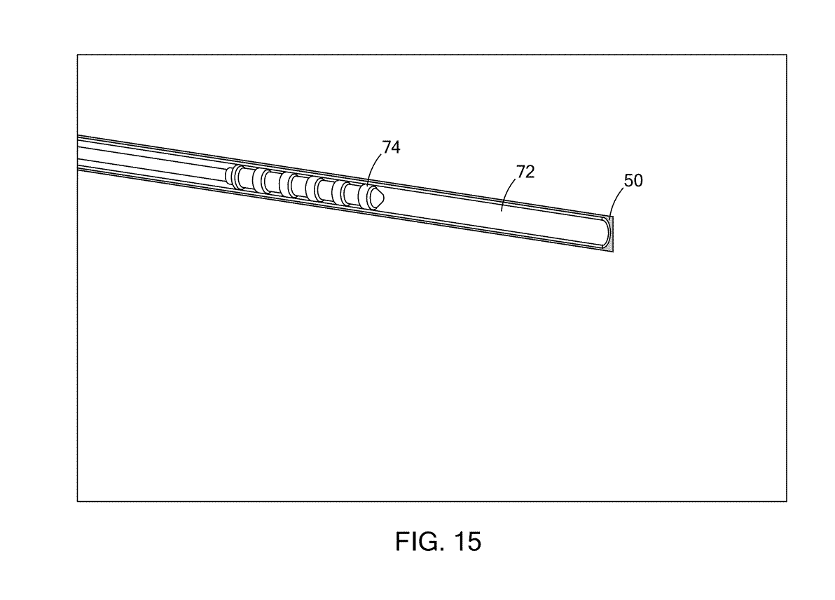

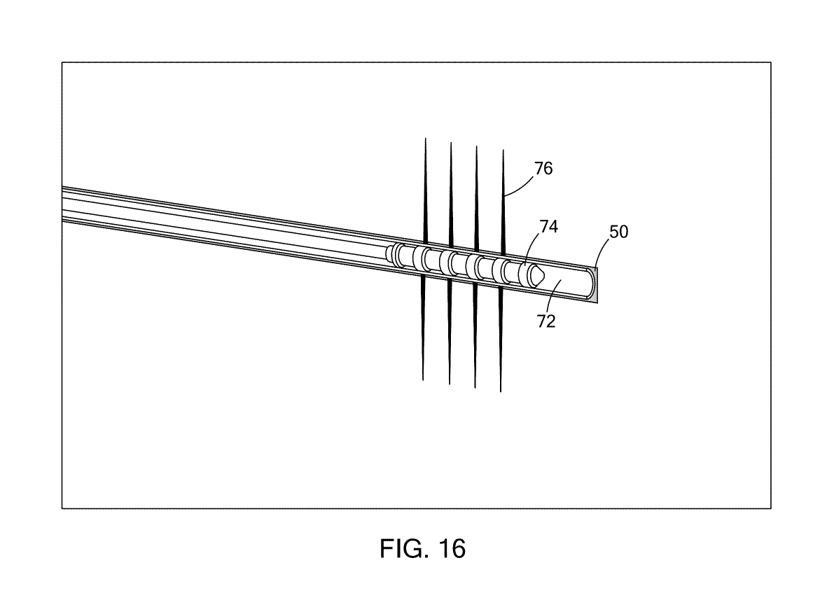

Next, there is a lowering of a specialized tool called a perforating gun 74 which is equipped with shaped explosive charges down to the rock layer containing oil or natural gas. The structure of the perforating gun can be formed at least in part from polymer derived ceramic material. This perforating gun is then fired which creates holes 76 through the casing, cement and into the target rock (FIGS. 15 and 16). These perforating holes 76 connect the reservoir and the wellbore. Since the perforations are only a few inches long and are performed often more than a mile underground, the entire process is imperceptible on the surface. The perforation gun is then removed in preparation for the next step—hydraulic fracturing.

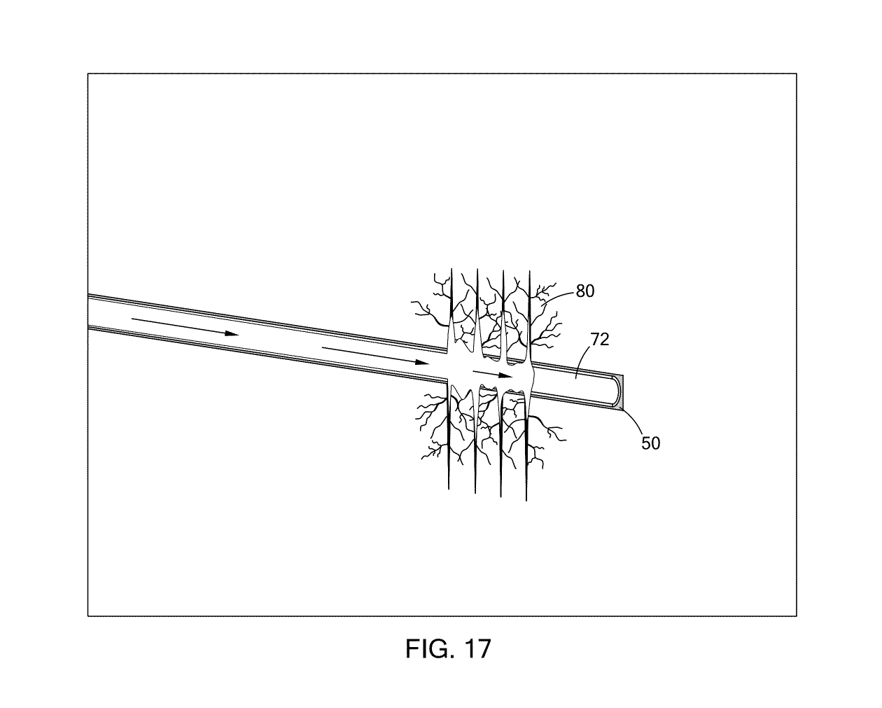

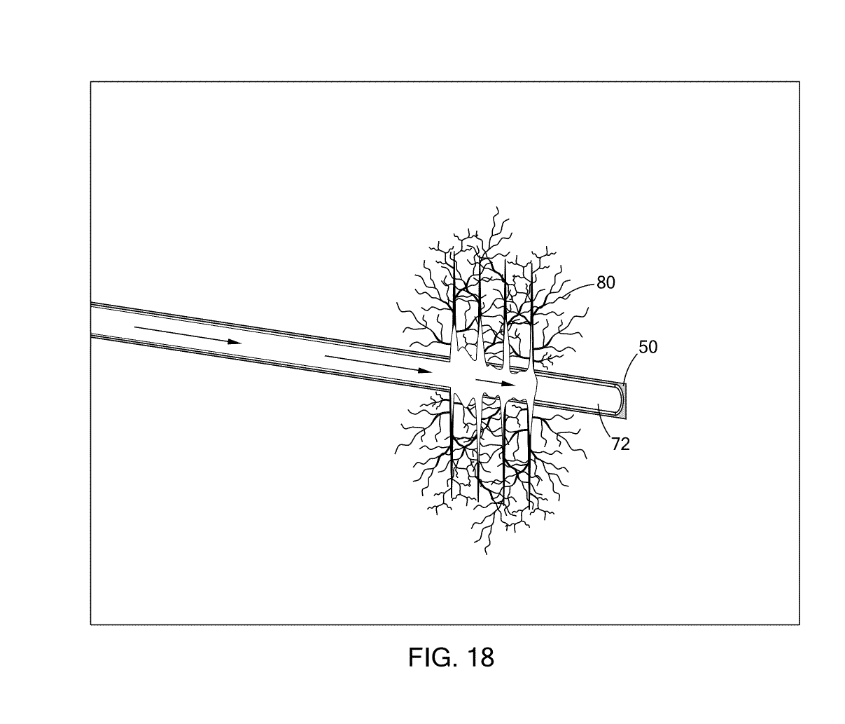

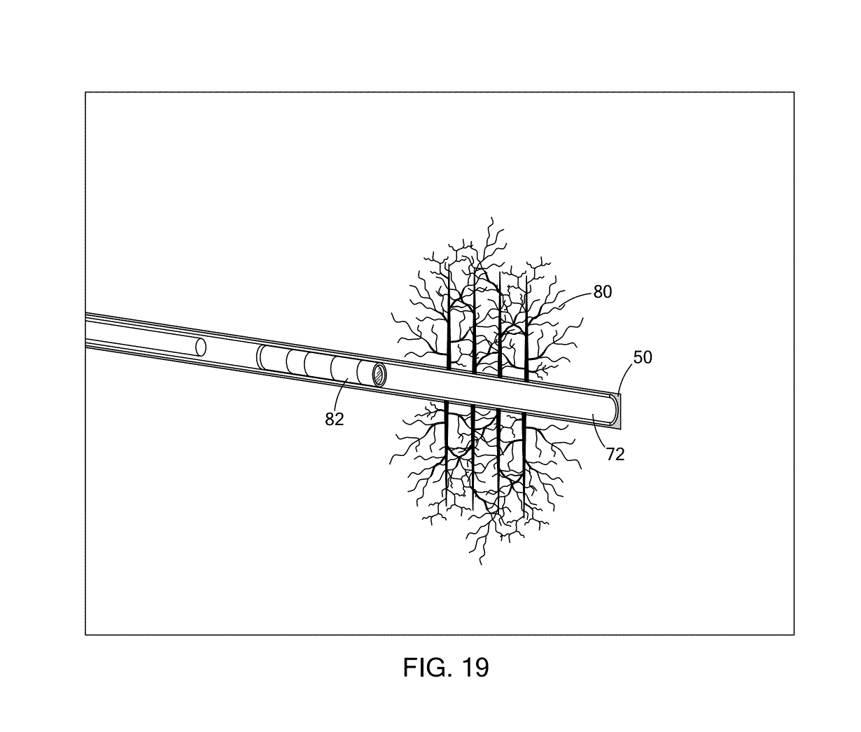

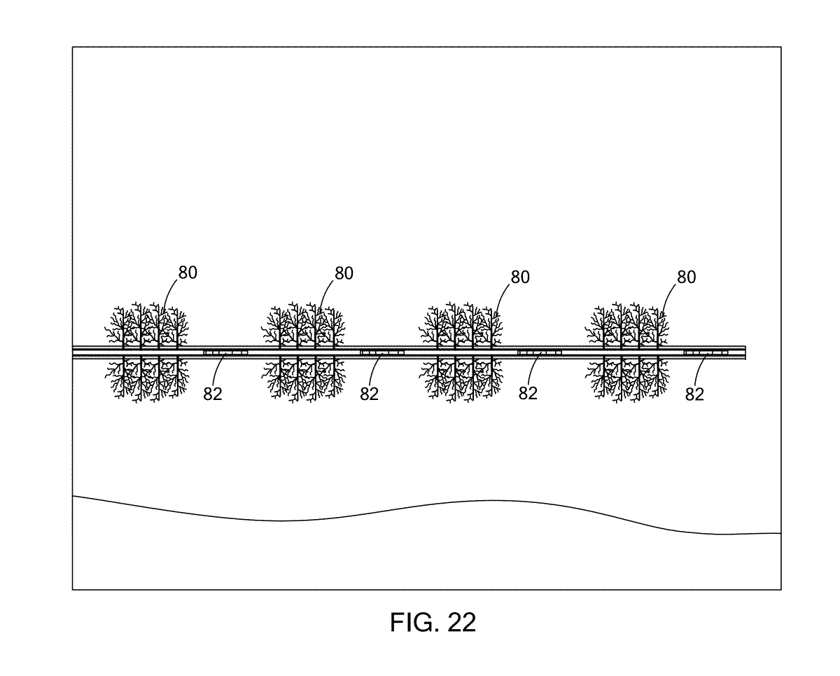

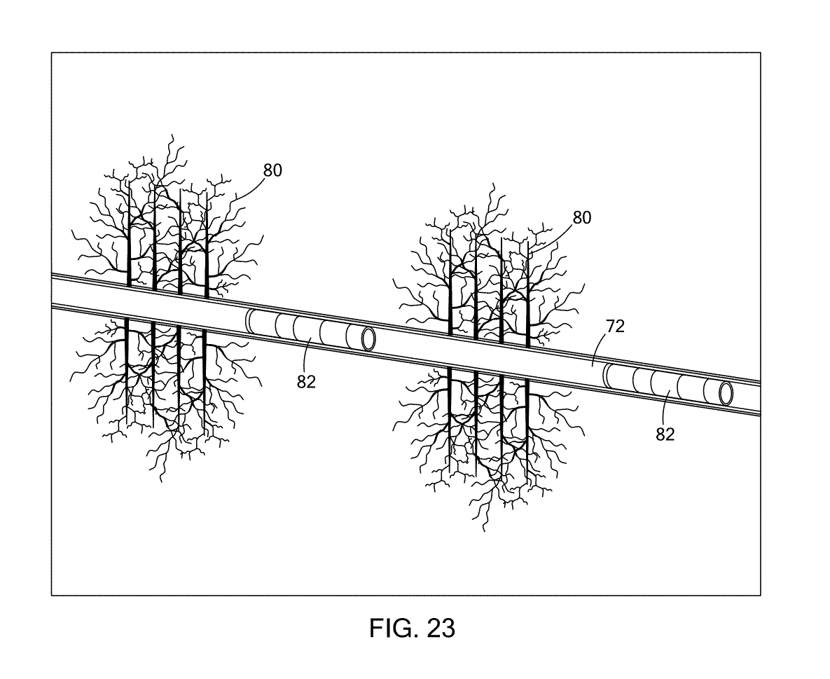

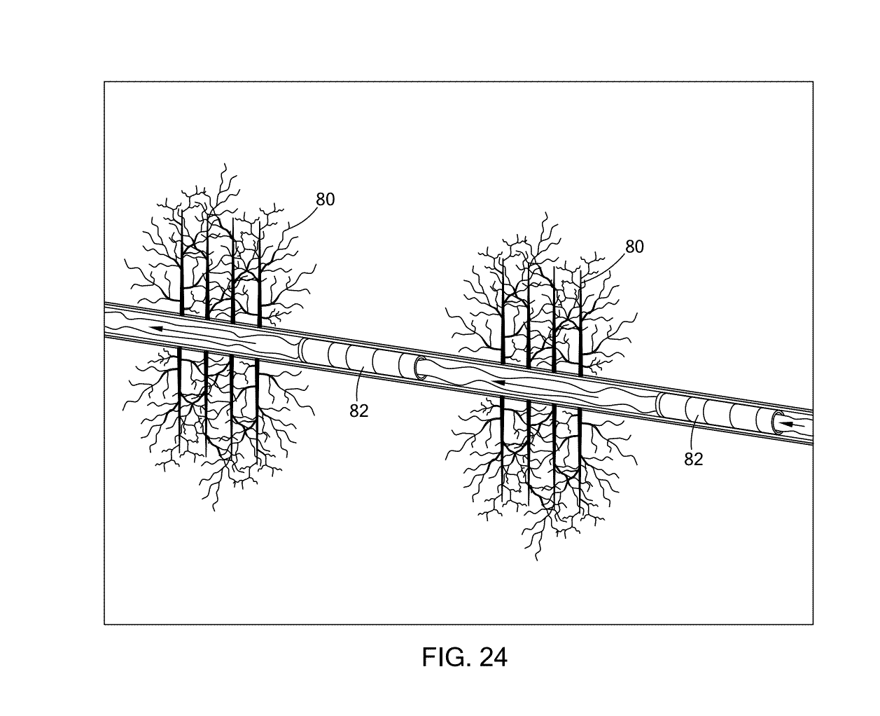

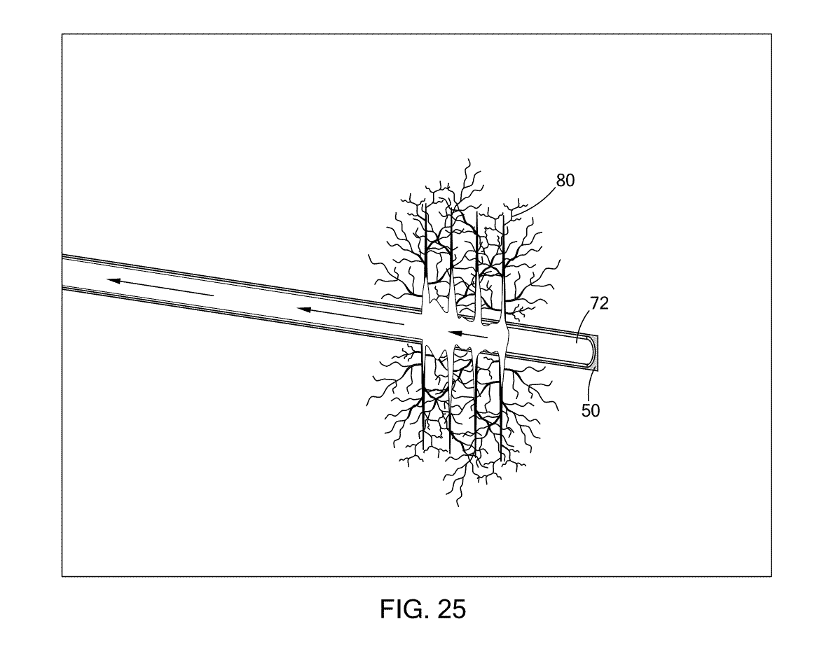

The drilling process further involves the pumping of a mixture of mostly water and sand plus a few chemicals under controlled conditions into deep underground reservoir formations. The chemicals are generally used for friction reduction, to keep bacteria from forming and to help carry the sand. These chemicals typically range in concentrations from 0.1 to 0.5% by volume and help to improve the performance of the stimulation. This stimulation fluid is sent to trucks that pump the fluid into the wellbore and out through the perforations that were earlier formed. This process creates fractures 80 in the oil and gas reservoir rock (FIGS. 17, 18). The sand and the frac fluid remain in these fractures in the rock and keeps them open when the pump pressure is relieved. This allows the previously trapped oil or natural gas to flow to the wellbore more easily. This initial stimulation segment is then isolated with a specially designed plug 82 also contemplated to be formed from polymer derived ceramic material and the perforating guns are used to perforate the ground (FIGS. 19-21). This area is then hydraulically fractured in the same manner. This process is repeated along the entire horizontal section of the well, which can extend several miles (FIG. 22). Once the stimulation is complete the isolation plugs are drilled out and production begins (FIGS. 23-24). Initially water, and then natural gas or oil flows into the horizontal casing and up the wellbore (FIG. 25).

In the course of initial production of the well approximately 15 to 50% of the fracturing fluid is recovered. This fluid is either recycled to be used on other fracturing operations or safely disposed of according to government regulations. The whole process of developing a well typically takes from 3 to 5 months, a few weeks to prepare the site, 4 to 6 weeks to drill the well, and then 1 to 3 months of completion activities which includes 1 to 7 days of stimulation. But this 3 to 5 month investment can result in a well that will produce oil or natural gas for 20 to 40 years or more. When all of the oil or natural gas that can be recovered economically from a reservoir has been produced, work begins to return the land to the way it was before the drilling operations commenced. Wells will be filled with cement and pipes cut off 3 to 6 feet below ground level. All surface equipment will be removed and all pads will be filled in with dirt or replanted. The land can then be used again by the land owner for other activities and there will be virtually no visional signs that a well was once there.

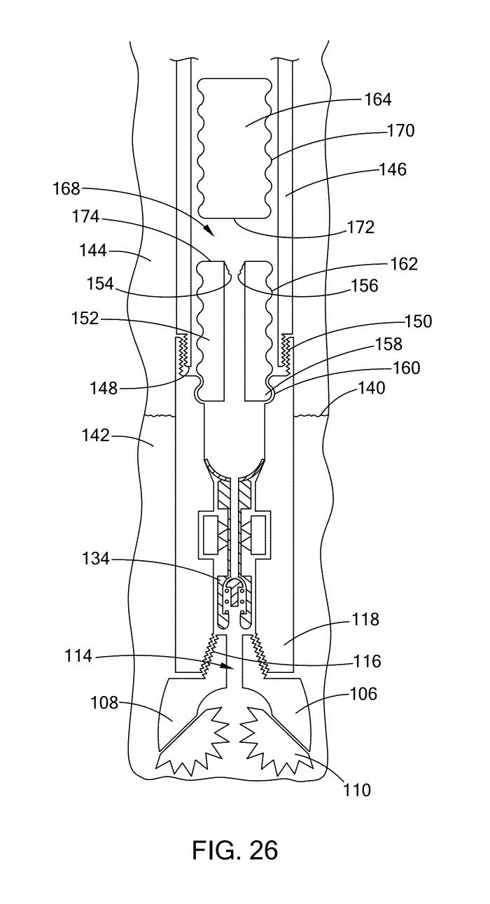

Many different approaches to drill bits and drill strings are contemplated in this implementation of polymer derived ceramic materials for downhole equipment. One exemplar of an approach to a rotary drill string used to create a wellbore is presented in U.S. Pat. No. 7,036,610, from which FIG. 26 is reproduced. Here, the assembly is configured to allow for cementation of a drill string with an attached drill bit into place during a single drilling pass into the earth. As such, the method of drilling the well can become a single process that saves time and reduces cost. However, wellbore drilling can of course also be conducted separate from casing installation.

Thus, FIG. 26 depicts a drill string in the process of being cemented in place during one drilling pass into earth. Each of the components of the drill strings can be formed from one or more of the polymer derived ceramic materials disclosed herein.

A borehole 102 can be drilled through the earth including a target geological formation. The borehole is created with a milled tooth rotary drill bit 106 having milled ceramic roller cones 108, 110. FIG. 26 shows a section view of a drill string in the process of being cemented in place during one drilling pass into formation. A standard water passage 114 is shown through the rotary cone drill bit. The threads 116 on rotary drill bit 106 are screwed into a latching subassembly 118. The latching sub assembly is a relatively thick-walled pipe having some functions similar to a standard drill collar. This thick walled pipe can also be formed from a ceramic material.

FIG. 26 corresponds to the situation where cement is in the process of being forced from the surface through a valve assembly. The top level of cement in the well is designated as element 140. Below 140, cement fills the annulus of the borehole. Above 140, mud fills the annulus of the borehole. For example, cement is present at position 142 and drilling mud is present at position 144 in FIG. 26.

Relatively thin-wall casing, or drill pipe, designated as element 146 in FIG. 26, is attached to the latching sub. The bottom male threads of the drill pipe 148 are screwed into the female threads 150 of the latching sub.

Drilling mud is wiped off the walls of the drill pipe in the well with a bottom wiper plug 152. The bottom wiper plug can be fabricated from polymer derived ceramic material in the shape shown. Portions 154 and 156 of an upper seal of the bottom wiper plug are shown in a ruptured condition in FIG. 26. Initially, they sealed the upper portion of the bottom wiper plug. Under pressure from cement, the Bottom Wiper Plug is pumped down into the well until a lower lobe of the bottom wiper plug 158 latches into place into recession 160. After the bottom wiper plug latches into place, the pressure of the cement ruptures the upper seal of the bottom wiper plug. A bottom wiper plug lobe 162 is shown in FIG. 26. Such lobes provide an efficient means to wipe the mud off the walls of the drill pipe while the Bottom Wiper Plug is pumped downhole with cement.

Further, a top wiper plug 164 is being advanced downhole by water 166 under pressure in the drill pipe. As the Top Wiper Plug 164 is pumped down under water pressure, the cement remaining in region 168 is forced downward through the bottom wiper plug, through the valve assembly, through the water passages of the drill bit and into the annulus in the well. A top wiper plug lobe 170 provides an efficient means to wipe the cement off the walls of the drill pipe while the top wiper plug is advanced downhole with water.

After the bottom surface 172 of the top wiper plug is forced into the top surface 174 of the bottom wiper plug, almost the entire “cement charge” has been forced into the annulus between the drill pipe and the hole. As pressure is reduced on the water, the valve assembly seals against the seating surface 134. As the water pressure is reduced on the inside of the drill pipe, then the cement in the annulus between the drill pipe and the hole can cure under ambient hydrostatic conditions.

As with various other components of downhole drilling and implementation apparatus, there are provided AVSI/API specifications for a drill pipe, the contents of which are incorporated in its entirety by reference. There are maximum percentages permitted for phosphorus and sulfur, each of which are completely lacking in drill pipes formed from polymer derived ceramic materials. There are also tensile, grated strength, elongation and absorbed energy requirements, each of which are to be met by the contemplated ceramic materials employed for drill pipes.

For example, the yield load of the weld zone between members in tension shall be greater than the yield load of the drill-pipe body as given by Equation:

(Yw×Aw)≧(Ymin×Adp)

where

Adp is the cross-sectional area of the drill-pipe body based on the specified dimensions of the pipe body;

Aw is the minimum cross-sectional area of the weld zone;

Ymin is the specified minimum yield strength of the drill-pipe body;

Yw is the weld zone minimum yield strength (determined by the manufacturer based on the design).

The method for calculating the minimum cross-sectional area, Aw, of the weld zone shall be as given by:

Aw=0.7854×D²_{te,min}−d²_{te,max}

where

dte,max is the maximum allowable inside diameter specified by the drill-pipe manufacturer;

Dte,min is the minimum allowable outside diameter specified by the drill-pipe manufacturer.

For surface hardness, in various contemplated approaches, no hardness number shall exceed 37 HRC or equivalent. For the through-wall hardness test, the mean hardness number of the weld zone shall not exceed 37 HRC or 365 HV10.

The guided-bend specimens can have no open discontinuity in the weld zone exceeding 3 mm (0.125 in) measured in any direction on the convex surface of the specimen after bending. Open discontinuities occurring on the corner of the specimen during testing shall not be considered unless there is definite evidence that they result from lack of fusion, inclusions or other internal discontinuities.

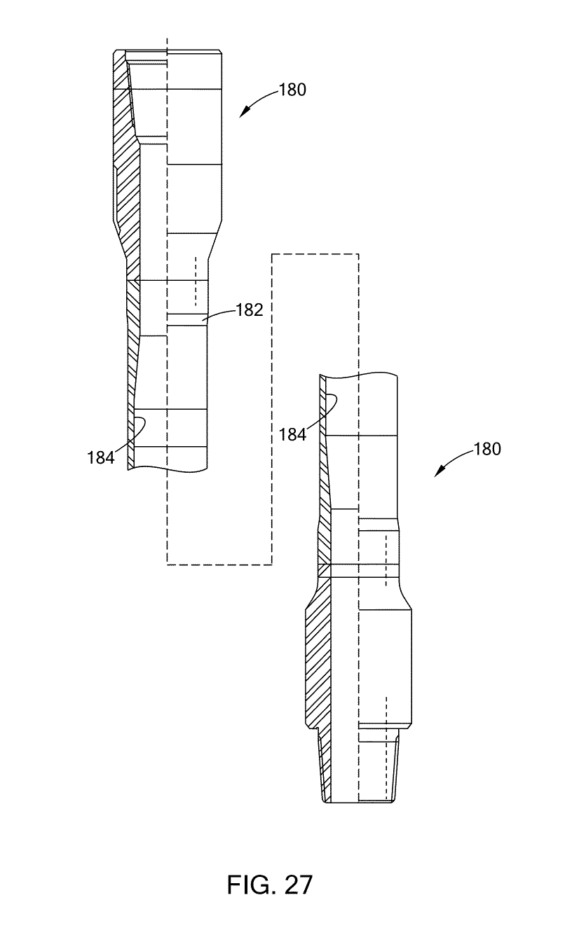

The dimensions of the drill-pipe body can correspond with the ANSI/APF requirements. The configuration of a drill-pipe body 180 can correspond to FIG. 27. The internal upset taper area 182 of the drill-pipe body shall have a smooth profile. The internal upset configuration shall have no sharp corners or drastic changes of section that can cause a 90° hook-type tool to hang up.

The outside-diameter tolerances of the drill-pipe body can further be in accordance with the requirements of ANSI/ADP. The outside-diameter tolerances behind the length, Mₑᵤ, apply to the outside diameter of the drillpipe body immediately behind the upset for a distance of approximately 127 mm (5 in) for sizes smaller than label 1: 6⅝ and a distance approximately equal to the outside diameter for label 1: 6⅝. Measurements shall be made with calipers or snap gauges.

The pipe-body inside diameter, ddp, is calculated as:

d_{dp}=D_{dp}−2t

The wall thickness 184 at any place on the pipe body shall not be less than the specified thickness minus 12.5%. The drill-pipe body can be supplied in lengths and tolerances as specified in the purchase agreement. The lengths and tolerances should be such that the required final length of drill-pipe is achievable.

The mass of a drill pipe shall conform to the calculated mass for the end finish and dimensions specified, within the tolerances stipulated as follows. Calculated mass, WL, expressed in kilograms (pounds), of a piece of drill-pipe body of length Lpe shall be determined in accordance with:

W_{L}=(wpe×Lₚₑ)+ew

where

Wₚₑ is the non-upset pipe mass per unit length, expressed in kilograms per meter (pounds per foot);

Lₚₑ is the length of drill-pipe body, expressed in meters (feet);
e_{w} is the drill-pipe-body mass gain due to end finishing.
   Mass tolerance is as follows:
single lengths:
   +6.5
   −3.5%
order item:
   0
   −1.8%

Where an under-thickness tolerance smaller than 12.5% is specified, the plus tolerance on mass for single lengths shall be increased to 19% less the specified under-thickness tolerance.

Deviation from straight or chord height of a drill pipe shall not exceed either of the following:

a) 0.2% of the total length of the drill-pipe body measured from one end to the other

b) 3.2 mm (⅛ in) maximum drop in the transverse direction in a length of 1.5 m (5 ft) from each end.

The outside and inside surfaces of the upset shall be aligned with the outside surface of the pipe body. The total indicator reading shall not exceed 2.4 mm (0.093 in) for the outside surface and 3.2 mm (0.125 in) for the inside surface.

Maximum ovality, measured with a micrometer on the outside diameter of the upset shall not exceed 2.4 mm (0.093 in).

The minimum pipe-body elongation, e, in a 50.8 mm (2.0 in) gauge length, expressed in percent rounded to the nearest 0.5% for elongations less than 10% and to the nearest unit percent for elongations of 10% and greater, shall be that determined by

e=k×A^{0.2}/U_{dp}^{0.9}

where

k is a constant equal to 1 944 (625 000);

A is the cross-sectional area of the tensile-test specimen, expressed in square millimeters (square inches), based on the specified outside diameter or nominal specimen width and specified wall thickness, rounded to the nearest 10 mm2 (0.01 in2), or 490 mm2 (0.75 in2) whichever is smaller;

Udp is the minimum specified tensile strength, in megapascals (pounds per square inch).

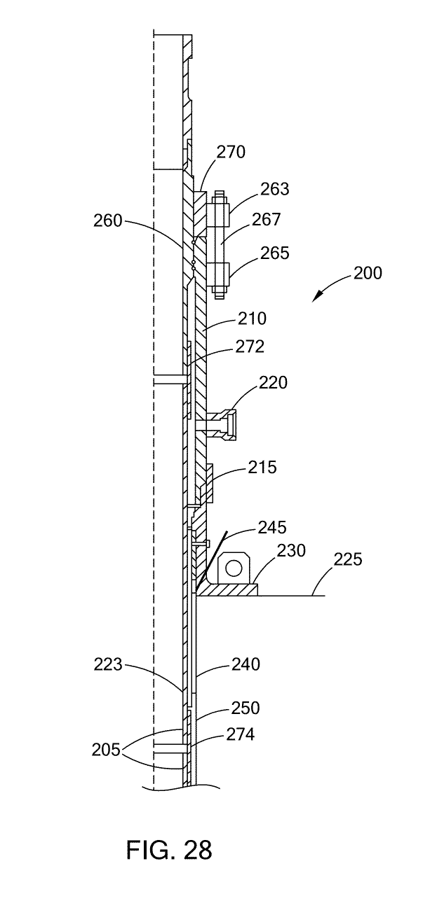

With reference to FIG. 28, there is now presented one approach to a casing hanger 210. This example of a hanger assembly is taken from U.S. Pat. No. 7,597,146, however, various alternate embodiments and approaches to hanger systems are also contemplated. The casing hanger can include a fluid port wherein the fluid port provides fluidic access to an outer annulus by allowing fluid to pass through the casing hanger, a landing sub attached to the casing hanger, and an isolation device attached to the landing sub wherein the isolation device is adapted to allow fluidic isolation of a portion of the landing sub from a portion of the outer annulus of the wellbore. This structure too can be formed from polymer derived ceramic material.

FIG. 28 depicts a cross-sectional view of reverse circulation cementing apparatus 200 interacting with casing string 205 in a wellbore in accordance with one embodiment of the present invention. The casing hanger 210 may be attached to landing sub 230 by collar 215 or any attachment means known in the art. Although landing sub 230 is illustrated as a separate piece from casing hanger 210, landing sub 230 may be integral to casing hanger 210 in certain embodiments. The landing sub 230 may seat against ground 225, or any other support structure near the ground, to provide support for reverse circulation cementing apparatus 200. As stated, the casing hanger 210 may include a fluid port 220. The fluid port 220 may be used, among other things, to introduce cement slurry compositions to an outer annulus 250 by way of a fluid conduit 223. In certain embodiments, the fluid port 220 may be integral to the casing hanger 210. An isolation device 240 may provide fluidic isolation of outer annulus 250. In this way, fluid introduced into outer annulus 250 is prevented from exiting outer annulus 250 by leakage around landing sub 230. However, the fluid insertion tube 245 may be any means for inserting fluid.

The isolation device 240 may be any device that provides at least partial fluidic isolation of outer annulus 250. In certain embodiments, isolation device 240 may comprise a ceramic cup or basket, or a retrievable ceramic packer. In the embodiment depicted in FIG. 28, the isolation device 240 is shown as an inflatable tube. The inflatable tube may be expanded or inflated with a fluid. In certain embodiments, the fluid may be a hardening material such as polymer derived ceramic, which may be settable and capable of permanently hardening in a portion of outer annulus 250. Insertion tube 245 may be used to introduce the material into isolation device 240 as necessary.

A sealing mandrel 260 may be attached to the casing hanger 210 by any means known in the art. In certain embodiments, the sealing mandrel 260 may be integral to the casing hanger 210. In the embodiment depicted in FIG. 79, the sealing mandrel 260 is shown as attached to casing hanger 210 via a load bearing ring 270. The load-bearing ring 270 is in turn attached to turnbuckles 263 and 265 via bolt 267. The sealing mandrel 260 may also be attached to a casing string 205 via casing collars 272 and 274. In this way, sealing mandrel 260 may support the weight of the casing string 205.

Downhole tubing and casing are also subject to ANSI/API specifications, the contents of which are incorporated by reference in their entirety. Again, such structure is intended to be formed from the polymer derived ceramic material disclosed herein.

For example, the minimum elongation, e, expressed in percent, is calculated as given by:

e=k×A^{0.2}/U^{0.9}

where

e is the minimum gauge length extension in 50.8 mm (2.0 in), expressed in percent, rounded to the nearest 0.5% below 10% and to the nearest unit percent for 10% and larger;

k is a constant: 1 942,57 (625 000);

A is the cross-sectional area of the tensile test specimen, expressed in square millimeters (square inches), based on specified outside diameter or nominal specimen width and specified wall thickness, rounded to the nearest 10 mm2 (0.01 in2), or 490 mm2 (0.75 in2) whichever is smaller;

U is the minimum specified tensile strength, in megapascals (pounds per square inch).

The minimum elongation for both round-bar tensile specimens [8.9 mm (0.350 in) diameter with 35.6 mm (1.40 in) gauge length and 12.7 mm (0.500 in) diameter with 50.8 mm (2.0 in) gauge length] shall be determined using an area A of 130 mm2 (0.20 in2).

The yield strength shall be the tensile stress required to produce the elongation under load required.

Moreover, for example, the masses determined shall conform to the calculated masses for the endfinish. Calculated masses can be determined in accordance with:

WL=wpe·Lef+km·em (5)

where (according to ISO/TR 10400 or API TR 5C3, 11.4),
WL is the calculated mass of a piece of pipe of length L, in kilograms (pounds);
wpe is the plain-end mass in kilograms per metre (pounds per foot);
Lef is the length of pipe, including end-finish, in meters (feet), as defined in 8.6;
km is the mass correction factor: 1,000 for carbon steels; 0.989 for martensitic chromium steels;
em is the mass gain due to end-finishing, in kilograms (pounds).

Casing, tubing and pup joints shall be furnished in lengths conforming to requirements. Length determination shall be in meters and hundredths of a meter (feet and tenths of a foot). The accuracy of length-measuring devices for lengths of product less than 30 m (100 ft) shall be ±0.03 m (±0.1 ft).

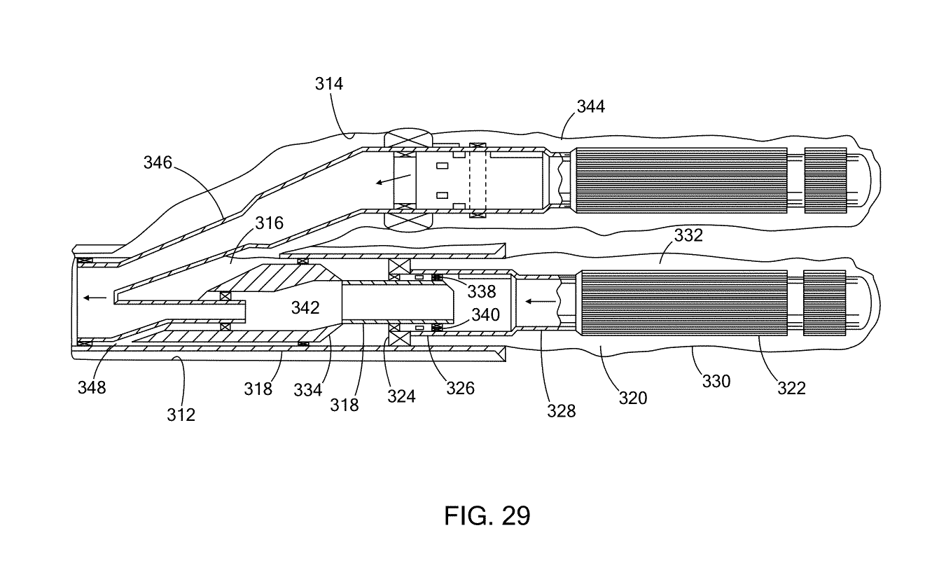

Turning now to FIG. 29, an approach is depicted which has resulted in the construction and completion of a main or parent wellbore 312 and a lateral or branch wellbore 314. This approach has been duplicated from U.S. Pat. No. 6,907,930. The wellbores 312, 314 intersect at an intersection 316, which is formed by positioning a milling/drilling whipstock (not shown in FIG. 80) in the main wellbore 312 below the intersection, and then using the whipstock to laterally deflect mills, drills, etc. to cut through casing 318 lining the main wellbore and drill the branch wellbore extending outwardly from the intersection. Such downhole components are contemplated to be formed at least in part from polymer derived ceramic material. Techniques of forming wellbore intersections are well known to those skilled in the art. In one specific approach, both the wellbore 314 and the lower portion of the wellbore 312 could branch outwardly from the upper portion of the wellbore 312.

After the wellbores 312, 314 have been formed, the milling/drilling whipstock is retrieved from the well, and the lower portion of the wellbore 312 is completed as shown in FIG. 29. Specifically, a gravel packing assembly 320 is installed in the wellbore 312, and the wellbore is gravel packed about the assembly to provide sand control. The assembly 320 as depicted in FIG. 29 includes one or more well screens 322, a packer 324 and a slurry discharge device 326 interconnected in a tubular string 328. Again, one or more of these structures are contemplated to be formed from ceramic material.

The elements of the gravel packing assembly 320 can be arranged as depicted in FIG. 29, with the discharge device 326 positioned between the packer 324 and the screens 322, but other configurations may be utilized, if desired. The packer 324 is set in the casing 318 below the intersection 316, and gravel and/or proppant 330 is discharged into an annulus 332 between the assembly 320 and the wellbore 312, using techniques well known to those skilled in the art.

Note that it is not necessary for the lower portion of the wellbore 312 to be gravel packed in keeping with the principles of the invention. For example, a formation fracturing operation or other stimulation operation, with or without also gravel packing, could be performed in the lower portion of the wellbore 312. As another example, the screens 322 could be installed in the lower portion of the wellbore 312 without gravel packing or fracturing, the screens could be expanded in the lower portion of the wellbore as described below, or the lower portion of the wellbore could be completed in some other manner, if desired.

After gravel packing the lower portion of the wellbore 312, a deflector 334 is installed in the wellbore 312 below the intersection 316. A tubular tailpipe 336 attached to the deflector 334 is stung into an upper end of the assembly 320 and is sealingly engaged therewith, for example, with seals 338 received in seal bores 340. As a result, a passage 342 formed through the deflector 334 is in sealed communication with the interior of the assembly 320 via the tailpipe 336. Both the deflector and tailpipe can be formed from ceramic material.

In one aspect of the drilling method, the branch wellbore 314 is completed and the wellbore intersection 316 is isolated from fluid flows in the wellbores 312, 314 in only a single trip into the well. Specifically, another gravel packing assembly 344 is attached to a tubular leg 346 of a wellbore connector 348 and conveyed into the well.

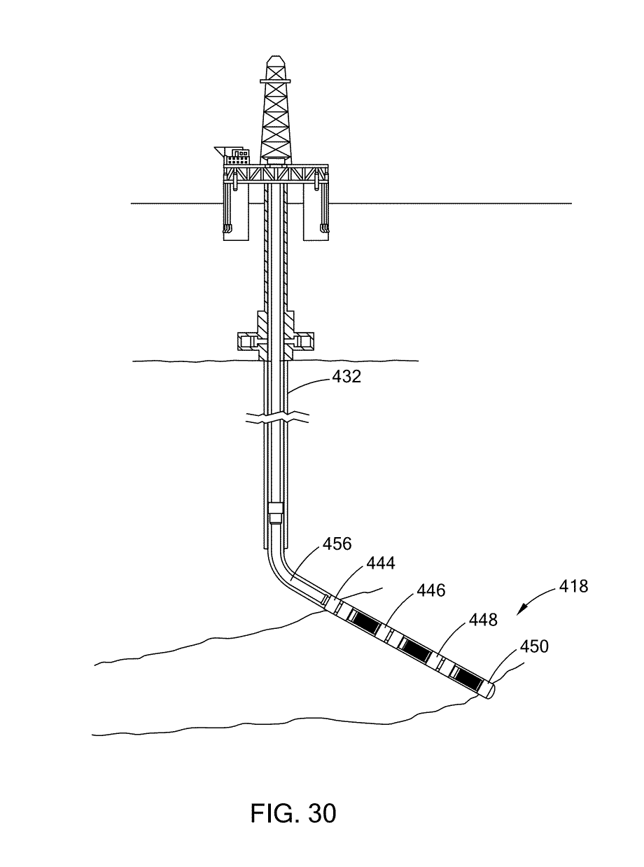

In another related or alternative approach, an outer tubing string 456 may include one or more packers 444, 446, 448, 450 that provide zonal isolation for the production of hydrocarbons in certain zones of interest within wellbore 432 (See FIG. 30 reproduced from U.S. Pat. No. 8,267,173). When set, the packers 444, 446, 448, 450 isolate zones of the annulus between wellbore 432 and outer tubing string 456. These packers, irrespective of their configuration, can be formed at least in part from ceramics. In this manner, formation fluids from formation 414 may enter the annulus between wellbore 432 and outer tubing string 456 in between packers 444, 446, between packers 446, 448, and between packers 448, 450. Additionally, pack slurries, also known as proppant slurries, may be pumped into the isolated zones provided therebetween.

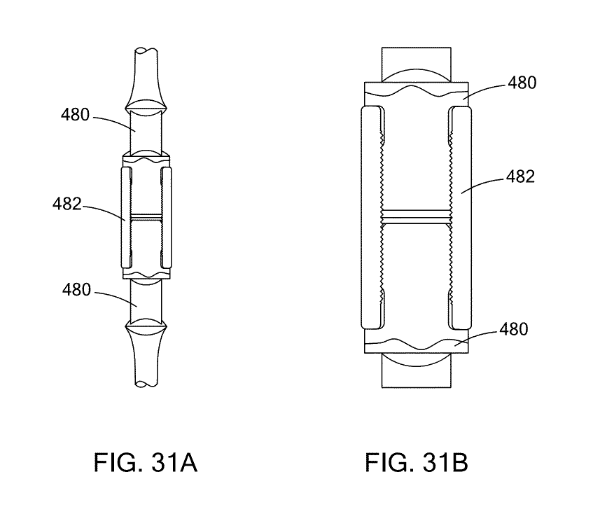

Moreover, as stated, in oil and gas wells, a string connects the pump, located down hole, to the drive system, located at the surface. Conventional sucker rods are elongated rods, 20 feet to 30 feet in length. Traditional drive string typically consisted of a sequence of conventional sucker rods 480 with connecting mechanisms 482 at each end of each conventional sucker rod which permit end-to-end interconnection of adjacent rods (See FIGS. 31A, 31B). In contrast, a continuous sucker rod is a unitary rod, consisting of one elongated continuous piece of material. Thus, a continuous sucker rod does not have the numerous interconnection points found in the interconnected conventional sucker rods. Each interconnection point between two successive conventional sucker rods is a source of potential weakness and excess wear on the adjacent tubing and casing. However, increased costs can be associated with continuous sucker rod. In either approach, the rods are contemplated to be formed from polymer derived ceramic.

The length of a drive string can vary from anywhere from as little as 500 feet to as much as 10,000 feet or more, depending on the depth of the well and desired location of the pump down hole. A continuous sucker rod is typically produced and stored for sale on large transport reels. These transport reels have a maximum diameter of about 19 to 20 feet and the diameter may be as small as 9-10 feet. (The desired maximum diameter is limited by transport issues). A full reel can carry continuous sucker rod with lengths of over 6,000 feet depending on the diameter of the rod. One approach to manipulating a continuous sucker rod is set forth in U.S. Pat. No. 8,281,477. Such an approach can be adopted to create a continuous sucker rod out of polymer derived ceramic.

Further, as stated above, a perforating assembly is employed to create fractures within the wells of a wellbore. The perforating assembly can be formed at least in part from ceramic material. In one embodiment, as disclosed in U.S. Pat. No. 7,185,703, a perforating assembly 538 is preferably positioned within a casing 534 prior to the installation of a tubing string assembly 540. This is achieved by running the perforating assembly 538 downhole on a conveyance such as a wireline, a coiled tubing or preferably an electric wireline with logging capabilities such that the precise location for positioning the perforating assembly 538 within the casing 534 can be determined. In this case, the tubing string assembly 540 is run downhole until the downhole end of the tubing string assembly 540 contacts the uphole end of the perforating assembly 538. Tubing string assembly 540 is then partially retrieved uphole to the location depicted in FIG. 83 such that the shock created when the perforating assembly 538 is fired does not affect any of the components of the tubing string assembly 540.

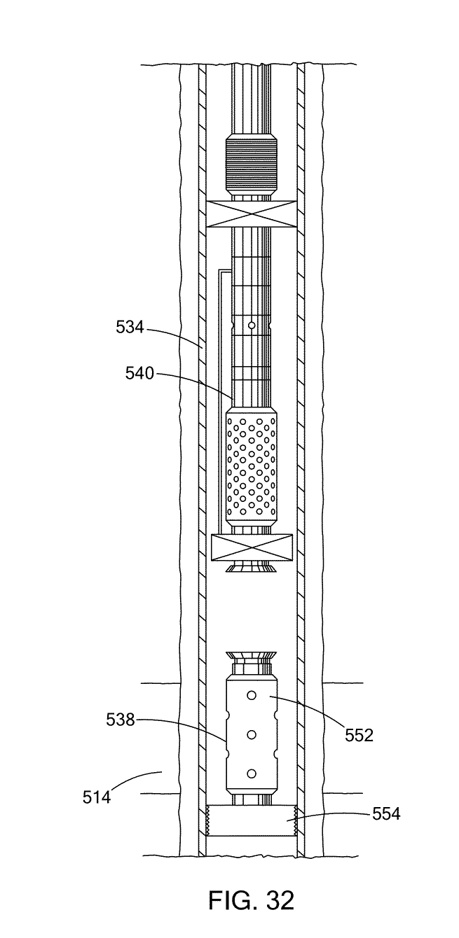

Alternatively, the perforating assembly 538 may initially be coupled to the downhole end of a tubing string assembly 540 such that only a single run is required for the installation of the downhole completion system of the present invention. In this case, once the perforating assembly 538 is positioned within casing to the 534 proximate formation 514, the perforating assembly 538 is disconnected from the tubing string assembly 540 such that the tubing string assembly 540 may be partially retrieved uphole to the location depicted in FIG. 32. Once the perforating assembly 538 and the tubing string assembly 540 are in this position, the completion of the well may begin.

More specifically, the illustrated perforating assembly 538 includes a perforating gun 552 and an auto release gun hanger 554. Preferably perforating gun 552 includes a plurality of shaped charges contained within a charge carrier such that when the shaped charges are detonated, each shaped charge creates a jet that blasts through a scallop or recess in the charge carrier, creates a hydraulic opening through casing 534 and cement 536 and then penetrates formation 514 forming a perforation 555 therein. Perforating gun 552 may be activated by any suitable signaling process, however, perforating gun 552 is preferably a pressure activated perforating gun. Once the shaped charges have been detonated, auto release gun hanger 554 disengages from casing 534, and falls into the rat hole (not pictured) of wellbore 532.

Even though a particular embodiment of perforating assembly 538 has been depicted and described, it should be clearly understood by those skilled in the art that additional, different or fewer components could alternatively be used with perforating assembly 538 without departing from the principles of the present disclosure. For example, perforating assembly 538 may alternatively be a disappearing perforating gun that disintegrates upon firing or may be retrievable uphole via wireline or other suitable conveyance through tubing string assembly 540 after firing.

Today hydraulic fracturing has become an increasingly important technique for producing oil and natural gas in places where the hydrocarbons were previously inaccessible. Technology will continue to be developed to improve the safe and economic development of oil and gas resources. Efficiencies and costs are also expected to continue to improve. Accordingly, employing the polymer derived ceramic downhole tools disclosed herein lends itself to both improved efficiency and cost.

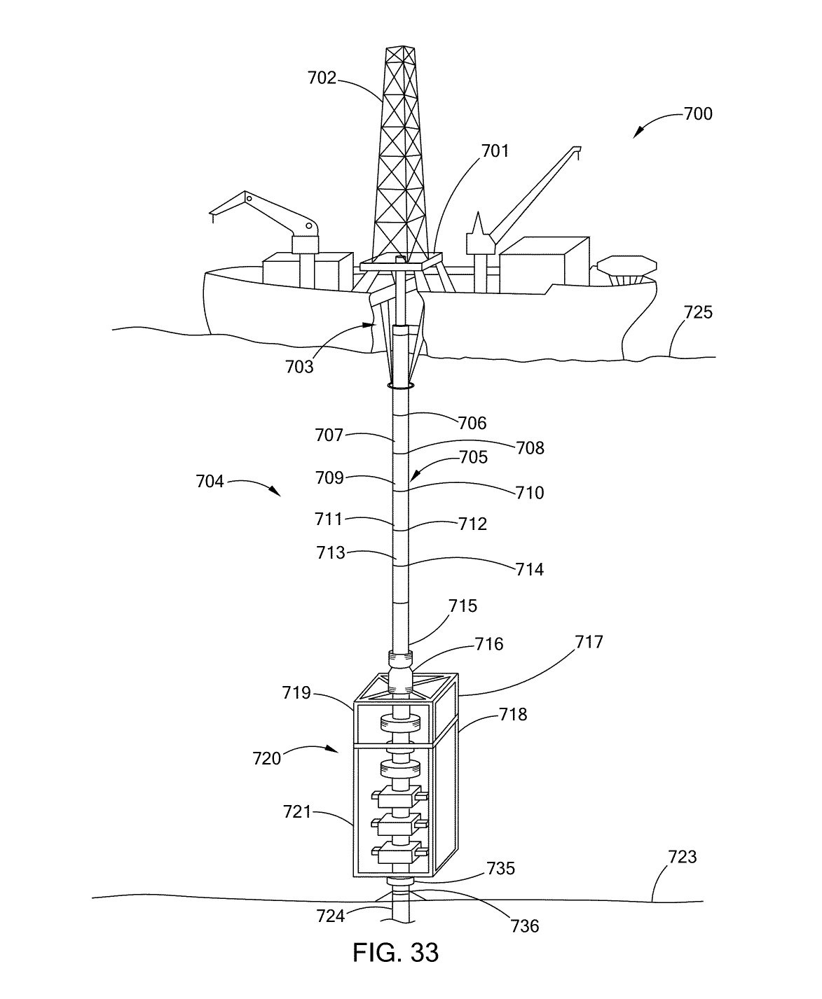

Turning to FIG. 33 there is shown an embodiment of a polymer derived riser assembly, and preferably a reinforced polysilocarb derived riser assembly. This riser assembly may be made from cured reinforced polysilocarb material, e.g., a hard cured composite, it may be made from reinforced pyrolized material, e.g., a ceramic composite, and combinations and variations of these.

In this embodiment there is provided a dynamically positioned (DP) drill ship 700 having a drill floor, a derrick 702 above the drill floor 701, and moon pool 703 (as seen by the cutaway in the figure showing the interior of the drill ship 700) below the drill floor 701 and other drilling and drilling support equipment and devices utilized for operation, which are known to the offshore drilling arts, but are not shown in the figure.

The structural above deck components, (as well as other components) and in particular the heavier structural above deck components, such as the derrick, and the drill floor support, can be made from reinforced polymer derived structures, reinforced polymer derived ceramic structures and combinations and variations of these; and in particular, polysilocarb derived ceramic composite structures. These structures and materials can be considerably lighter than steel, of equal or superior strength, and thus, the use of these lighter components can enhance the stability of the drill ship, among other advantages. Additionally, polysilocarb derived materials can function as fire resistant and retardant coatings and layers. The fire resistant, retardant, and other fire related features for the present polysilocarb derived materials is disclosed and taught in U.S. patent application Ser. No. 14/634,814 the entire disclosure of which is incorporated herein by reference. These materials and their fire resistant, retardant, and other fire related features can be utilized in many applications, areas, components, and sections of the off shore rig or vessel.

The drill ship 700 includes a polysilocarb derived riser assembly 704. Although a drill ship is shown in this embodiment, any other type of offshore drilling rig, vessel or platform including FPSOs, or GGSOs, may be utilized and thus may include a polysilocarb derived riser assembly 704. The polysilocarb derived riser assembly 704, as shown in this figure, is deployed and connecting drill ship 700 with a borehole 724 that extends below the seafloor 723.

In FIG. 33 the polysilocarb derived riser assembly is a drilling riser BOP package with the BOP positioned at or near the seafloor, typically attached to a wellhead, as seen for example in some drilling activities. Embodiments of polysilocarb derived riser assemblies have applications for other types of risers, riser-BOP packages and activities. Thus, polysilocarb derived riser assemblies have applications in relation to drilling, workover, servicing, testing, intervention and completing activities. They also have applications where a BOP is not employed, were drilling is done in the riser, where the riser is a production riser, and other configurations known to, or later developed by the art.

The polysilocarb derived riser assembly 704 has a polysilocarb derived riser 705, e.g., a composite polymer derived material, and a BOP stack 720. The upper portion, i.e., the portion of the riser when deployed that is closest to the surface of the water 725, of riser 705, is connected to the drillship 700 by tensioners that are attached to tension ring. The upper section of the riser 705 may have a diverter and other components (not shown in this figure) that are commonly utilized and employed with risers and are well known to those of skill in the art of offshore drilling.

The polysilocarb derived riser 705 extends from the moon pool 703 of drill ship 700 and is connected to BOP stack 720. The polysilocarb derived riser 705 is made up of riser sections, e.g., 707, 709, 711, 713, that are connected together, by riser couplings, e.g., 706, 708, 710, 712, 714, and lowered through the moon pool 703 of the drill ship 700. Thus, the polysilocarb derived riser 705 may also be referred to as a riser string. One, some, or all of the riser sections may be made from polymer derived material (such as cured reinforced polysilocarb material, e.g., a hard cured composite, reinforced pyrolized material, e.g., a ceramic composite, and combinations and variations of these).

The lower portion, i.e., the portion of the riser that when deployed is closest to the seafloor, of the riser 705 is connected to the BOP stack 720 by way of the riser-BOP connecter 715. The riser-BOP connecter 715 is associated with flex joint 716, which may also be referred to as a flex connection or ball joint. These assemblies, and some or all of their components can be made from polymer derived material (such as cured reinforced polysilocarb material, e.g., a hard cured composite, reinforced pyrolized material, e.g., a ceramic composite, and combinations and variations of these).

The BOP stack 720 may be characterized as having two component assemblies: an upper component assembly 717, which may be referred to as the lower marine riser package (LMRP), and a lower component assembly 718, which may be referred to as the lower BOP stack or the BOP proper. In this embodiment, the upper component assembly 717 has a frame 719 that houses an annular preventer. The lower component assembly 718 has a frame 721 that houses an annular preventer, a first ram preventer, a second ram preventer, and a third ram preventer. The BOP stack 720 has a wellhead connecter 735 that attaches to wellhead 736, which is associated with borehole 724.

The riser has an internal cavity, not shown in FIG. 33 that is in fluid and mechanical communication with an internal cavity, not shown in FIG. 33, in the BOP stack. These internal cavities can be coated with, or made up entirely or in part of polymer derived materials, and in particular polysilocarb derived materials, as well as, polysilocarb pigment based coatings, which are taught and disclosed in U.S. patent application Ser. No. 14/634,819, the entire disclosure of which is incorporated herein by reference. Thus, as deployed, the riser BOP package provides, in an embodiment a polysilocarb derived cavity or channel, putting the drill ship 700 in fluid and mechanical communication with the borehole. In a particular embodiment this channel has an interior surface that is made from a polysilocarb derived material, e.g., neat, reinforced, a jacket, an inner sleeve, a layer, a coating, or as a pigment in a coating, to name a few.

The polysilocarb derived materials, and coatings and paints based upon or utilizing these materials have excellent corrosion and abrasion resistance. Thus, for example, in situations where the flow fluids (such as the hydrocarbon stream, the drilling fluids, or other fluids flowing through the riser, or other tubulars, valves, pipes, etc.) have abrasive properties or contain materials that are abrasive during exploration, completion, workover, reentry, and production polysilocarb materials and coatings can be used to provide enhanced abrasion resistance, and mitigate, or manage the adverse effects of the abrasive fluid. The abrasion resistant and corrosion resistant features of the polysilocarb derived materials also find applications in BOP components and surfaces, and other components and surfaces of the drilling rig.

The BOP stack frames 719, 721 protect the BOP, and may have lifting and handling devices, a control and connection module, and other equipment and devices utilized in subsea operation, which are known to the offshore drilling art, but are not shown in the figure. The internal cavity in the stack goes through the stack from its top (closest to the surface of the water 725) to its bottom (closest to the sea floor 723). This cavity, for example, could be about 18¾″ in diameter and has a cavity wall, which as discussed above may have a polysilocarb derived inner surface.

Typically, in deep sea drilling operations a 21″ riser and an 18¾″ BOP are used. The term “21 riser” can be considered as generic and covers risers wherein the large central tube has an outer diameter in the general range of 21″ and would include for example a riser having a 21¼″ outer diameter. Wall thickness for the polysilocarb derived central tube of 21″ risers can range from about ⅝″ to ⅞″, about ¼″ to about ½″, less than ½″, and smaller and larger sizes. Polysilocarb derived risers and BOPs, however, can vary in size, type and configuration. Polysilocarb derived risers can have outer diameters ranging from about 13⅜″ to about 24″. Because of the reduced weight and equal or increased strength of polysilocarb derived risers they can have diameters larger than 24″, e.g., 30″, 36″ 40″ and greater. Further because of the reduced weight, less buoyancy control components will be needed for the riser, enabling smaller as deployed outer diameters, which reduces the effect of currents on the deployed riser. This it is contemplated that as deployed polymer derived risers can have, the above mentioned diameters, and wall thickness of less than about ⅞″, and less then about ½″, yet have lengths of greater than about 5,000 ft, greater than about 10,000 ft., greater than 15,000 ft., and greater than about 20,000 ft.

The sections of the riser are typically stored vertically on the offshore drilling rig. Once the drilling rig has reached a drilling location the riser and BOP package are deployed to the seafloor. In general, it being recognized that different, varied and more detailed procedures may be followed, as a first step in deploying the BOP, the BOP stack is prepared and positioned under the drill floor and under the rotary table. A spider and gimbal are also positioned with respect to the rotary table. The lower most section of the riser that attaches to the BOP is moved into the derrick and lowered by the hoisting apparatus in the derrick through the spider and down to the BOP below the drill floor where it is connected to the BOP. The riser and BOP are then lowered to a point where the upper coupling of the riser section is at a height above the drill floor were it can be readily connected to the next section of riser. The spider holds the riser in this position. Once the connection has been made, the two sections and the BOP are then lowered, and this process is repeated until sufficient sections of riser have been added and lowered to enable the BOP to reach and be landed on (attached to) the wellhead at the seafloor.

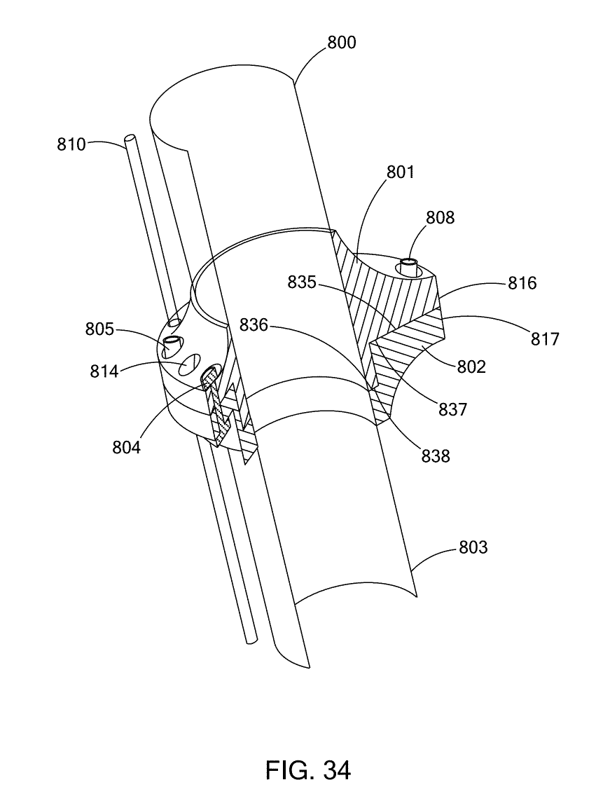

In FIG. 34 there are shown exemplary embodiment of a riser having a flanged coupling, such as an HMF coupling. In this embodiment the riser and coupling are polysilocarb derived components and surfaces. Although a flanged coupling is shown for illustrative purposes, the teachings and embodiments would cover all types of riser connections, including various types of couplings that use mechanical means, such as, flanges, bolts, clips, bowen, lubricated, dogs, keys, threads, course threads, pins and other means of attachment known to the art or later developed by the art. Thus, by way of example, riser couplings would include flange-style couplings, which use flanges and bolts; dog-style, which use dogs in a box that are driven into engagement by an actuating screw; and key-style, which use a key mechanism that rotates into locking engagement. Preferably the flange components would be polysilocarb derived reinforced ceramic composite structures.

Thus, turning to FIG. 34 there is provided a polysilocarb derived riser section center tube 800 that has a flange 801 attached at its lower end. Riser section center tube 803 has a flange 802 attached at it upper end. (Although not shown in this figure, it is recognized that riser section center tube 800 would have a flange attached to its upper end and that riser section center tube 803 would have a flange attached to its lower end.) Polysilocarb derived ceramic flange 801 is attached to upper flange 802 by bolts and nuts. e.g., 804, 805, 806. Also associated with the riser sections 800, 803 and extending through the flanges 801, 802 are a choke line 810, a booster line (not shown), a kill line (not shown), a hydraulic line (not shown) and blanks (e.g., open unfilled holes in the flange) 814. Flange 801 has an outer surface 816, a mating surface 835 and a shoulder surface 836. Flange 802 has an outer surface 817, a mating surface 837 and a shoulder surface 838.

In being understood that one, some or all of these components of the riser center tube, flanges, and their respective and various surfaces can be made from, or coated with, polysilocarb derived materials, e.g., neat, reinforced, a jacket, an inner sleeve, a layer, a coating, or as a pigment in a coating, to name a few.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of formulations, plastics, articles, components, parts, uses, applications, methods, activities and operations set forth in this specification may be used for various other fields and for various other activities, uses and embodiments. Additionally, these embodiments, for example, may be used with: existing systems, articles, components, operations or activities; may be used with systems, articles, components, operations or activities that may be developed in the future; and with such systems, articles, components, operations or activities that may be modified, in-part, based on the teachings of this specification. Further, the various embodiments and examples set forth in this specification may be used with each other, in whole or in part, and in different and various combinations. Thus, for example, the configurations provided in the various embodiments and examples of this specification may be used with each other; and the scope of protection afforded the present inventions should not be limited to a particular embodiment, example, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed is:

1. A system for the production of natural resources from formation within the earth, comprising: downhole equipment, wherein components of the downhole equipment are formed at least in part from polymer derived ceramic material.

2. The system of claim 1, wherein the system includes a drill head formed from polymer derived ceramic material.

3. The system of claim 1, wherein the system includes a drill pipe formed from polymer derived ceramic material.

4. The system of claim 1, wherein the system includes a surface casing formed from polymer derived ceramic material.

5. The system of claim 1, wherein the system includes a tubular casing formed from polymer derived ceramic material.

6. The system of claim 1, wherein the system includes a completion assembly formed from polymer derived ceramic material.

7. The system of claim 1, wherein the system includes a liner hanger assembly formed from polymer derived ceramic material.

8. The system of claim 1, wherein the system includes one or multilateral assemblies formed from polymer derived ceramic material.

9. The system of claim 1, wherein the system includes one or more packer assemblies formed from polymer derived ceramic material.

10. The system of claim 1, wherein the system includes a sucker rod assembly formed from polymer derived ceramic material.

11. The system of claim 1, wherein the polymer derived ceramic material is a polysilocarb derived ceramic material.

12. The system of claim 11, wherein the polysilocarb formulation is a reaction type formulation.

13. The system of claim 11, wherein the polysilocarb formulation is a reaction type formulation, wherein the formulation comprises at least one precursor selected from the group consisting of Phenyltriethoxysilane, Phenylmethyldiethoxysilane, Methyldiethoxysilane, Vinylmethyldiethoxysilane, Trimethyethoxysilane Triethoxysilane, and TES 40.

14. The system of claim 11, wherein the system includes a drilling head formed from polymer derived ceramic material the drilling head comprises a cutting material selected from the group consisting of polysilocarb derived ceramic and polysilocarb derived SiC.

15. The system of claim 11, wherein the polysilocarb formulation is a mixing type formulation.

16. The system of claim 2, wherein the polymer derived ceramic material is a polysilocarb derived ceramic material.

17. The system of claim 3, wherein the polymer derived ceramic material is a polysilocarb derived ceramic material.

18. The system of claim 4, wherein the polymer derived ceramic material is a polysilocarb derived ceramic material.

19. The system of claim 5, wherein the polymer derived ceramic material is a polysilocarb derived ceramic material.

20. The system of claim 6, wherein the polymer derived ceramic material is a polysilocarb derived ceramic material.

21. The system of claim 7, wherein the polymer derived ceramic material is a polysilocarb derived ceramic material.

22. The system of claim 8, wherein the polymer derived ceramic material is a polysilocarb derived ceramic material.

23. The system of claim 9, wherein the polymer derived ceramic material is a polysilocarb derived ceramic material.

24. The system of claim 10, wherein the polymer derived ceramic material is a polysilocarb derived ceramic material.

25. A down hole equipment for use in obtaining a natural resource from below a surface of the earth, the equipment comprising a component comprising a cured polysilocarb material.

26. The equipment of claim 25, wherein the equipment is a drilling head.

27. The equipment of claim 25, wherein the equipment is a blow out preventer.

28. The equipment of claim 25, wherein the equipment is a marine riser assembly.

29. The equipment of claim 25, wherein the equipment is a well head.

30. The equipment of claim 25, wherein the equipment is a derrick.

31. The equipment of claim 30, wherein the derrick is on a drill ship.

32. The equipment of claim 25, wherein the equipment is a submersible pump.

33. The equipment of claim 25, wherein the component comprising a cured polysilocarb formulation is a surface.

34. The equipment of claim 33, wherein the surface is an inner surface.

35. A down hole equipment for use in obtaining a natural resource from below a surface of the earth, the equipment comprising a component comprising a ceramic composite polysilocarb material.

36. The equipment of claim 35, wherein the equipment is a drilling head.

37. The equipment of claim 35, wherein the equipment is a blow out preventer.

38. The equipment of claim 35, wherein the equipment is a marine riser assembly.

39. The equipment of claim 35, wherein the equipment is a well head.

40. The equipment of claim 35, wherein the equipment is a derrick.

41. The equipment of claim 40, wherein the derrick is on a drill ship.

42. The equipment of claim 35, wherein the equipment is a submersible pump.

43. The equipment of claim 35, wherein the component comprising a cured polysilocarb formulation is a surface.

44. The equipment of claim 43, wherein the surface is an inner surface.

45. A down hole equipment for use in obtaining a natural resource from below a surface of the earth, the equipment comprising a component comprising a coating comprising a polysilocarb derived material.

46. A method for obtaining a natural resource from a formation within the earth, the method comprising: providing a downhole equipment, wherein a component of the downhole equipment comprises a polymer derived ceramic material; advancing the downhole equipment in a bore hole below the surface of the earth.

47. A method of making a component for a downhole equipment, the method comprising: providing a polysilocarb formulation and forming the polysilocarb formulation into a component part of the downhole equipment.

48. The method of claim 47, comprising curing the component part.

49. The method of claim 47 comprising machining the component part.

50. The method of claim 48, comprising pyrolizing the cured component part.

51. The method of claim 47, comprising pyrolizing the component part.

52. The method of claim 51, comprising re-infiltrating the pyrolized component part.
